(19) United States
(12) Patent Application Publication
(10) Pub. No.: US 2023/0306761 A1
(43) Pub. Date: Sep. 28, 2023

(54) METHODS FOR IDENTIFYING CROSS-MODAL FEATURES FROM SPATIALLY RESOLVED DATA SETS

(71) Applicant: The General Hospital Corporation, Boston, MA (US)

(72) Inventors: Ruxandra F. SIRBULESCU, Brighton, MA (US); Josh HESS, Bristol, VA (US); Patrick M. REEVES, Cambridge, MA (US); Mark C. POZNANSKY, Newton, MA (US)

(21) Appl. No.: 18/024,179

(22) PCT Filed: Sep. 2, 2021
(86) PCT No.: PCT/US2021/048928

§ 371 Date: Mar. 1, 2023

Related U.S. Application Data
(60) Provisional application No. 63/073,816, filed on Sep. 2, 2020.

(51) Int. Cl. G06V 20/69; G06T 7/33; G06V 10/762; G06T 7/00

(52) U.S. Cl. CPC G06V 20/695; G06T 7/0012; G06T 7/33; G06V 10/762; G06V 20/698; G06T 2207/10056; G06T 2207/10064; G06T 2207/30024; G06V 2201/03

(57) ABSTRACT

Disclosed are methods of identifying a cross-modal feature from two or more spatially resolved data sets, the method including: (a) registering the two or more spatially resolved data sets to produce an aligned feature image including the spatially aligned two or more spatially resolved data sets; and (b) extracting the cross-modal feature from the aligned feature image.

### FIELD OF THE INVENTION

This application relates to methods and systems for identifying a diagnostic, prognostic, or theranostic from one or more correlates identified from aligned spatially resolved data sets.

### BACKGROUND

Development of spatially resolved detection modalities has revolutionized diagnostics, prognostics, and theranostics. Their potential for multi-modal applications, however, remains largely unrealized, as each modality is typically analyzed independently of others.

There is a need for new methods leveraging multiple spatially resolved detection modalities for identifying multi-modal diagnostics, prognostics, and theranostics.

### SUMMARY OF THE INVENTION

In one aspect, the invention provides a method of identifying a cross-modal feature from two or more spatially resolved data sets, the method including: (a) registering the two or more spatially resolved data sets to produce an aligned feature image including the spatially aligned two or more spatially resolved data sets; and (b) extracting the cross-modal feature from the aligned feature image.

In some embodiments, step (a) includes dimensionality reduction for each of the two or more data sets. In some embodiments, the dimensionality reduction is performed by uniform manifold approximation and projection (UMAP), isometric mapping (Isomap), t-distributed stochastic neighbor embedding (t-SNE), potential of heat diffusion for affinity-based transition embedding (PHATE), principal component analysis (PCA), diffusion maps, or non-negative matrix factorization (NMF). In some embodiments, the dimensionality reduction is performed by uniform manifold approximation and projection (UMAP). In some embodiments, step (a) includes optimizing global spatial alignment in the aligned feature image. In some embodiments, step (a) includes optimizing local alignment in the aligned feature image.

In some embodiments, the method further includes clustering the two or more spatially resolved data sets to supplement the data sets with an affinity matrix representing inter-data point similarity. In some embodiments, the clustering step includes extracting a high dimensional graph from the aligned feature image. In some embodiments, clustering is performed according to Leiden algorithm, Louvain algorithm, random walk graph partitioning, spectral clustering, or affinity propagation. In some embodiments, the method includes prediction of cluster-assignment to unseen data. In some embodiments, the method includes modelling cluster-cluster spatial interactions. In some embodiments, the method includes an intensity-based analysis. In some embodiments, the method includes an analysis of an abundance of cell types or a heterogeneity of predetermined regions in the data. In some embodiments, the method includes an analysis of spatial interactions between objects. In some embodiments, the method includes an analysis of type-specific neighborhood interactions. In some embodiments, the method includes an analysis of high-order spatial interactions. In some embodiments, the method includes an analysis of prediction of spatial niches.

In some embodiments, the method further includes classifying the data. In some embodiments, the classifying process is performed by a hard classifier, soft classifier, or fuzzy classifier.

In some embodiments, the method further includes defining one or more spatially resolved objects in the aligned feature image. In some embodiments, the method further includes analyzing spatially resolved objects. In some embodiments, the analyzing spatially resolved objects includes segmentation. In some embodiments, the method further includes inputting one or more landmarks into the aligned feature image.

In some embodiments, step (b) includes permutation testing for enrichment or depletion of cross-modal features. In some embodiments, the permutation testing produces a list of p-values and/or identities of enriched or depleted factors. In some embodiments, the permutation testing is performed by mean value permutation test.

In some embodiments, step (b) includes multi-domain translation. In some embodiments, the multi-domain translation produces a trained model or a predictive output based on the cross-modal feature. In some embodiments, the multi-domain translation is performed by generative adversarial network or adversarial autoencoder.

In some embodiments, at least one of the two or more spatially resolved data sets is an image from immunohistochemistry, imaging mass cytometry, multiplexed ion beam imaging, mass spectrometry imaging, cell staining, RNA-ISH, spatial transcriptomics, or codetection by indexing imaging. In some embodiments, at least one of the spatially resolved measurement modalities is immunofluorescence imaging. In some embodiments, at least one of the spatially resolved measurement modalities is imaging mass cytometry. In some embodiments, at least one of the spatially resolved measurement modalities is multiplexed ion beam imaging. In some embodiments, at least one of the spatially resolved measurement modalities is mass spectrometry imaging that is MALDI imaging, DESI imaging, or SIMS imaging. In some embodiments, at least one of the spatially resolved measurement modalities is cell staining that is H&E, toluidine blue, or fluorescence staining. In some embodiments, at least one of the spatially resolved measurement modalities is RNA-ISH that is RNAScope. In some embodiments, at least one of the spatially resolved measurement modalities is spatial transcriptomics. In some embodiments, at least one of the spatially resolved measurement modalities is codetection by indexing imaging.

In another aspect, the invention provides a method of identifying a diagnostic, prognostic, or theranostic for a disease state from two or more imaging modalities, the method including comparing a plurality of cross-modal features to identify a correlation between at least one cross-modal feature parameter and the disease state to identify the diagnostic, prognostic, or theranostic, where the plurality of cross-modal features is identified according to a method describe dherein, where each cross-modal feature includes a cross-modal feature parameter, and where the two or more spatially resolved data sets are outputs by the corresponding imaging modality selected from the group consisting of the two or more imaging modalities.

In some embodiments, the cross-modal feature parameter is a molecular signature, single molecular marker, or abundance of markers. In some embodiments, the diagnostic, prognostic, or theranostic is individualized to an individual that is the source of the two or more spatially resolved data sets. In some embodiments, the diagnostic, prognostic, or theranostic is a population-level diagnostic, prognostic, or theranostic.

In yet another aspect, the invention provides a method of identifying a trend in a parameter of interest within the plurality of aligned feature images identified according to the method described herein, the method including identifying a parameter of interest in the plurality of aligned feature images and comparing the parameter of interest among the plurality of the aligned feature images to identify the trend.

In still another aspect, the invention provides a computer-readable storage medium having stored thereon a computer program for identifying a cross-modal feature from two or more spatially resolved data sets, the computer program including a routine set of instructions for causing the computer to perform the steps from the method described herein.

In a further aspect, the invention provides a computer-readable storage medium having stored thereon a computer program for identifying a diagnostic, prognostic, or theranostic for a disease state from two or more imaging modalities, the computer program including a routine set of instructions for causing the computer to perform the steps from the method described herein.

In a yet further aspect, the invention provides a computer-readable storage medium having stored thereon a computer program for identifying a trend in a parameter of interest within the plurality of aligned feature images identified according to the method described herein, the computer program including a routine set of instructions for causing the computer to perform the steps from the method described herein.

In a still further aspect, the invention provides a method of identifying a vaccine, the method including: Aa) providing a first data set of cytometry markers for a disease-naïve population; (b) providing a second data set of cytometry markers for a population suffering from a disease; (c) identifying one or more markers from the first and second data sets that correlate to clinical or phenotypic measures of the disease; and (d) (1) identifying as a vaccine a composition capable of inducing the one or more markers that directly correlate to positive clinical or phenotypic measures of the disease; or (2) identifying as a vaccine a composition capable of suppressing the one or more markers that directly correlate to negative clinical or phenotypic measures of the disease.

### BRIEF DESCRIPTION OF THE DRAWINGS

FIG. 1 is a schematic representation showing the process of imaging diabetic foot ulcer (DFU) biopsy tissue with multiple modalities e.g., H&E staining, mass spectrometry imaging (MSI), and imaging mass cytometry (IMC) followed by processing and analysis of the multimodal image datasets using an integrated analysis pipeline.

FIG. 2 is a high-resolution scanned image showing DFU biopsy tissue sections on a microscopy glass slide.

FIG. 2 is a schematic drawing showing DFU biopsy tissue sections on a glass slide before treatment with a spray matrix solution (optimized for each type of analyte) with 2,5-Dihidroxybenzoic acid (DHB), 40% in 50:50 v/v acetonitrile: 0.1% TFA in water.

FIG. 2 is a schematic drawing showing DFU biopsy tissue sections on a glass slide after treatment with a spray matrix solution (optimized for each type of analyte) with 2,5-Dihidroxybenzoic acid (DHB), 40% in 50:50 v/v acetonitrile: 0.1% TFA in water.

FIG. 2 is a graph showing the resulting mass-to-charge average spectrum of an area of DFU tissue after laser desorption, ionization, and characterization using mass spectrometry.

FIG. 3 is a schematic showing the process underlying imaging of DFU biopsy tissue or cell-lines using IMC. Following preprocessing of the sample staining with metal-labeled antibodies is performed. Laser ablation of the sample produces aerosolized droplets that are transported directed into the inductively coupled plasma torch of the instrument producing atomized and ionized sample components. Filtration of undesired components takes place within a quadrupole ion deflector where low-mass ions and photons are filtered out. The high-mass ions representing mainly the metal ions associated with the labeled antibodies are pushed further to the time-of-flight (TOF) detector, which records each ion’s time of flight based on each ion’s mass-to-charge ratio, thus identifying and quantifying the metals present in the sample. Each isotope-labeled sample component is then represented by an isotope intensity profile where each peak represents the abundance of each isotope in a sample. Multi-dimensional analysis is then performed to visualize the data.

FIG. 4 is a flow chart summarizing the multiple steps involved in acquiring multimodal image datasets and extracting molecular signatures from the multimodal datasets.

FIG. 5 is a series of graphs showing an estimation of the intrinsic dimensionality of an MSI dataset using the dimension reduction methods t-distributed stochastic neighbor embedding (t-SNE), uniform manifold approximation and projection (UMAP), potential of heat diffusion for affinity-based transition embedding (PHATE), isometric mapping (Isomap), non-negative matrix factorization (NMF), and principal component analysis (PCA). Convergence on an embedding error value indicated that increasing the dimension of the resulting embedding no longer improved an algorithm’s ability to capture the complexity of the data. Nonlinear methods of dimensionality reduction, e.g., t-SNE, UMAP, PHATE, and Isomap, converged onto an intrinsic dimensionality far lower than that of linear methods, e.g., NMF and PCA, indicating that far fewer dimensions are needed to accurately describe the dataset.

FIG. 6 are graphs showing the computational run time for each algorithm across embedding dimensions 1-10. Plotted are the mean and standard deviation (n=5) across each number of dimensions for each method. Results show that the nonlinear methods t-SNE and Isomap require longer run times than the nonlinear methods PHATE and UMAP.

FIG. 7A is a graph showing a comparison of mutual information captured by each of the tested dimension reduction methods between gray scale versions of three-dimensional embeddings of MSI data and the corresponding H&E stained tissue section. Mutual information is defined to be greater than or equal to zero, negative values are consistent with minimizing a cost function in the registration process. Results show that Isomap and UMAP consistently share more information with the H&E image than the other tested methods.

FIG. 7B is a scheme showing the key technical steps of the analysis described herein. Both the full data set (noisy) or the denoised data set (peak-picked) were used to assess the ability of each of the tested dimension reduction methods to recover data connectivity (manifold structure). The denoised manifold preservation (DeMaP) metric [18] between Euclidean distances in resulting embeddings corresponding to non-peak-picked data and geodesic distances in ambient space (not dimension reduced after peak-picking) of corresponding peak picked data was calculated.

FIG. 7C is a graph showing the mean and standard deviation DeMaP metric (Spearman’s rho correlation coefficient) for all tested dimension reduction methods (n=5). This figure shows the results of the correlation described in FIG. 7B. Nonlinear methods Isomap, PHATE, and UMAP all consistently preserve manifold structure without prior filtering of the data with consistent correlations greater than 0.85 across dimensions 2-10.

FIG. 8 is a schematic flowchart showing the steps from mass spectrometry data and image reconstruction to dimension reduction using UMAP and data visualization through a pixelated embedding representation of the mass spectrometry data.

FIG. 9 illustrates the mapping onto the original DFU tissue section of a 3-dimensional embedding of MSI data after dimensionality reduction by UMAP, where each of the three UMAP dimensions is colored either Red (U1), Green (U2), or Blue (U3). The merged image (RGB Image) contains an overlay of all three pseudo-colored images. The conversion of the RGB image to gray scale is achieved by adding pixel intensities for each of the three pseudo-color channels as shown in the equation. A weighting factor can be added to each channel (x₁, x₂, x₃) to adjust signal contribution for each of the channels, for visualization purposes. A representative grayscale image is shown for the dataset in the pseudo-colored images.

FIG. 10 is a series of grayscale images of DFU biopsy tissue samples showing a comparison between various linear and nonlinear dimension reduction methods.

FIG. 11 is a group of images of a DFU biopsy tissue acquired by brightfield microscopy (H&E), MSI, and IMC. The spatial resolution of the three imaging modalities is displayed to convey the difference in imaging resolution between brightfield microscopic images, MSI images, and IMC images.

FIG. 12 is a flowchart with representative grayscale DFU biopsy tissue images showing the process of image registration across imaging modalities.

FIG. 13 is a flowchart describing the process of aligning multimodal images with a local region of interest (ROI) approach.

FIG. 14 is a flowchart with representative grayscale DFU biopsy tissue images showing the process of fine-tuning of the registration at the local scale. Regions of interest within the Toluidine Blue images corresponding to each MSI image were selected for local scale registration.

FIG. 15 is a series of MSI (A-C and A″-C″) and IMC images (A′-C′ and A‴-C‴) showing three different regions of interest (ROI) in a DFU biopsy tissue section. Single-cell coordinates on each ROI were identified by segmentation using IMC parameters, and subsequent clustering analysis of the extracted single-cell measurements with respect to their IMC profile was used to define cell types (cell types 1-12). Using the coordinates of these single-cells, corresponding MSI data was extracted. Panels A, B, and C show the spatial distribution of an MSI parameter identified through permutation testing. Panels A′, B′, and C′ show spatial distribution of IMC markers of interest prior to single-cell segmentation. Panels A″, B″, and C″ show an overlay of panels A+A′, B+B′, C+C′. Panels A‴, B‴, and C‴ show single-cell masks (ROls defined by single-cell pixel coordinates) identified by segmentation. Coloring depicts cell-types identified by clustering single-cell measurements with respect to IMC parameters.

FIG. 16 is an image illustrating an exemplary workflow to integrate image modalities (boxed marked (C)) and model composite tissue states using MIAAIM. Inputs and outputs (boxes marked (A)) are connected to key modules (shaded boxes) through MIAAIM’s Nextflow implementation (solid arrows) or exploratory analysis modules (dashed arrows). Algorithms unique to MIAAIM (boxes marked (D)) are detailed in corresponding figures (black bolded text). Methods incorporated in for application to single-channel image data types and external software tools that interface with MIAAIM are included (white boxes).

FIGS. 17A and 17B illustrated HDlprep compression and HDlreg manifold alignment, respectively. HDI prep compression steps may include: (i) High-dimensional modality (ii) subsampling (iii) data manifold. Edge bundled connectivity of the manifold is shown on two axes of the resulting steady state embedding (*fractal-like structure may not reflect biologically relevant features). (iv) high-connectivity landmarks identified with spectral clustering. (v) landmarks are embedded into a range of dimensionalities and exponential regression identifies steady-state dimensionalities. Pixel locations are used to reconstruct compressed image. HDlreg manifold alignment may include:(i) Spatial transformation is optimized to align moving image to fixed image. KNN graph lengths between resampled points (yellow) are used to compute α-MI. Edge-length distribution panels show Shannon MI between distributions of intra-graph edge lengths at resampled locations before and after alignment (α-MI converges to Shannon MI as α → 1). MI values show increase in information shared between images after alignment. KNN graph connections show correspondences across modalities. (ii) Optimized transformation aligns images. Shown are results of transformed H&E image (green) to IMC (red).

FIG. 17C demonstrates an exemplary alignment: (i) Full-tissue MSl-to-H&E registration produces T₀. (ii) H&E is transformed to IMC full-tissue reference, producing T₁. (iii) ROI coordinates extract underlying MSI and IMC data in IMC reference space. (iv) H&E ROI is transformed to correct in IMC domain, producing T₂. Final alignment applies modality-specific transformations. Shown are results for an IMC ROI.

FIGS. 18A-18I provide a summary of the performance of dimensionality reduction algorthims for summarizing diabetic foot ulcer mass spectrometry imaging data. FIG. 18A: three mass spectrometry peaks highlighting tissue morphology were manually chosen (top) and were used to create and RGB image representation of the MSI data, which was converted to a grayscale image. The MSI grayscale image was then registered to its corresponding grayscale converted hematoxylin and eosin (H&E) stained section. The deformation field (middle), indicated by the determinant of its spatial Jacobian matrix, was saved to use downstream as a control registration. Three-dimensional Euclidean embeddings of the MSI data were then created using random initializations of each dimension reduction algorithm (bottom). These embeddings were then used to create an RGB image following the procedure above. The spatial transformation created by registering the manually identified peaks with the H&E image was then applied to dimension reduced grayscale images, aligning each to the grayscale H&E image. FIG. 18B: the mutual information of between each aligned grayscale embedded image (n = 5 per method) and the grayscale H&E image was calculated using Parzen window histogram density estimation with a histogram bin width of 64. Plot is oriented so that results are consistent with the notion of a “cost function” in optimization contexts, where the goal is to minimize cost. Thus, larger negative values depict higher mutual information. UMAP consistently captures multi-modal information content with respect to the H&E data.

FIG. 18C: optimization of image registration between the grayscale version of manually identified mass spectrometry peaks and the grayscale H&E image (FIG. 18A, top) using mutual information as a cost function with external validation using dice scores on 7 manually annotated regions. Registration parameters used for the final registration used in FIG. 18A are indicated with dashed lines. Registration was performed by first aligning images with a multi-resolution affine registration (left). The transformed grayscale version of manually identified mass spectrometry peaks was then registered to the grayscale H&E image using a nonlinear, multi-resolution registration. FIG. 18D: average neighborhood entropy (n = 5) of each pixel calculated within a 10-pixel disc across dimension reduction algorithms. Results show UMAP’s ability to highlight structure in the tissue section. FIG. 18E: manual annotations of grayscale H&E image used for validating registration quality with controlled deformation field in a used for mutual information calculations in FIG. 18B. FIG. 18F: cropped regions using the same spatial coordinates as FIG. 18E of manually annotated regions used to calculate the dice scores in FIG. 18C. Results show good spatial overlap across disparate annotations. FIG. 18G: radar plots showing performance comparison of dimension reduction algorithms spanning a range of data representation – linear, nonlinear, local, and global data structure preservation (t-SNE, UMAP, PHATE, Isomap, NMF, PCA). Shown are mean values (n = 5) of algorithm runtime (top, log transformed), estimated steady-state manifold embedding dimensionality (right), noise robustness (bottom), and multi-modal mutual information to DFU MSI data (left). All plots are oriented so that larger values depict better algorithmic performance. Results show UMAP’s ability to efficiently capture data complexity with few degrees of freedom while balancing noise robustness with multi-modal information content contained in histology images. FIG. 18H: intrinsic dimensionality of MSI data estimated by each dimension reduction method. Embedding errors (y-axes) are not comparable across plots. Plotted are the mean and standard deviation (n = 5) embedding errors across embedding dimensions 1-10. Convergence on y-axes indicates that increasing the dimension of the resulting embeddings no longer improves an algorithms ability to capture data complexity. Results show that the intrinsic dimensionality estimated by nonlinear methods (t-SNE, UMAP, PHATE, Isomap) is far less than that of linear methods (NMF, PCA), meaning that fewer dimensions are needed to accurately describe the data set. FIG. 18I: denoised manifold preservation (DeMaP) metric between Euclidean distances in resulting embeddings corresponding to non-peak-picked data and geodesic distances in ambient space (not dimension reduced after peak-picking) of corresponding peak-picked data. Results showing the mean and standard deviation DeMaP metric (Spearman’s rho correlation coefficient) for all tested dimension reduction methods (n = 5). Nonlinear methods Isomap, PHATE, and UMAP all consistently preserve manifold structure without prior filtering of the data with consistent correlations greater than 0.85 across dimensions 2-10. FIG. 18: computational runtime for each algorithm across embedding dimensions 1-10. Plotted are the mean and standard deviation (n = 5) across each number of dimensions for each method. Nonlinear methods t-SNE and Isomap require longer run times than the nonlinear methods PHATE and UMAP. Linear methods require the least amount of run time; however, they fail to capture data complexity succinctly.

FIGS. 19A-19H provide a summary of the performance of dimensionality reduction algorthims for summarizing prostate cancer mass spectrometry imaging data. FIG. 19A: same as FIG. 18A, but for prostate cancer tissue biopsy. FIG. 18B: same as FIG. 18B, but for prostate cancer tissue biopsy. FIG. 19C: optimization of image registration between the grayscale version of manually identified mass spectrometry peaks and the grayscale H&E image (FIG. 19A, top) using mutual information as a cost function. Registration parameters used for the final registration used in FIG. 19A are indicated with dashed lines. Registration was performed by first aligning images with a multi-resolution affine registration (left). The transformed grayscale version of manually identified mass spectrometry peaks was then registered to the grayscale H&E image using a nonlinear, multi-resolution registration. FIG. 19D: Same as FIG. 18D, but for prostate cancer tissue biopsy. FIG. 19E: same as FIG. 18G, but for prostate cancer tissue biopsy. FIG. 19F: same as FIG. 18H, but for prostate cancer tissue biopsy. FIG. 19G: same as FIG. 18l, but for prostate cancer tissue biopsy. Nonlinear methods Isomap, PHATE, and UMAP all consistently preserve manifold structure without prior filtering of the data with consistent correlations greater than 0.75 across dimensions 2-10. FIG. 19H: results showing the computational run time for each algorithm across embedding dimensions 1-10. Plotted are the mean and standard deviation (n = 5) across each number of dimensions for each method. Results show that the nonlinear methods t-SNE, PHATE, and Isomap require longer run times than UMAP. Linear methods require the least amount of run time; however, they fail to capture data complexity succinctly and are not robust to noise.

FIGS. 20A-20H provide a summary of the performance of dimensionality reduction algorthims for summarizing tonsil mass spectrometry imaging data. FIG. 20A: same as FIG. 18A, but for tonsil tissue biopsy. FIG. 20B: same as FIG. 18B, but for tonsil tissue biopsy. Isomap and NMF consistently capture multi-modal information content with respect to the H&E data. FIG. 20C: same as FIG. 19C, but for tonsil tissue biopsy. FIG. 20D: same as FIG. 18D, but for tonsil tissue biopsy. FIG. 20E: same as FIG. 18G, but for tonsil tissue biopsy. FIG. : same as FIG. 18H, but for tonsil tissue biopsy. FIG. 20G: same as FIG. 18I, but for tonsil tissue biopsy. FIG. 20H: same as FIG. 18I, but for tonsil tissue biopsy.

FIGS. 21A and 21B demonstrate that spectral centroid landmarks recapitulate steady-state manifold embedding dimensionalities across tissue types and imaging technologies. FIG. 21A: sum of squared errors of exponential regressions fit to steady state embedding dimensionality selections from spectral landmarks compared to full mass spectrometry imaging data sets across tissue types. Discrepancies between exponential regressions fit to the cross-entropy of landmark centroid embeddings and full data set embeddings approach zero as the number of landmarks increases. Dashed lines show MIAAIM’s default selection of 3,000 landmarks for computing steady-state manifolds embedding dimensionalities. FIG. 21B: same as FIG. 21A, but for subsampled pixels in imaging mass cytometry regions of interest.

FIGS. 22A and 22B demonstrate that UMAP embeddings of spatially subsampled imaging mass cytometry data with out-of-sample projection recapitulate full data embeddings (FIG. 22B) while decreasing runtime (FIG. 22A) in diabetic foot ulcer samples.

FIGS. 23A and 23B demonstrate that UMAP embeddings of spatially subsampled imaging mass cytometry data with out-of-sample projection recapitulate full data embeddings (FIG. 23B) while decreasing runtime (FIG. 23A) in prostate cancer samples.

FIGS. 24A and 24B demonstrate that UMAP embeddings of spatially subsampled imaging mass cytometry data with out-of-sample projection recapitulate full data embeddings (FIG. 24B) while decreasing runtime (FIG. 24A) in tonsil samples.

FIGS. 25A and 25B show MIAAIM image compression scales to large fields of view and high-resolution multiplexed image datasets by incorporating parametric UMAP. FIG. 25A: multiplex CyCIF image of lung adenocarcinoma metastasis to the lymph node (n = ~100 million pixels, 0.65 µm/pixel resolution, 44 channels, 27 antibodies) and corresponding steady-state UMAP embedding and spatial reconstruction (shown are three UMAP channels of 4 channel steady state embedding). Parametric UMAP compresses millions of pixels and preserves tissue structure across multiple length scales. FIG. 25B: same as FIG. 25A, but for tonsil CyCIF data (n = ~256 million pixels, 0.65 µm/pixel resolution).

FIGS. 26A-26I show that microenvironmental correlation network analysis (MCNA) links protein expression with molecular distributions in the DFU niche. FIG. 26A: MCNA UMAP of m/z peaks grouped into modules. FIG. 26B: exponential-weighted moving averages of normalized ion intensities for top five positive and negative correlates to proteins. Colors indicate module assignment. Heatmaps (right) indicate Spearman’s rho. FIG. 26C: exponential-weighted moving averages of normalized average ion intensity per modules ordered as distance from center of wound in DFU increases. FIG. 26D: Raw IMC nuclear (Ir) and CD3 staining in ROI (left) (scale bars = 80 µm). Masks showing CD3 expression (middle-left). Aligned MSI showing one of top CD3 correlates (middle-right). Overlay of CD3 expression and a top molecular correlate (right). FIG. 26E: same as FIG. 26D at different ROI. FIG. 26F: unsupervised phenotyping. Shaded box indicates CD3+ population. Heatmap indicates normalized protein expression.

FIG. 26G: MCNA UMAP colored to reflect ions’ correlations to Ki-67 within CD3+ and CD3- populations. Colors indicate Spearman’s rho and size of points indicates negative log transformed, Benjamini-Hochberg corrected P-values for correlations. FIG. 26H: tornado plot showing top five CD3+ differential negative and positive correlates to Ki-67 compared to the CD3- cell populations. X-axis indicates CD3+ specific Ki-67 values. Color of each bar indicates change in correlation from CD3- to CD3+ populations.

FIG. 26I: boxplots showing ion intensity and of top differentially correlated ions (top, positive; bottom; negative) to CD3+ specific Ki-67 expression across ROls on the DFU. Tissue maps of top differentially associated CD3+ Ki-67 correlates (top, positive; bottom; negative) with boxes (white) indicating ROls on the tissue that contain CD3+ cells.

FIGS. 27A-27H illustrate cobordism projection and domain transfer with (i-)PatchMAP. FIG. 27A: schematic representing PatchMAP stitching between boundary manifolds (reference and query data) to form cobordism (grey), information transfer across cobordism geodesics (top) and cobordism projection visualization (bottom). FIG. 27B: boundary manifold stitching simulation. PatchMAP projection (manually drawn dashed lines indicate stitching) and UMAP projections of integrated data are shown at NN values that maximized SC for each method. FIG. 27C: MSI-to-IMC data transfer with i-PatchMAP. Line plots show Spearman’s rho between predicted and true spatial autocorrelation values. FIG. 27D: MSI-to-IMC data transfer benchmark. FIG. 27E: CBMC multimodal CITE-seq data transfer benchmark. FIG. 27F: PatchMAP of DFU single-cells (blue) and DFU (red), Tonsil (green), and Prostate (orange) pixels based on MSI profile. Individual plots show IMC expression for DFU single-cells (right). FIG. 27G: MSI-to-IMC data transfer from DFU single-cells to the full tissue. FIG. 27H: MSI-to-IMC data transfer from DFU single-cells to the tonsil tissues.

FIGS. 28A and 28B show that PatchMAP preserves boundary manifold structure while accurately embedding inter-boundary manifold relationships in the cobordism. FIG. 28A: PatchMAP embedding of MNIST digits dataset (n = 70,000) randomly split into two equally-sized boundary manifolds. At lower values of nearest neighbors, PatchMAP resembles UMAP embeddings because open neighborhoods are preserved after intersecting pairwise nearest neighbor queries. Under these conditions, the intersection operation resembles the fuzzy set union that UMAP implements. At higher values of nearest neighbors, PatchMAP captures manifold relationships in cobordisms while preserving boundary manifold structure. Here, PatchMAP aligns boundary manifolds along a primary axis to produce near mirror images. This reflects the equal splitting of the data in half, and it is captured in cobordism geodesic distances. FIG. 28B: validation of FIG. 27B on the full MNIST digits dataset, where each digit in the dataset is considered to be a boundary manifold. Lower values of nearest neighbors resemble UMAP embeddings, and higher values of nearest neighbors allow PatchMAP to accurately model cobordism geodesic distances.

### DETAILED DESCRIPTION

In general, the invention provides methods and computer-readable storage media for processing two or more spatially resolved data sets to identify a cross-modal feature, to identify a diagnostic, prognostic, or theranostic for a disease state, or to identify a trend in a parameter of interest.

The term “theranostic,” as used herein refers to a diagnostic therapeutic. For example, a theranostic approach may be used for personalized treatment.

The present method is designed as a general framework to interrogate spatially resolved datasets of broadly diverse origin (e.g., laboratory samples, various imaging modalities, geographic information system data) in conjunction with other aligned data to identify cross-modal features, which can be used as high-value or actionable indicators (e.g. biomarkers or prognostic features) composed of one or more parameters that become uniquely apparent through the creation and analysis of multi-dimensional maps.

A method of the invention may be a method of identifying a cross-modal feature from two or more spatially resolved data sets by: (a) registering the two or more spatially resolved data sets to produce an aligned feature image including the spatially aligned two or more spatially resolved data sets; and (b) extracting the cross-modal feature from the aligned feature image.

A method of the invention may be a method of identifying a diagnostic, prognostic, or theranostic for a disease state from two or more imaging modalities. The method includes comparison of a plurality of cross-modal features to identify a correlation between at least one cross-modal feature parameter and the disease state to identify the diagnostic, prognostic, or theranostic. The plurality of cross-modal features may be identified as described herein. In the methods described herein, each cross-modal feature includes a cross-modal feature parameter. The two or more spatially resolved data sets are outputs by the corresponding imaging modality selected from the group consisting of the two or more imaging modalities described herein.

A method of the invention may be a method of identifying a trend in a parameter of interest within the plurality of aligned feature images identified according to the methods described herein. The method includes identifying a parameter of interest in the plurality of aligned feature images and comparing the parameter of interest among the plurality of the aligned feature images to identify the trend.

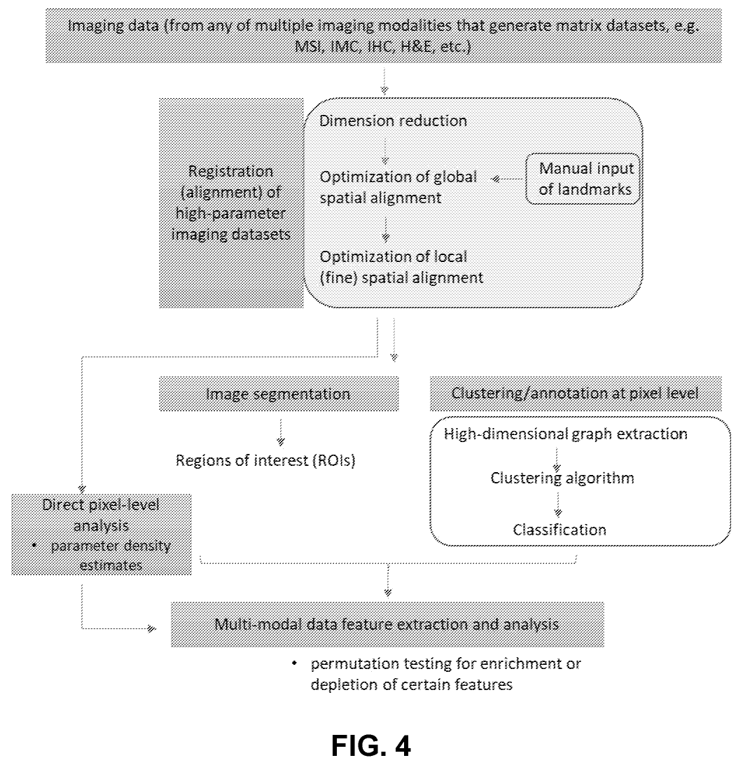

FIG. 4 summarizes the required and optional steps for identifying a cross-modal feature. Step 1 is the spatial alignment of all modalities of interest. Steps 2-4 can be run in parallel, and are complementary approaches used to identify trends in expression/abundance of parameters of interest for modelling and prediction of biological processes at multiple scales: cellular niches (fine local context), local tissue heterogeneity (local population context), tissue-wide heterogeneity and trending features (global context), and disease/tissue states (combination of local and global tissue context).

In the context of data derived from biological samples with relevance for biomedical and research applications, the present method is envisioned to have broad applicability to data from a variety of tissue-based data acquisition technologies, including, but not limited to: RNAscope [1], multiplexed ion beam imaging (MIBI) [2], cyclic immunofluorescence (CyCIF) [3], tissue-CyCIF [4], spatial transcriptomics [5], mass spectrometry imaging [6], codetection by indexing imaging (CODEX) [7], and imaging mass cytometry (IMC) [8].

The invention also provides computer-readable storage media. The computer-readable storage media may have stored thereon a computer program for identifying a cross-modal feature from two or more spatially resolved data sets, the computer program including a routine set of instructions for causing the computer to perform the steps from the method of identifying a cross-modal feature from two or more spatially resolved data sets, as described herein. The computer-readable storage media may have stored thereon a computer program for identifying a diagnostic, prognostic, or theranostic for a disease state from two or more imaging modalities, the computer program including a routine set of instructions for causing the computer to perform the steps from the corresponding methods described herein. The computer-readable storage media may have stored thereon a computer program for identifying a trend in a parameter of interest within the plurality of aligned feature images identified according to the corresponding methods described herein, the computer program including a routine set of instructions for causing the computer to perform the steps from the corresponding methods described herein.

All of the computer-readable storage media described herein exclude any transitory media (e.g., volatile memory, data signals embodied in a carrier wave, such as a carrier wave in a network, e.g., internet). Examples of computer-readable storage media include non-volatile memory media, e.g., magnetic storage devices (e.g., a conventional “hard drive,” RAID array, floppy disk), optical storage devices (e.g., compact disk (CD) or digital video disk (DVD)), or an integrated circuit device, such as a solid-state drive (SSD) or a USB flash drive.

### Registration of Spatially Resolved Datasets

The integration of spatially resolved datasets (e.g., high-parameter spatially resolved datasets from various imaging modalities) presents challenges due to the possible existence of differing spatial resolutions, spatial deformations and misalignments between modalities, technical variation within modalities, and, given the goal of discovery of new relationships, the questionable existence of statistical relations between differing modalities. Thus, systems, methods, and computer-readable storage media disclosed herein provide a general approach to accurately integrate datasets from a variety of imaging modalities.

The method is demonstrated on an example data set designed for the integration of imaging mass cytometry (IMC), mass spectrometry imaging (MSI), and hematoxylin and eosin (H&E) data sets.

Image registration is often viewed as a fitting problem, whereby a quality function is iteratively optimized through the application of transformations to one or more images in order to spatially align them. In practice, image registration frameworks typically consist of sequential pair-wise registrations to a chosen reference image or group-wise registration; the latter of which has been proposed as a method by which multiple images can be registered in a single optimization procedure, removing the bias imposed by choosing a reference image and thus reference modality [9,10]. Recently, both of these frameworks have been extended to learning-based registrations capable of processing large data sets through the use of spatial transformer networks [11,12,13,14]. In our investigation of an appropriate registration pipeline, we acknowledge the potential use of a group-wise registration scheme and learning-based models, particularly in situations where tissue morphology changes significantly between adjacent sections (as with glandular prostate tissue) or when there is an abundance of data, respectively.

The methods disclosed herein are centered around a sequential pair-wise registration scheme that can be guided and optimized at each step. Thus, the methods disclosed herein provide a platform for one-off image registration as well as the registration of multiple samples in a data set across acquisition technologies and tissue types.

### Image Registration

### Dimension Reduction

High-parameter data sets, often confounded with technical variation and noise, pose a challenge for their analysis and integration with each other. The spatial integration of each modality currently requires that a representative image(s) be presented that enables a statistical correspondence to other modalities in an image registration scheme. The manual identification of such an image quickly becomes intractable for the data sets in consideration due to the number of parameters acquired and the complex relationships between those parameters.

Methods of the invention include the step of registering two or more spatially resolved data sets to produce a feature image including the spatially aligned two or more spatially resolved data sets. Automatic definition of image features may be achieved using techniques that embed data into a space having a metric adapted for constructing entropic spanning graphs. Such techniques include dimension reduction techniques and compression techniques that embed high-dimensional data points (e.g., pixels) in Euclidean space. Non-limiting examples of dimension reduction techniques include uniform manifold approximation and projection (UMAP) [15], isometric mapping (Isomap) [16], t-distributed stochastic neighbor embedding (t-SNE) [17], potential of heat diffusion for affinity-based transition embedding (PHATE) [18], principal component analysis (PCA) [19], diffusion maps [20], non-negative matrix factorization (NMF) [21] are used to condense the dimensionality of the data into a concise representation of the full set.

Uniform manifold approximation and projection (UMAP) is a machine learning technique for dimension reduction. UMAP is constructed from a theoretical framework based in Riemannian geometry and algebraic topology. The result is a practical scalable algorithm that applies to real world data. The UMAP algorithm is competitive with t- SNE for visualization quality, and in some cases, preserves more of the global data structure with superior run time performance. Furthermore, UMAP has no computational restrictions on embedding dimension, making it viable as a general-purpose dimension reduction technique for machine learning.

Isometric mapping (Isomap) is a nonlinear dimensionality reduction method. It is used for computing a quasi-isometric, low-dimensional embedding of a set of high-dimensional data points. Th method permits estimating the intrinsic geometry of a data manifold based on a rough estimate of each data point’s neighbors on the manifold.

t-distributed stochastic neighbor embedding (t-SNE) is a machine learning algorithm for nonlinear dimensionality reduction that allows one to represent high-dimensional data in a low-dimensional space of two or three dimensions for better visualization. Specifically, it models each high-dimensional object by a two- or three-dimensional point in such a way that similar objects are modeled by nearby points and dissimilar objects are modeled by distant points with high probability.

Potential of heat diffusion for affinity-based transition embedding (PHATE) is an unsupervised low-dimensional embedding of high-dimensional data.

Principal component analysis (PCA) is a technique for dimensionality reduction of large data sets by creating new uncorrelated variables that successively maximize variance.

Diffusion maps is a dimensionality reduction or feature extraction method, which computes a family of embeddings of a data set into Euclidean space (often low-dimensional) whose coordinates can be computed from the eigenvectors and eigenvalues of a diffusion operator on the data. The Euclidean distance between points in the embedded space is equal to the diffusion distance between probability distributions centered at those points. Diffusion maps is a nonlinear dimensionality reduction method which focuses on discovering the underlying manifold that the data has been sampled from.

Non-negative matrix factorization (NMF) is a dimensionality reduction method that decomposes a non-negative matrix to the product of two non-negative ones.

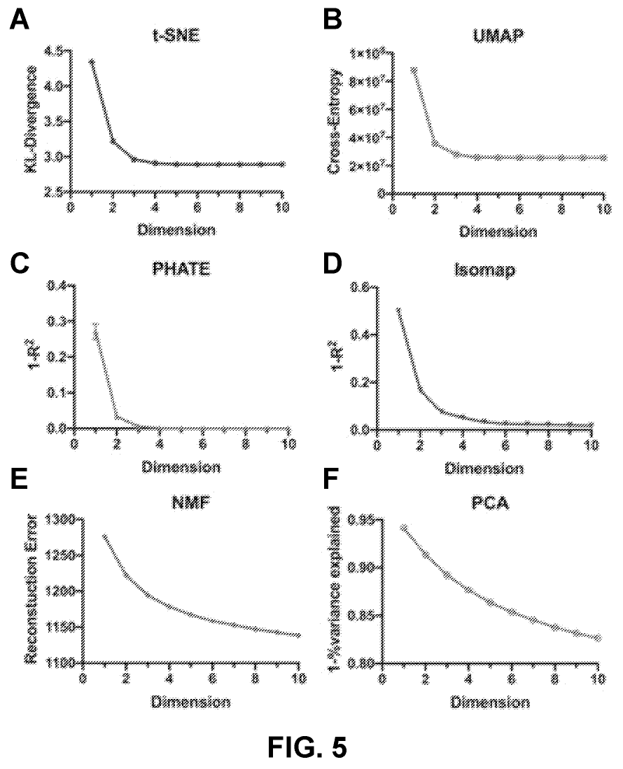

This dimensionality reduction process is often data dependent, and the appropriate representation of a data set requires the observation of the performance of the chosen algorithm. In the example data set, our chosen method for dimension reduction is the uniform manifold approximation and projection (UMAP) algorithm [17]. Our results (FIGS. 5, 6, 7A, 7B, and 7C) show that this algorithm, a manifold-based nonlinear technique, provides the best representation of MSI data across considered methods for multi-modal comparisons to H&E based on standards of image registration and experiments on computational complexity, robustness to noise, and ability to capture information in low-dimension embeddings. Dimension reduction process listed above can be applied to all datasets in consideration, although the manual curation of representative features of a modality is possible and is considered a “guided” dimension reduction.

In order to represent the compressed high-dimensional data sets as an image with foreground and background, each pixel in the compressed high-dimensional image is considered as an n-dimensional vector, and corresponding images are pixelated by referring to the spatial locations of the respective pixels in the original data sets. This process results in images with numbers of channels equal to the dimension of embedding. Dimension reduction algorithms typically compress data into the Euclidean vector space of dimension n, where n is the chosen embedding dimension. By definition, this space contains the zero vector, so pixels/data points are not guaranteed to be distinguishable from image background (typically zero-valued). To avoid this, each channel is linearly rescaled to the range of zero to one, following the process in [23], allowing for the distinction of foreground (spatial locations containing acquired data) and background (non-informative spatial locations).

### Input of Landmarks

The image registration step may include, e.g., a user-directed input of landmarks. A user-directed input of landmarks is not a required step for completing image registration. Instead, this step may be included to improve the quality of results, e.g., in instances where unsupervised automated image registration does not produce optimal results (e.g., different adjacent tissue sections, histological artifacts etc.). In such cases, methods described herein may include providing one or more user-defined landmarks. The user-defined landmarks may be input prior to the optimization of registration parameters.

In certain preferred embodiments, user input is incorporated after dimension reduction. Alternatively, user input may be incorporated prior to dimension reduction by using spatial coordinates of raw data. Practically, user-defined landmarks may be placed within an image visualization software (e.g., Image J, which is available from imagej.nih.gov).

### Optimization of Registration Parameters

Once features are chosen for registration of modalities through dimension reduction, parameters for the aligning process can be optimized in a semi-automatic fashion by hyperparameter grid search and, e.g., by manual verification. The computations for the registration procedure in the current implementation (separate from the step of dimensionality reduction) may be carried out, e.g., in the open-source Elastix software [22], which introduces a modular design to our framework. Thus, the pipeline is able to incorporate multiple registration parameters, cost functions (dissimilarity measures optimized during registration), and deformation models (transformations applied to pixels to align spatial locations from multiple images), allowing for the alignment of images with arbitrary number of dimensions (from dimension reduction), the incorporation of manual landmark setting (for difficult registration problems), and the composition of multiple transformations to allow for fine-tuning and registering data sets acquired with more than two imaging modalities (e.g., MSI, IMC, IHC, H&E, etc.)

### Optimization of Global Spatial Alignment

The image registration step may include optimizing global spatial alignment of registration parameters. Optimization of global spatial alignment may be performed on two or more data sets after the reduction of their dimensionality.

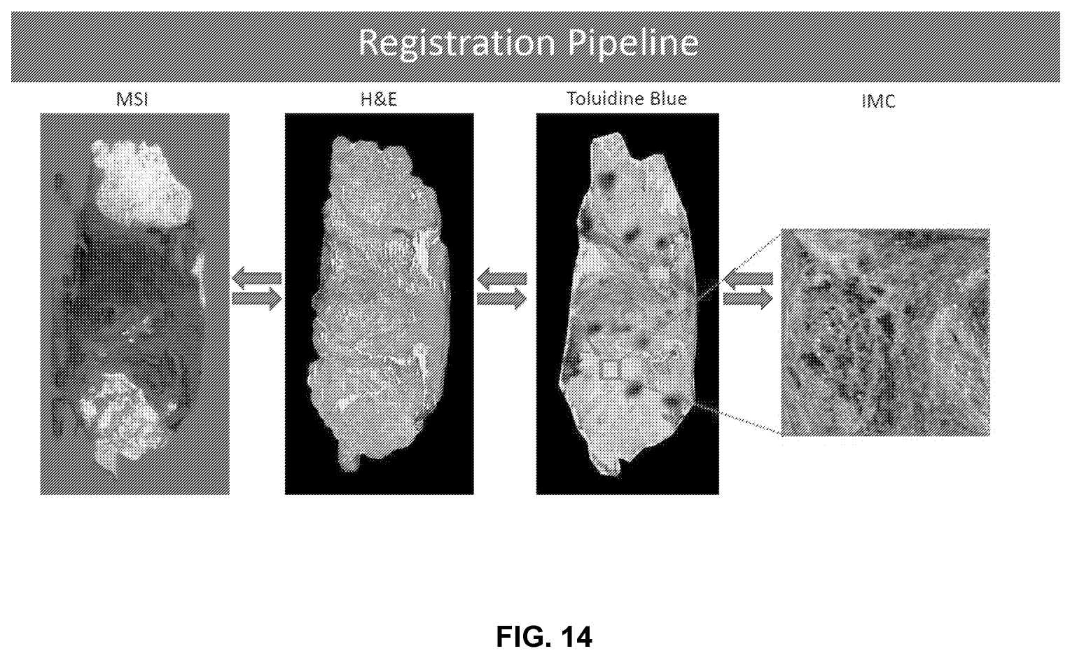

Using hyperparameter grid searches, registration parameters may be optimized, e.g., to ensure an appropriate alignment of each modality at the full-tissue scale for coarse-grained analyses (e.g. tissue-wide gradient calculations of markers of interest, tissue-wide marker/cell heterogeneity, identification of regions of interest (ROIs) for further inspection, etc.). In some embodiments, the spatial alignment of a data set may be carried out in a propagating manner by registering full-tissue sections for each data set (e.g., MSI, H&E, and toluidine blue stained images). Then, the spatial coordinates for an ROI (e.g., IMC ROI taken from the toluidine blue stained image) may be used to correct any local deformations that need further adjustment for fine-grained analyses (FIGS. 14 and 15).

In the example data set described herein, the spatial resolutions of each modality were as follows: MSI about 50 µm, H&E about 0.2 µm, and IMC about 1 µm.

The method described herein may preserve the spatial coordinates of high-dimensional, high-resolution structures and tissue morphology. Thus, in some methods described herein, the higher resolution ROls may remain unchanged at each step of the registration scheme (e.g., the exemplary registration scheme described herein). Such higher resolution ROls may serve as, e.g., the final reference image, to which all other images are aligned. It has been shown that MSI data is reflective of tissue morphology present in traditional histology staining [24]. Given this correspondence combined with the ability of histology (H&E) staining to capture cellular spatial organization, we choose to view the H&E image as a medium between the MSI and IMC data sets and as the lynchpin for spatially aligning all modalities. Due to limitations on computational resources, a resolution of ~1.2 µm per pixel is used for the H&E image in the registration process.

Although, the use of a hierarchical, multi-resolution registration scheme similar to that implemented with our data set has the potential to register data sets of arbitrary resolution.

### Optimization of Local Alignment for Fine-Grained Spatial Overlay

The methods described herein may include secondary fine-tuning of image alignment for smaller-sized ROIs. This step may be performed, e.g., after all modalities are aligned at the tissue level (global registration).

In the exemplary data set described herein, the lack of morphological information currently available at the full-tissue scale for IMC images after acquisition, a result of the destructive nature of the IMC technology, necessitates this added step of correcting for local deformations that occur within each ROI. To that end, single-cell multiplexed imaging technologies capable of full-tissue data acquisition, such as tissue-based cyclic immunofluorescence (t-CyCIF) [4] and co-detection by indexing (CODEX) [7], offer both coarse analyses on the heterogeneity of specimens at a large scale and local analyses on ROIs; however, the dilution of single-cell relationships resulting from that tissue-wide heterogeneity, when combined with potential exposure to artifacts on the edges of full tissue specimens, often necessitates a finer analysis on regions of interest (ROIs) within the full tissue. As a result, with full tissue specimens, it is often the case that a low-powered field of view is used to scan slides for coarse morphological characteristics before obtaining a finer analysis at the cellular level with a higher magnification.

From this perspective, our iterative full-tissue to ROI approach allows for the generalization to arbitrary multiplexed imaging technologies, both tissue-wide, and those with predefined ROIs, as in our example data set. Our propagating registration pipeline allows for the correction of local deformations that are smaller than the grid spacing used in our hierarchical B-spline transformation model at the full-tissue scale. It is well-known that the number of degrees of freedom and thus computational complexity and flexibility of deformation models increase with the resolution of the uniform control point grid spacing [25]. The control point grid spacing of a nonlinear deformation model represents the spacing between nodes that anchor the deformation surface of the transformed image. When used with a multi-resolution registration approach, the uniform control point spacing for nonlinear deformation is often scaled with image resolution. Thus, coarse nonlinear deformations are corrected prior to a finer, high-resolution registration at the local scale. While our pyramidal approach to full-tissue registration attempts to mitigate misalignment due to overly fine or coarse grid spacing, we ultimately choose to ensure fine-structure registration of each ROI by reducing the sampling space for the cost function from being a global, tissue-wide cost, to one centered at each ROI after registering the full tissues.

The final registration proceeds by following the steps of dimension reduction, global spatial alignment optimization, and local alignment optimization, and by composing resulting transformations in the propagating scheme. The original data corresponding to each modality is then spatially aligned with all others by applying its respective transformation sequence to each of its channels.

### Manifold-Based Data Clustering/Annotation

Once all modalities are spatially aligned through the dimension reduction, analysis can proceed at the pixel level or at the level of spatially resolved objects (see analyzing pre-defined, spatially resolved objects). At the pixel level, although the data from each modality is aligned, parsing through the volumes of data that exist at the individual pixel level may be intractable - posing a similar problem faced when choosing feature images for registration. Clustering is a method by which similar data points (e.g., pixels, cells, etc.) are grouped together with the goal of reducing data complexity and preserving the overall data structure. Through this approach, the individual pixels of an image can be grouped together to summarize homogenous regions of tissue to provide a more interpretable, discretized version of the full image, relieving the complexity of the analysis from millions of individual pixels to a defined number of clusters (e.g. tens to hundreds). When used in conjunction with heatmaps or another form of data visualization, a summary of each cluster, or tissue region, can be visualized in a single image, aiding in quick interpretation of the profile of each region.

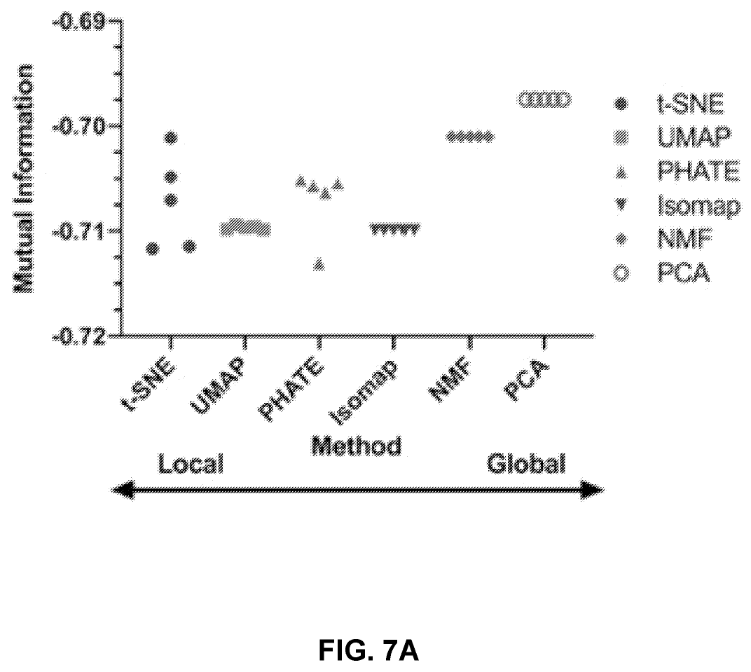

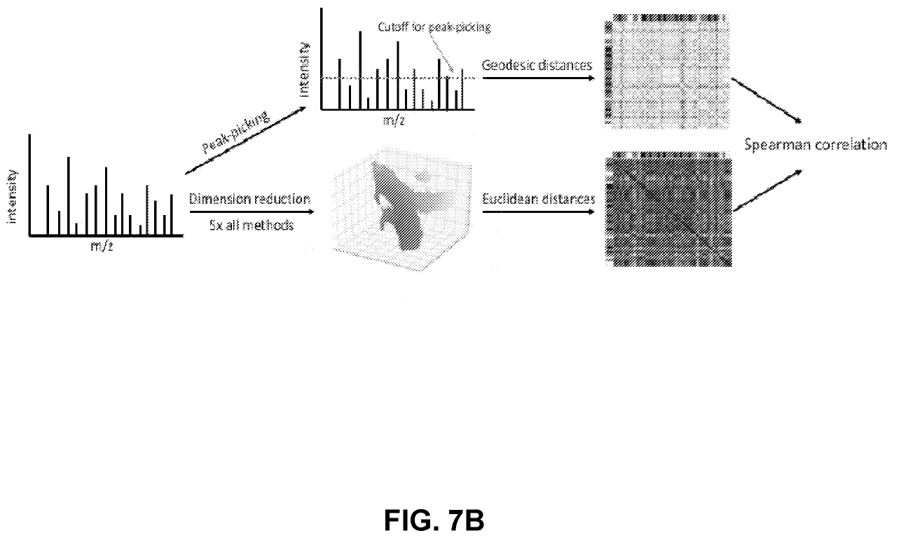

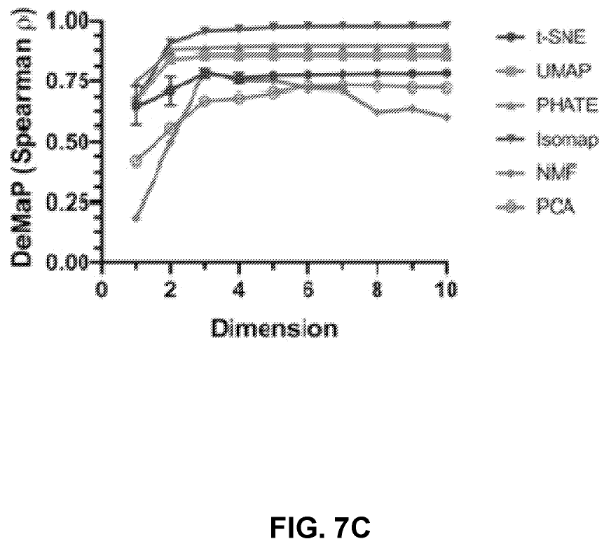

In the exemplary data set described herein (FIGS. 7B and 7C), the UMAP algorithm proved to be robust to noisy (variable) features, and the computational efficiency of the algorithm allowed for an iterative dissection of the data in a reasonable timeframe. As a result of UMAP’s robustness to noise and ability to capture complexity we found it to be most appropriate for constructing a mathematical representation of very high-dimensional data, such as those derived from MSI or similar methods where hundreds to thousands of channels are available for each image.

The dimension reduction portion of the UMAP algorithm operates by maximizing the information content contained in a low-dimensional graph representation of the data set compared to a high-dimensional counterpart [15]. In certain preferred embodiments, the dimension reduction optimization scheme is capable of recapitulating the high-dimensional graph itself. As a result, we extract the high-dimension graph (simplicial set) and use it as input for a community detection (clustering) method (e.g., Leiden algorithm [28], Louvain algorithm [29], random walk graph partitioning [34], spectral clustering [35], affinity propagation [36], etc.), as opposed to clustering on embedded data space itself, as in [30]. This graph-based approach can be applied to any algorithm that constructs a pairwise affinity matrix (e.g., UMAP [15], Isomap [16], PHATE [18], etc.). The method described herein perform the clustering of the high-dimensional graph prior to the actual reduction of data dimensionality (embedding), ensuring that clusters are formed based on a construction representative of global manifold structure. The exemplary clustering approach used herein conserves global features of the data [32], in contrast to the embedding produced by local dimension reduction using a method, e.g., t-SNE or UMAP (preferably, t-SNE) [18]. Compared with the clustering approach on the graph structure taken from a reduced data space, as in [31], the approach taken in our example data set relieves the imposition of identifying principle components from the raw data prior to clustering, which we found was sensitive to noise when using a large or noisy data set (e.g., the full MSI data set from in the Image Registration section above).

Independent of the choice of clustering algorithm, a simplified representation of the data through the process then allows one to conduct a number of analyses, ranging from prediction of cluster-assignment to unseen data, directly modelling cluster-cluster spatial interactions, to conducting traditional intensity-based analyses independent of spatial context. The choice of analysis depends on the study and/or task at hand - whether one is interested in features outside of spatial context (abundance of cell types, heterogeneity of predetermined regions in the data, etc.), or whether one is focused on spatial interactions between the objects (e.g., type-specific neighborhood interactions [26], high-order spatial interactions - extension of first-order interactions [7], prediction of spatial niches [27]). The resulting analyses and predictions can then be used as hallmark features for the diagnosis and prediction of disease and for indicators of biological processes of interest for purely scientific reasons.

Clustering allows one to interrogate the data in an unsupervised manner. However, just as easily, one could manually annotate pixels on the image in order to identify sets of features that correspond to those annotations of interest. In the UMAP embedded representation of our example data set from diabetic foot ulcer biopsy tissue, for example, one can easily identify two polar extremes of tissue health. These tissue states could be labelled and subsequently summarized in order to provide the same analyses listed above. In both cases, the annotations and cluster identities act as discretized sets of labels which can be further analyzed.

### Classification

Classification algorithms can then be run after clustering or manually annotating portions of the images in order to extend cluster assignments to unseen data. These algorithms will assign or predict the assignment of data to a group based on their values for the parameters used to build the classifiers. “Hard” classifiers are algorithms that create defined margins between labels of a data set, in contrast to “soft” classifiers, which form “fuzzy” boundaries between categories in a data set that represent the conditional probability of class assignment based on the parameter values of the given data.

When using soft classifiers (e.g., conditional probabilities produced by random forest, neural net with sigmoid final activation function, etc.), the additional generation of probability maps for, e.g., diseased/healthy tissue regions - diagnostics can be extracted. This probability map concept is best exemplified by the pixel classification workflow in the image analysis software, Ilastik [38]. After classification with a random forest classifier, one can then extract the relevant features that were used to make predictions for understandability. For example, the MSI parameters that had the most impact on cluster conditional probabilities in our random forest classification were used to identify distinguishing features between tissue regions.

By contrast, hard classifiers allow for a clear assignment of class to data, and thus are useful to impose when a clear category assignment (decision) is required. In our example data set, the MSI data set was clustered at the pixel level using the UMAP-based method described above, and a random forest classifier was used to extend cluster assignments to new pixels by assigning pixels to maximum probability clusters (a hard classification). This direction was taken due to computational constraints and computational efficiency, in addition to its ability to identify nonlinear decision boundaries produced in our manifold clustering scheme with robustness to parameter selection [37].

### Analyzing Pre-defined, Spatially Resolved Objects (Cells, Tissue Structures, Etc.)

In tissue specimens, there are often objects of interest that are cells or other morphological features (e.g., blood vessels, nerves, extracellular matrix; or whole structures, such as hair follicles or tumors). The spatial coordinates of these objects are then important to identify for understanding the imaging data set at a higher level than the pixel level. In the exemplary data set described herein, the IMC modality contains data at single-cell resolution, and the goal of the analysis is to connect this single-cell information to parameters in the other modalities. In single-cell multiplex imaging analysis, computer vision and/or machine learning techniques may be applied to locate the coordinates of cells on the image, use those coordinates to extract aggregated pixel-level data, and subsequently analyze that data at the single-cell instead of pixel level. This process is called “segmentation”, and there are a variety of single-cell segmentation software and pipelines available, such as Ilastik [38], watershed segmentation [39], UNet [40], and DeepCell [41]. This segmentation process, however, applies to any object of interest, and the resulting coordinates from the process can be used to aggregate data for the application of any of the above analyses (e.g., clustering, spatial analysis, etc.). Importantly for our application, this segmentation allows us to aggregate pixel-level data for each single cell, permitting the clustering of cells irrespective of spatial locations. This process allows for the formation of cellular identities based on traditional surface or activation marker staining in the IMC modality alone. A similar approach is applicable to arbitrary objects, provided that the analysis and aggregation of the pixel-level data is warranted.

### Multi-modal Data Feature Extraction and Analysis

The method described herein may include comparing data from different modalities, e.g., with respect to spatially resolved objects by using their spatial coordinates. The process of image registration spatially aligns all imaging modalities, so that objects can be defined in any one of the modalities employed and still accurately maintain associated features across all modalities. In the example described herein (FIG. 15), the IMC data set was used to identify single-cell coordinates, which were then used to extract features for single cells from both the aligned MSI pixel-level data and the IMC pixel level data itself. The data was subsequently clustered based on single-cell measurements in the IMC modality alone and in the MSI modality alone. The clustering of IMC single-cell measurements may be used to determine cell types. The ability to integrate multiple imaging modalities allowed us to perform permutation testing for enrichment or depletion of certain features in the MSI modality as a function of the corresponding cell types defined in the IMC data set. Alternatively, the method described herein may identify what IMC features are depleted or enriched based as cell types defined by the MSI modality. This type of cross-modal analysis extends to arbitrary numbers of parameters, and to arbitrary numbers of modalities. The permutation test assesses the randomized mean value of each parameter to its observed value independent of modality, enabling a one versus all comparison, where the assessed measure is aggregated by labels to a single modality. One could also ask what parameters from the other modalities influence or are correlated with the values obtained in their current modality of interest, as opposed to testing for enrichment or depletion with a cutoff for statistical significance. To address this question, one could perform correlation analyses across modalities and could create models that take into account multiple modalities. To this end, previously mentioned tools, such as a random forest classifier, may be used for the task of predictive modelling of objects based on their multi-modal portrait. Subsequent dissection of the classifier weights, as described above, could then be extracted to understand the relative influence of each parameter in each modality for the predictive task at hand.

Advantageously, the integration of these spatially resolved imaging data sets affords the flexibility in analysis. Analysis pipelines may be extracted from and used for many of the imaging modalities listed independently. When considering cross-modal analysis in this perspective, the opportunity to validate exciting new multi-modal analytic techniques, in addition to proving their usefulness with new findings becomes apparent.

### Additional Envisioned Applications

### Pixel-Level Calculations and Analysis

Most of the analyses described above focus around either identifying spatially resolved objects or clustering pixel-level data in order to discretize the data set for summarization. If instead, one wanted to analyze the registered images as they are at the pixel level, the trends of parameters of interest across a tissue or a focused region of a tissue could be gleaned. For example, gradients of parameters of interest across an image can visualized by computing parameter density estimates. The resulting smoothed representations of pixel-level data are akin to continuous gradients and can be visualized as a contour map or heatmap. In our example data set, we generated this visualization by calculating smoothed versions of markers of interest in the IMC data with respect to each other, showing the overall trends of those parameters relative to each other. This analysis is not restricted to a single modality. As a result of the registration process and spatial alignment across modalities, gradients across modalities can also be calculated. These continuous representations, when formally implemented in spatial gradient models, such as that in [49], could be used to provide numerical solutions to the attractive and repulsive influence that intra- or inter-modality parameters have on each other. If used in conjunction with time-dependent analyses, these numerical solutions and equations provide the possibility of developing cross-modal simulation models at the tissue level. For example, provided the sensitivity of data acquisition necessary to identify single molecules in MSI with high confidence, our data set could combine cross-modal gradient relationships with known attractions and repulsions between single molecules in order to simulate biological processes in tissue.

Following the argument above, spatial regression models are commonly used in geographic systems analyses [42,43], and could be used to parse relationships in multi-modal biological tissue data at the pixel level as well as for spatially resolved objects. The utility of a pixel-oriented analysis is best demonstrated in [33], where a spatial variance components analysis is used to draw inferences on the contribution and effect of parameters calculated at the pixel level with respect to cells (spatially resolved objects).

### Multi-Domain Translation

Recently, there have been advances in computer vision and artificial intelligence algorithms, both in classification tasks and in generative modelling. Of note are those models that are capable of learning and generating underlying distributions that create/represent the data sets at hand, such as generative adversarial networks [44] and adversarial autoencoders [45]. These models have the ability to predict and transfer knowledge gleaned from one image/modality to another. This concept of image-to-image, and in our case, domain-to-domain translation, is best demonstrated by cycle consistent generative adversarial networks [46]. From this angle, arbitrary modalities can be translated from one to another, provided there exists a relationship between them for training. This process, which we would be considered antibody-free labelling, in the case of generating IMC images from trained generative models on other modalities, is an extension of the application of generative modelling in biological image prediction, such as those exemplified in [47,48].

The following examples are meant to illustrate the invention. They are not meant to limit the invention in any way.

### EXAMPLES

### Example 1 Multi-Modal Imaging and Analysis of Diabetic Foot Ulcer Tissue

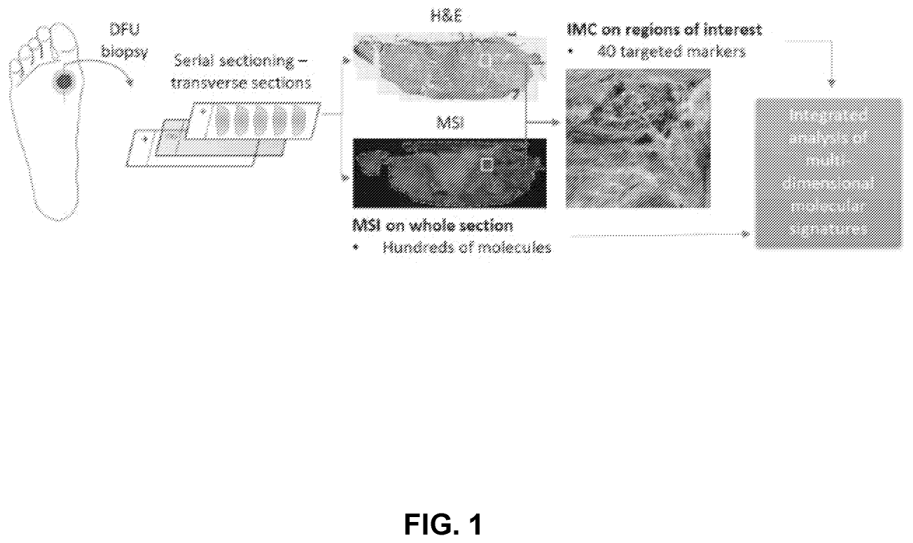

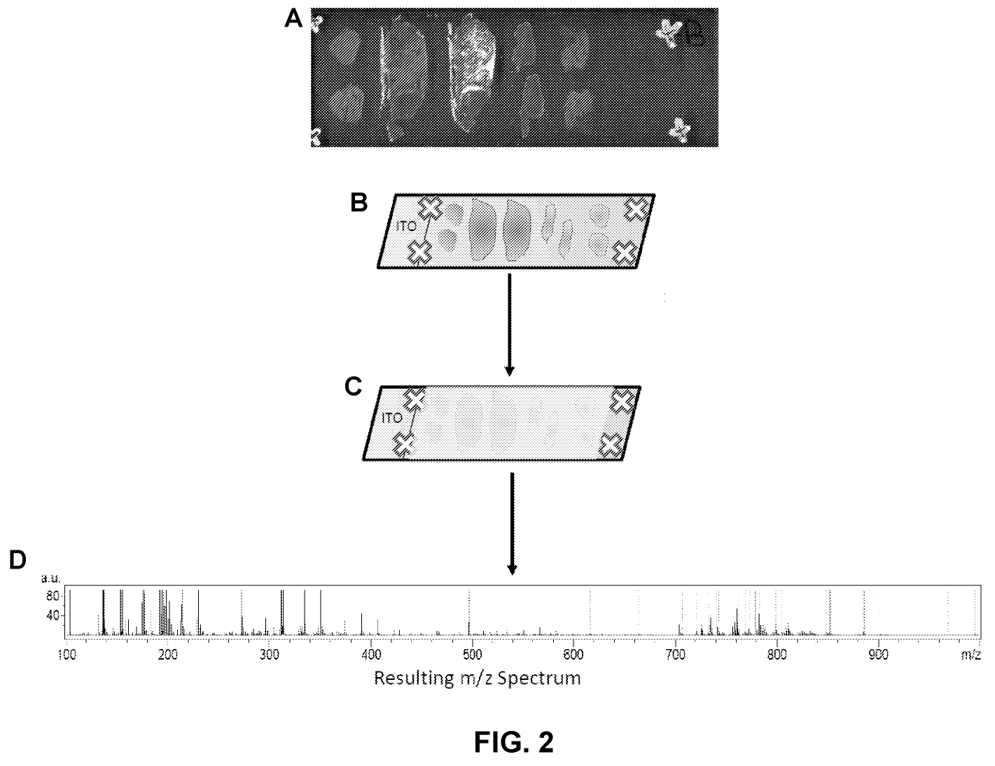

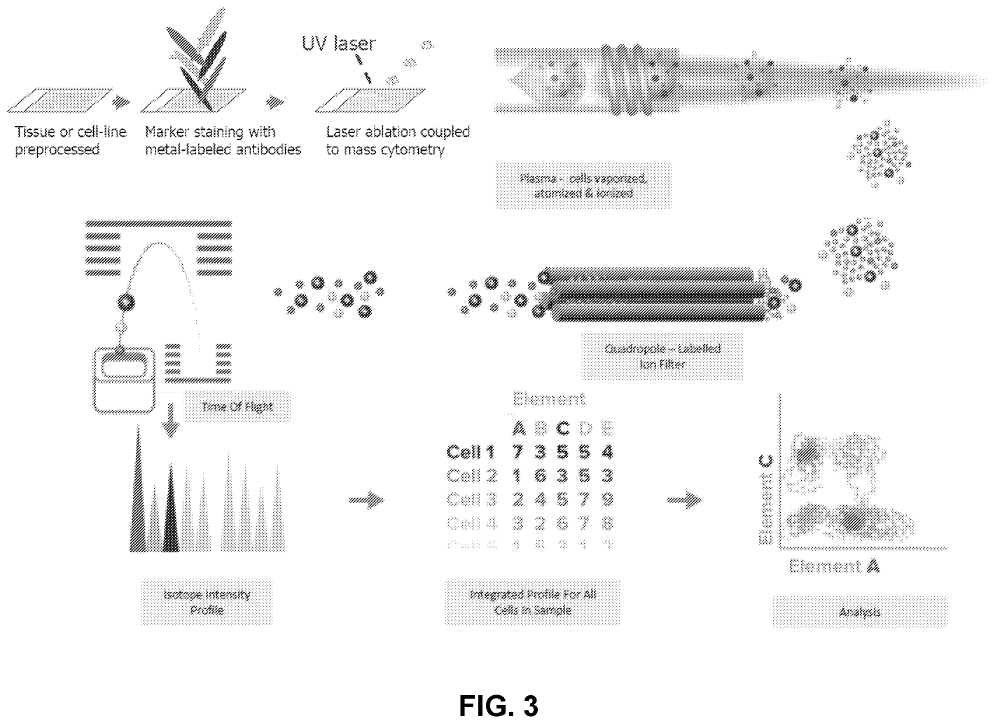

A diabetic foot ulcer (DFU) biopsy including a fully excised ulcer and surrounding healthy margin tissue was performed followed by tissue processing in preparation for multimodal imaging. Serial sections of the DFU biopsy were imaged with matrix assisted laser desorption ionization (MALDI) mass spectrometry imaging (MSI), with imaging mass cytometry (IMC), and with optical microscopy. Following the multi-modal imaging, the high-dimensional data acquired was processed using an integrated analysis pipeline to characterize molecular signatures (FIGS. 1 and 4). Each slice of DFU biopsy was stained using Hematoxylin and Eosin (H&E) and imaged using brightfield microscopy scanning. To prepare the DFU biopsy slices (FIG. 2) for MSI the slices were sprayed with matrix solution (optimized for each type of analyte). In this example, the matrix used contained 2,5-Dihidroxybenzoic acid (DHB), 40% in 50:50 v/v acetonitrile: 0.1% TFA in water was used (FIG. 2) to image preferentially small molecules and lipids. Imaging was performed using a Bruker Rapiflex™ MALDI-TOF mass spectrometry imaging system in positive ion mode, 10 kHz, 86% laser and 50 µm raster resulting in mass/charge (m/z) ratio spectra with peaks representing the molecular composition of the DFU biopsy slice (FIG. 2D). Imaging mass cytometry was performed in regions of interest within the DFU biopsy slices imaged with H&E staining and MSI. Following tissue or cell culture preprocessing the samples were stained with metal labeled antibodies (FIG. 3). Then labeled molecular markers in the sample were ablated using an ultraviolet laser coupled to a mass cytometer system (FIG. 3). In the mass cytometer cells of the sample are vaporized, atomized, ionized, and filtered through a quadrupole ion filter. Isotope intensities were profiled using time-of-flight (TOF) mass spectrometry and the atomic composition of each labeled marker of the sample is reconstructed and analyzed based on the isotope intensity profile (FIG. 3).

### Example 2. Processing and Analysis of Multi-Modal and High-Dimensional Data

Multi-modal imaging data acquired using any combination of modalities including e.g., MSI, IMC, immunohistochemistry (IHC), H&E staining, was processed using an integrated analysis pipeline (FIG. 4). The analysis pipeline was designed as a generalizable framework to interrogate spatially resolved datasets of broadly diverse origin (e.g., laboratory samples, various imaging modalities, geographic information system data) in conjunction with other aligned data to identify high-value or actionable indicators (e.g. biomarkers, or prognostic features) composed of one or more parameters that become uniquely apparent through the creation and analysis of multi-dimensional maps. To create such multi-dimensional maps a series of steps for processing the multi-modal imaging data were taken. First, spatial alignment of all modalities was performed in a process referred to as image registration (FIG. 4). Steps 2-4, (2) image segmentation, (3) manifold-based clustering and annotation at the pixel level, and (4) multi-modal data feature extraction and analysis were performed in parallel and were complementary approaches used to identify trends in expression or abundance of parameters of interest for modelling and prediction of biological processes at multiple scales: cellular niches (fine local context), local tissue heterogeneity (local population context), tissue-wide heterogeneity and trending features (global context), and disease/tissue states (combination of local and global tissue context).

### Example 3. Comparison of Run Time and Estimation of Data Dimensionality by Multiple Dimension Reduction Methods

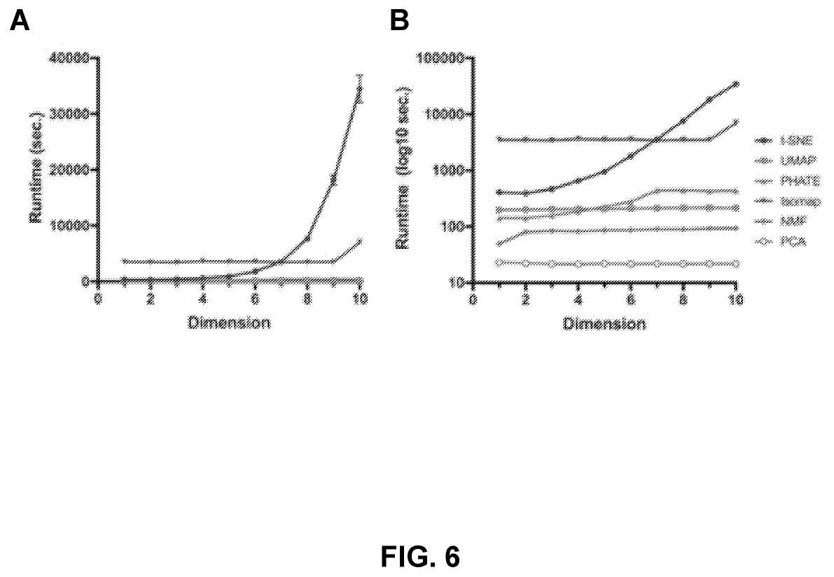

To develop rapid and accurate methods of (1) distinguishing non-healing diabetic foot ulcers (DFUs) at the time of presentation and of (2) assessing the effectiveness of debridement procedures in DFU wound healing a characterization of run time for multiple dimension reduction methods was performed on multi-modal and high-dimensional imaging MSI datasets. In order to condense the dimensionality of the MSI datasets the dimension reduction techniques uniform manifold approximation and projection (UMAP), isometric mapping (Isomap), t-distributed stochastic neighbor embedding (t-SNE), potential of heat diffusion for affinity-based transition embedding (PHATE), principal component analysis (PCA), and non-negative matrix factorization (NMF) were used (FIG. 5). The intrinsic dimensionality of the MSI data was estimated by each dimension reduction method (FIG. 5). Embedding error, as the mean and standard deviation (n=5) was plotted as a function of dimensions 1-10 for all methods. Convergence on an embedding error value indicated that increasing the dimension of the resulting embedding no longer improved an algorithm’s ability to capture the complexity of the data. We observed that nonlinear methods of dimensionality reduction, e.g., t-SNE, UMAP, PHATE, and Isomap, converge onto an intrinsic dimensionality far lower than that of linear methods, e.g., NMF and PCA, indicating that far fewer dimensions are needed to accurately describe the dataset. Computational run time for each algorithm was measured and plotted as the mean run time and standard deviation accorss each number of dimensions (FIG. 6). The nonlinear methods t-SNE and Isomap required longer run times than the nonlinear methods of PHATE and UMAP. Linear methods required the least amount of run time but also fail to capture the data complexity succinctly. The results showed that the UMAP algorithm, a manifold-based nonlinear technique, provided the best representation of MSI data in comparison to the other methods based on standards of image registration and experiments on computational complexity, robustness to noise, and ability to capture information in low-dimension embeddings.

### Example 4. Comparison of Mutual Information Captured by Each of the Tested Dimension Reduction Methods

Mutual information between grayscale versions of three-dimensional embeddings of MSI data and the corresponding H&E stained tissue section was characterized for the nonlinear, e.g., t-SNE, UMAP, PHATE, and Isomap, and linear, e.g., NMF and PCA, dimension reduction methods (FIGS. 7A-7C). The standard for image registration of grayscale multi-modal image alignment using mutual information as a cost function was implemented. Images resulting from each dimension reduction method were processed with an equivalent deformation field to facilitate the spatial alignment with the same H&E image. The mutual information between the H&E grayscale image and each three-dimensional embedding was then calculated. Mutual information was defined to be greater than or equal to zero where negative values are consistent with minimizing a cost function in the registration process. Results showed that Isomap and UMAP consistently shared more information with the H&E grayscale image than the other tested methods (FIGS. 7A, 7B, and 7C).

### Example 5 Dimension Reduction Process Pipeline

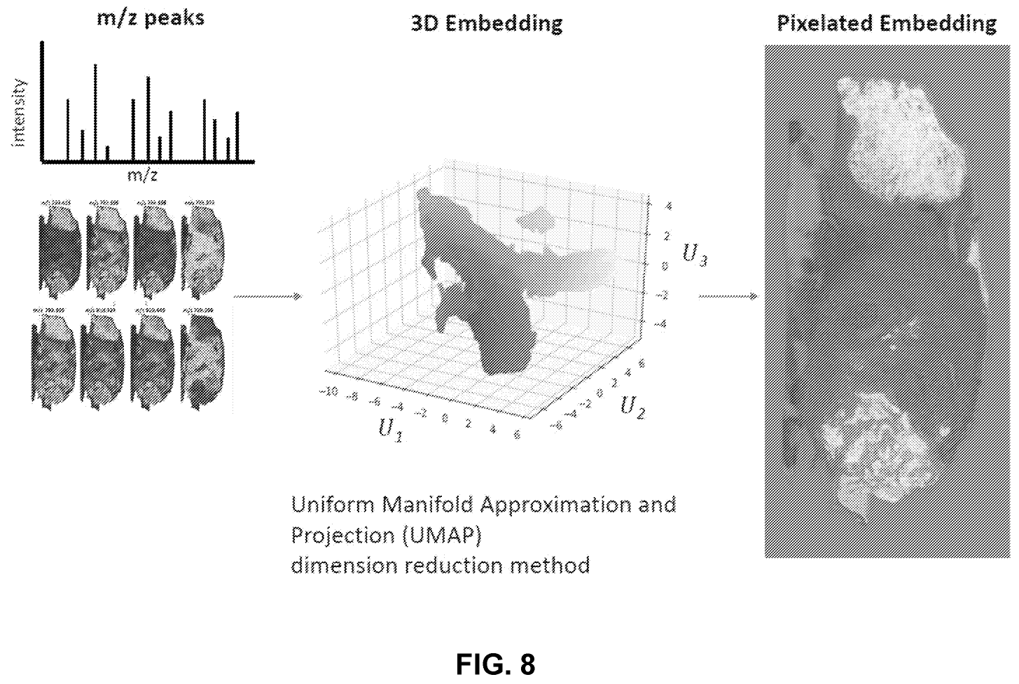

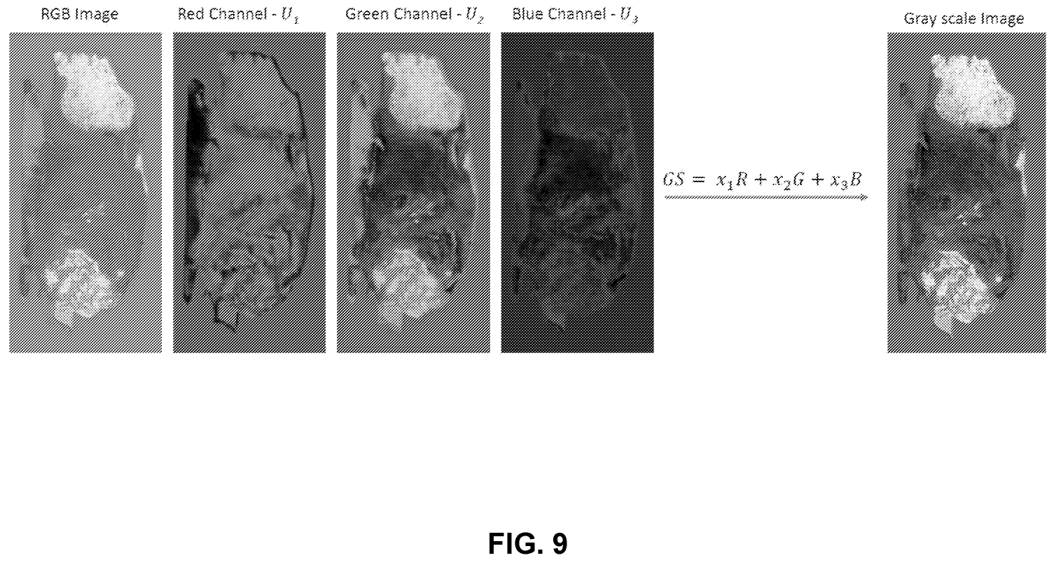

Dimension reduction using UMAP was performed on a DFU biopsy MSI dataset (FIGS. 8-9). Each UMAP dimension in the three-dimensional embedding was pseudo-colored, e.g., red for dimension U1, green for dimension U2, and blue for dimension U3 (FIG. 9). Overlaying the three channels yielded a composite grayscale image used for further analyses including registration and feature extraction methods. FIG. 8 illustrates this process, as raw MSI m/z data (left panel) are subjected in this example to three-dimensional to dimension reduction using UMAP (middle panel). The embedding dimensions can be assigned arbitrary colors to better visualize the projection of the data along the three dimensions. After UMAP 3D embedding, each pixel of the data set, now color-coded according to the UMAP dimension they fall under, can be mapped back onto their original locations on the DFU image (right panel). This allows the visualization of any structure in the high-dimensional dataset as it relates to the tissue section from which it was collected.

### Example 6. Comparative Assessment of Robustness to Noise of Selected Dimension Reduction Methods

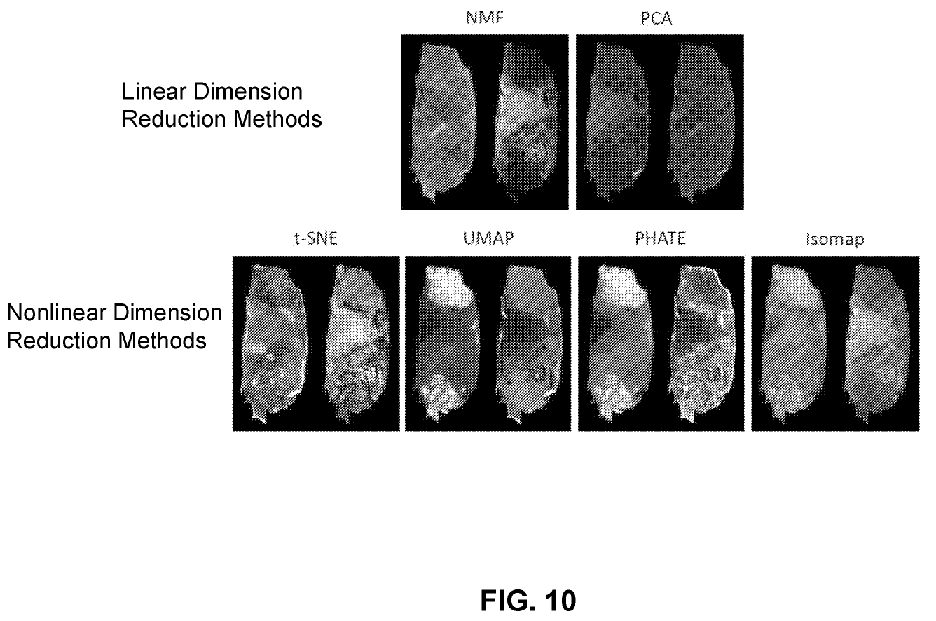

Linear dimension reduction methods, e.g., NMF and PCA, suffer from over-estimating intrinsic dimensionality of data and are sensitive to noisy channels. Dimension reduction of linear and nonlinear methods was performed, and the first two dimensions of each method’s four-dimensional embeddings were visualized (FIG. 10). Linear methods required higher number of features to capture the complexity of a dataset and oftentimes features captured were confounded by noise and some features are solely dedicated to representing noise. To further assess the robustness to noise of the nonlinear, e.g., t-SNE, UMAP, PHATE, and Isomap, and linear, e.g., NMF and PCA, dimension reduction methods the manifold structure of full mass spectrometry imaging (MSI) data (noisy) and denoised MSI data (peak-picked) was characterized using the Denoised manifold preservation (DeMaP) metric. The DeMaP metric between Eucledian distances in resulting embeddings corresponding to noisy MSI data and geodesic distances of corresponding peak-picked data was calculated. The mean and standard deviation DeMaP metric for all tested dimension reduction methods was plotted across dimensions 1-10 (FIG. 7C).

### Example 7 Multi-Scale Image Registration Pipeline

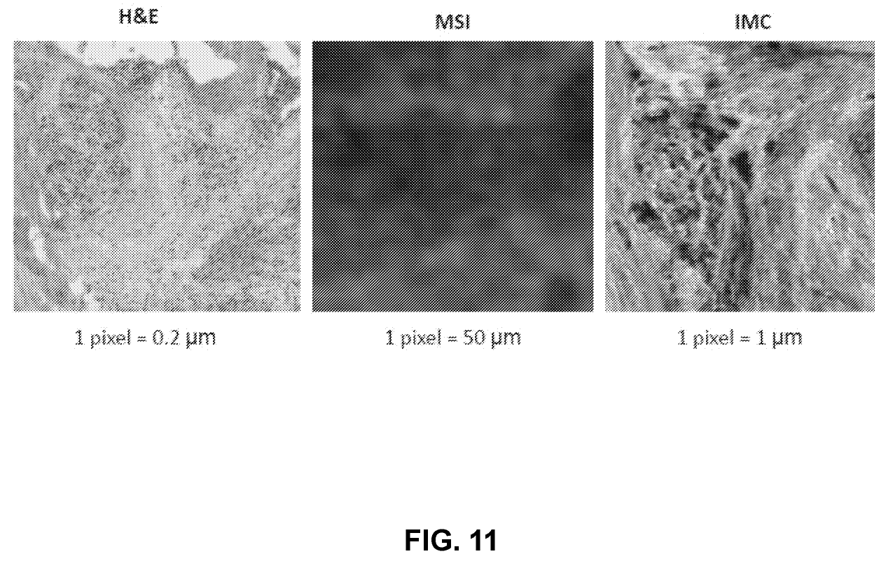

A multi-scale iterative registration approach that first spatially aligned multimodal image datasets at the whole tissue level, referred to as global registration, followed by higher resolution registration at subset regions of interest (ROIs), referred to as local registration, was performed. Spatial resolution of imaging modalities varies widely between them, e.g., MSI resolution ~ 50 µm, H&E and Toluidine Blue resolution ~ 0.2 µm, and IMC resolution ~ 1.0 µm (FIG. 11). To preserve the spatial coordinates of high-dimensional, high-resolution structures and tissue morphology during multi-modal image registration we maintain the higher resolution images unchanged at each step of the registration scheme serving as reference images to which all other images were aligned.

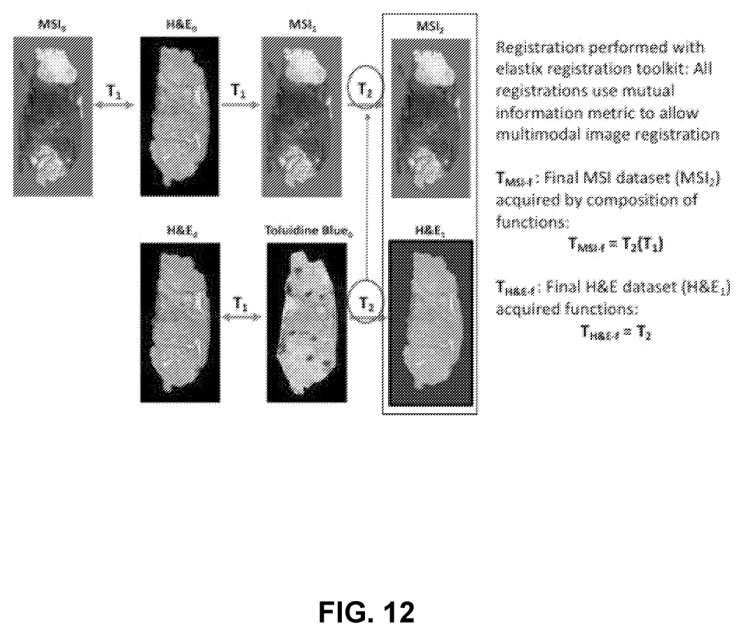

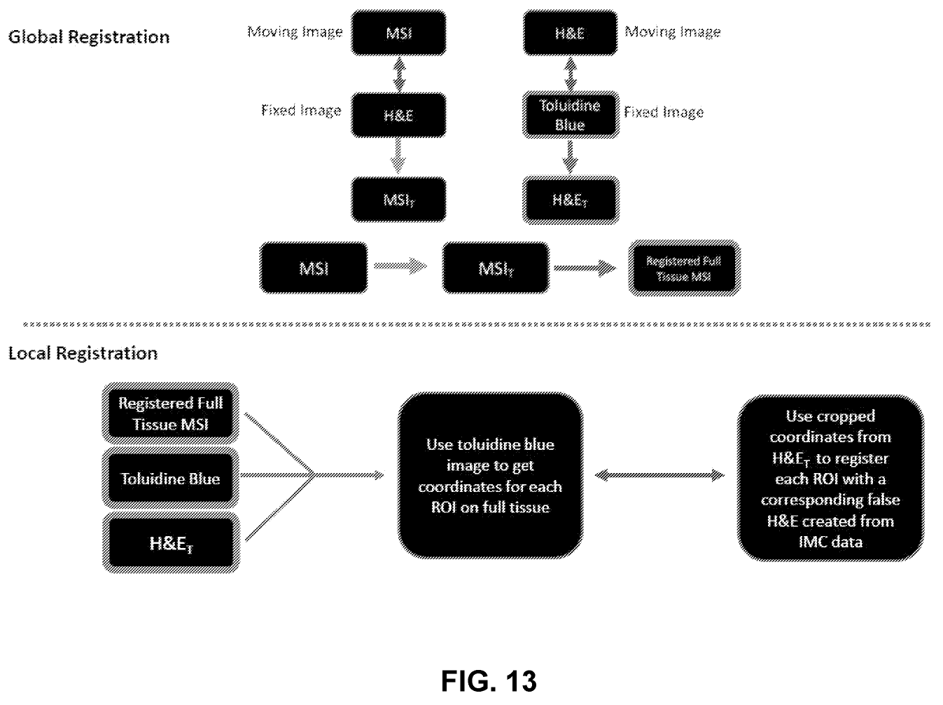

Global grayscale image registration on DFU biopsy tissue imaged with MSI, H&E staining and Toluidine Blue staining was performed with a multi-step process using Elastix registration toolkit (FIG. 12). MSI images were first processed for dimension reduction using UMAP. The resulting MSI image after UMAP dimension reduction, referred to as MSI₀, was registered to its corresponding H&E₀ image to produce the transformed MSI₁ image (FIGS. 12 and 13). This transformation (T1) warps the MSI image while keeping the H&E image fixed. The result is a transformed MSI image (MSI₁) that is aligned to the H&E image. In parallel, the H&E₀ image was registered to its corresponding Toluidine Blue₀image, a separate, adjacent tissue section of the same DFU biopsy, which was used for IMC imaging. Toluidine Blue₀ contained the spatial coordinates for IMC regions of interest that serve as reference coordinates for subsequent local transformations of the images. This transformation (T2) warps the H&E image while keeping the Toluidine blue image fixed. Finally, the transformation T2 is applied to the already transformed MSI₁, to yield an MSI image (MSI₂) that is registered to the Toluidine blue₀. This process is summarized in the two equations: T _{MSI-f}= T₂(T₁), where T_{MSI-f} is the final transformed MSI image, used in downstream analysis, T₁ is the registration transformation of the MSI image to H&E image, and T₂ is the registration transformation of the H&E image to the Toluidine blue (IMC) image; and T_{H&E-f}= T₂, where T_{H&E-f} is is the final transformed H&E image, used in downstream analysis and T₂ is as above, the registration transformation of the H&E image to the Toluidine blue (IMC) image.

After spatially aligning images from all modalities at the global level, we incorporated a secondary fine-tuning step of image alignment for smaller-sized ROls (FIG. 13). A result of the destructive nature of the IMC imaging is the necessity to add spatial information about the sample imaged using reference images of the same sample collected prior to IMC. Reference images were obtained from images stained with Toluidine Blue providing the ability to correct for local deformations that occur in tissue samples within each ROI. Fine-tuning of the registration at the local scale was performed by selecting regions of interest within the Toluidine Blue images corresponding to each MSI image. The overall registration for a single ROI is performed by the appropriate (modality-dependent) sequence of transformations, first at the global level followed by local transformation (FIG. 14).

### Example 8 Feature Extraction and Analysis of Multi-Modal Data

Spatially aligned images from multi-modal datasets were analyzed to identify objects in a process called segmentation. Once spatially resolved objects are identified, we began to compare data from different modalities with respect to those objects by using their spatial coordinates. We compared features from registered images containing data from an IMC dataset, used to identify single-cell coordinates due to its relatively higher spatial resolution, and an MSI dataset (images A-C and A″-C″ in FIG. 15). The data was subsequently clustered based on single-cell measurements in the IMC modality alone and in the MSI modality alone. The clustering of IMC single-cell measurements was used to determine cell types (images A′-C′ and A‴-C‴ in FIG. 15). The ability to integrate multiple imaging modalities allowed us to perform permutation testing for enrichment or depletion of certain features in the MSI modality as a function of the corresponding cell types defined in the IMC dataset.

### Example 9 Multi-Omics Image Alignment and Analysis by Information Manifolds (MIAAIM)

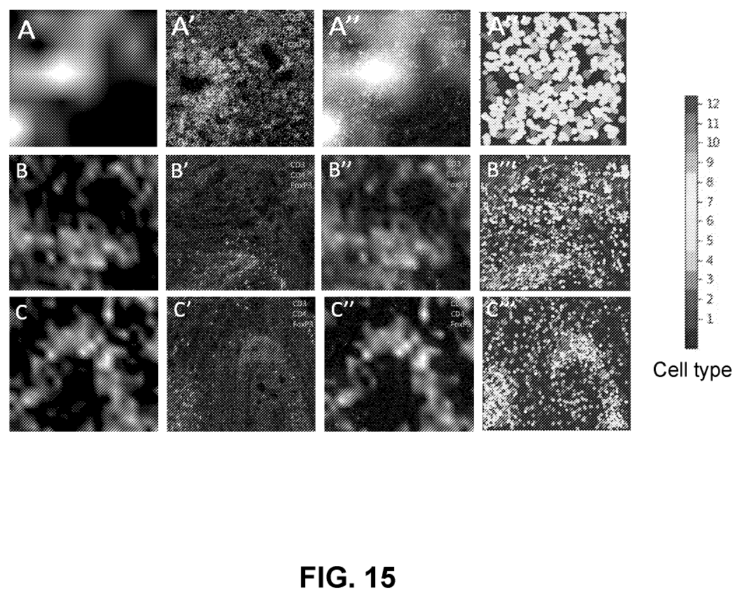

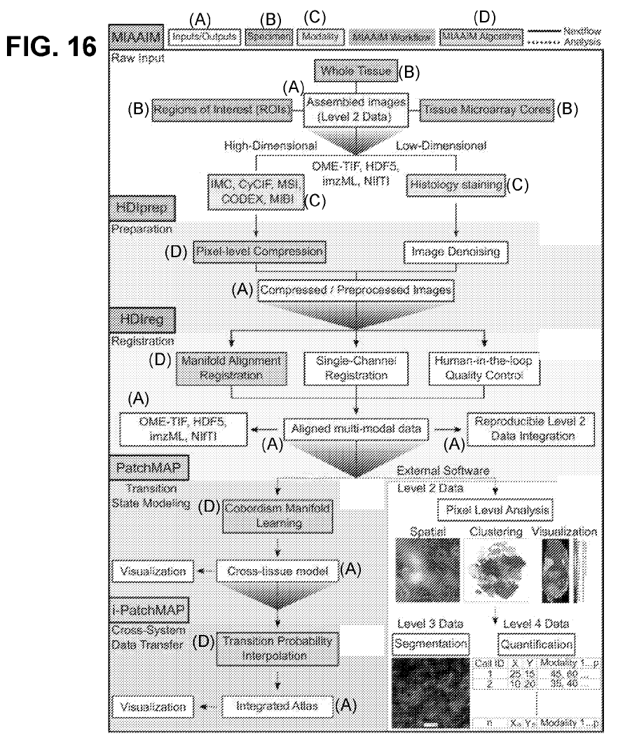

MIAAIM is a sequential workflow aimed at providing comprehensive portraits of tissue states. It includes 4 processing stages: (i) image preprocessing with the high-dimensional image preparation (HDIprep) workflow, (ii) image registration with the high-dimensional image registration (HDIreg) workflow, (iii) tissue state transition modeling with cobordism approximation and projection (PatchMAP), and (iv) cross-modality information transfer with i-PatchMAP (FIG. 16). Image integration in MIAAIM begins with two or more assembled images (level 2 data) or spatially resolved raster data sets (assembled images, FIG. 16). The size and standardized format of assembled images vary by technology. For example, cyclic fluorescence-based methods (e.g., CODEX, CyCIF) assemble BioFormats/OME-compatible 20-60-plex full-tissue mosaic images after correcting uneven illumination (e.g., BaSiC) and stitching tiles (e.g., ASHLAR); other methods acquire 20-100-plex data directly at regions of interest (ROIs) (e.g., MIBI, IMC). Additional methods quantify thousands of parameters at rasterized locations on full tissues or ROls and are not stored in BioFormats/OME-compatible formats. For example, the imzML format that builds on the mzML format used by Human Proteome Organization often stores MSI data.

Regardless of technology, assembled images contain high numbers of heterogeneously distributed parameters, which precludes comprehensive, manually-guided image alignment. In addition, high-dimensional imaging produces large feature spaces that challenge methods commonly used in unsupervised settings. The HDlprep workflow in MIAAIM generates a compressed image that preserves multiplex salient features to enable cross-technology statistical comparison while minimizing computational complexity (HDIprep, FIG. 16). For images acquired from histological staining, HDIprep provides parallelized smoothing and morphological operations that can be applied sequentially for preprocessing. Image registration with HDIreg produces transformations to combine modalities within the same spatial domain (HDIreg, FIG. 16). HDIreg uses Elastix, a parallelized image registration library to calculate transformations, and is optimized to transform large multichannel images with minimal memory use, while also supporting histological stains. HDIreg automates image resizing, padding, and trimming of borders prior to applying image transformations.

Aligned data are well-suited for established single-cell and spatial neighborhood analyses - they can be segmented to capture multi-modal single-cell measures (level 3 and 4 data), such as average protein expression or spatial features of cells, or analyzed at pixel level. A common goal in pathology, however, is utilizing composite tissue portraits to map healthy-to-diseased transitions. Similarities between systems-level tissue states can be visualized with the PatchMAP workflow (PatchMAP, FIG. 16). PatchMAP models tissue states as smooth manifolds that are stitched together to form a higher-order manifold, called a cobordism. The result is a nested model capturing nonlinear intra-system states and cross-system continuities. This paradigm can be applied as a tissue-based atlas-mapping tool to transfer information across modalities with i-PatchMAP (i-PatchMAP, FIG. 16).

MIAAIM’s workflows are nonparametric, using probability distributions supported by manifolds rather than training data models. MIAAIM is therefore technology-agnostic and generalizes to multiple imaging systems (Table 1). Nonparametric image registration, however, is often an iterative, parameter-tuning process rather than a “black-box” solution. This creates a substantial challenge for reproducible data integration across institutions and computing architectures. We therefore Docker containerized MIAAIM’s data integration workflows and developed a Nextflow implementation to document human-in-the-loop processing and remove language-specific dependencies in accordance with the FAIR (finable, accessible, interoperable, and reusable) data stewardship principles.

TABLE 1

| | | | | | |
|---|---|---|---|---|---|
| Imaging Technology | Input File Format | Parameters Detected | Tested with MIAAIM | Type of Processing | Data Set Reference |
| MSI [50] | imzML | Proteins, Lipids, Metabolites | ✓ | Compression | This study |
| Histological Stains (e.g. H&E) | TIF(F) | Tissue morphology | ✓ | Denoising | This study |
| IMC [51] | OME-TIF(F) | Subcellular proteomics | ✓ | Compression | This study |
| MIBI [52] | TIF(F) | Subcellular proteomics | ✓ | Compression | [57] |
| CODEX [53] | TIF(F) Hyper Stack | Subcellular proteomics | ✓ | Compression | [53] |
| CyCIF [54] | OME-TIF(F) | Subcellular proteomics | ✓ | Compression | [58] |
| 4i [55] | - | Sub-organelle proteomics | × | Compression | - |
| Slide-seq [56] | - | Subcellular Transcriptomics | × | Compression | - |
| RNA-ISH related technologies | - | Transcriptomics | × | Compression | - |

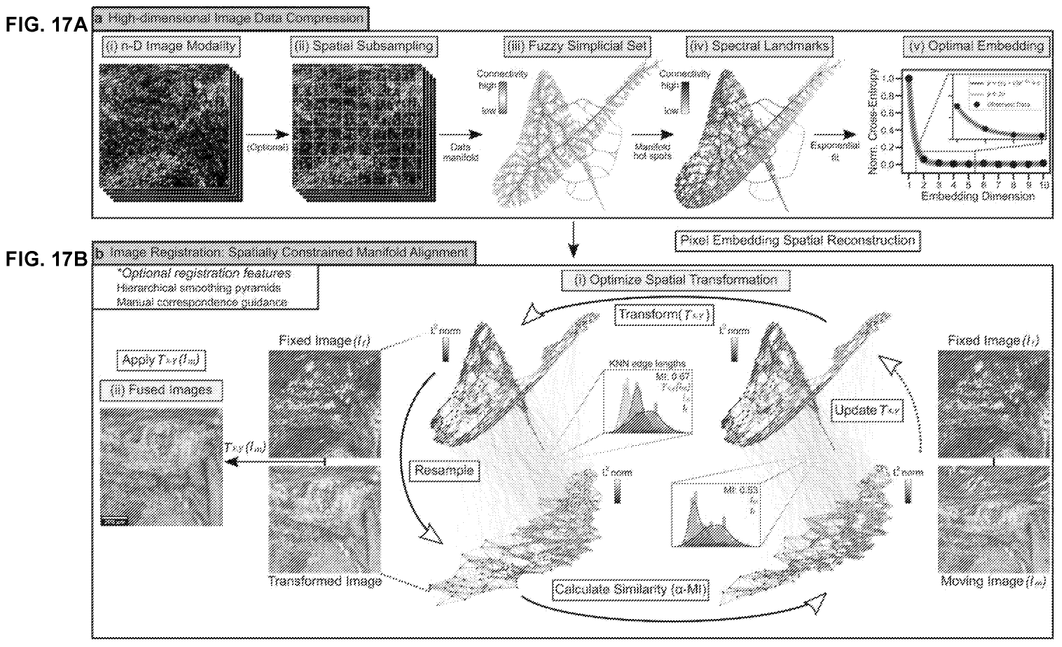

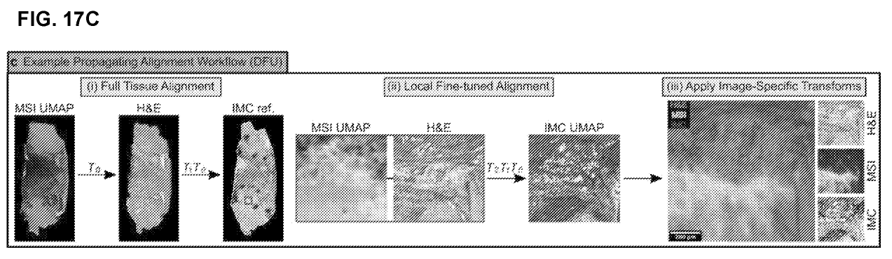

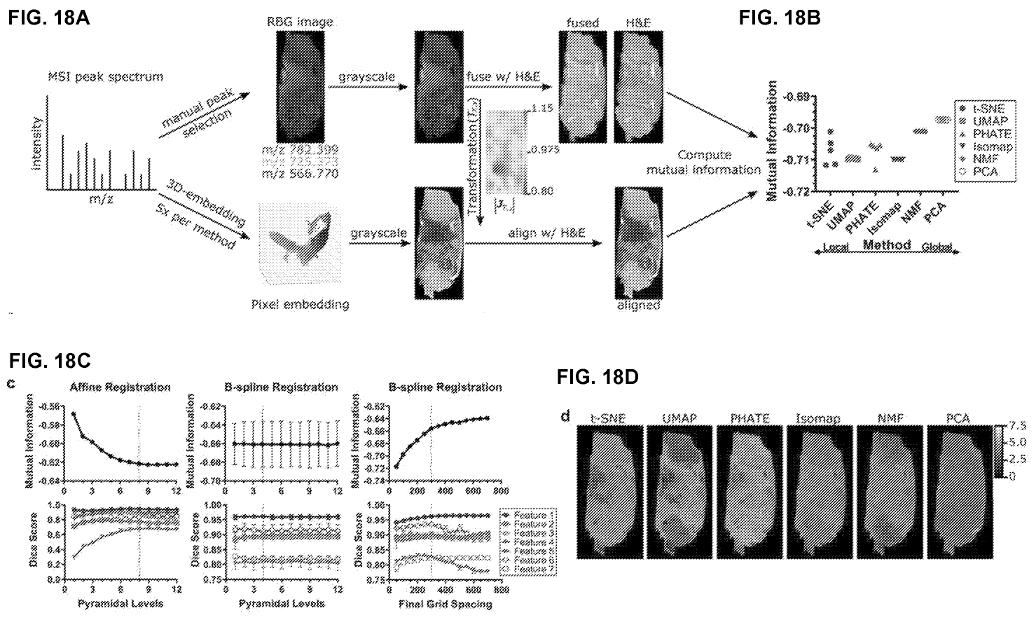

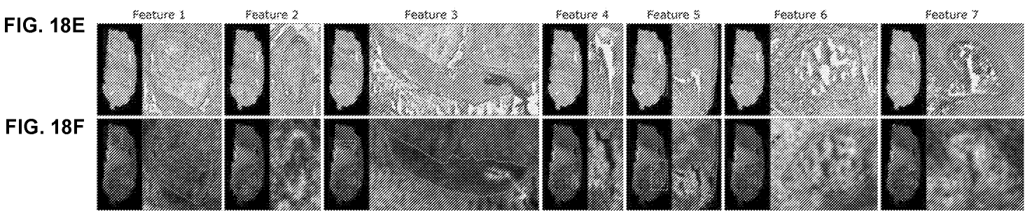

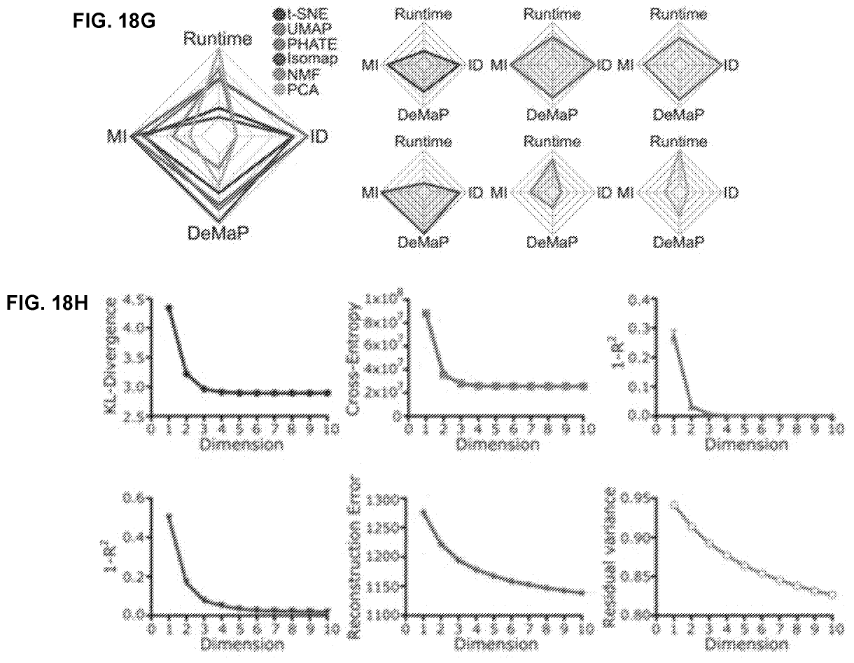

High-Dimensional Image Compression with HDIprep. To compress high-parameter images, HDIprep performs dimensionality reduction on pixels using Uniform Manifold Approximation and Projection (UMAP) (FIG. 17A). We performed a stringent comparison using new imaging data sets of diverse tissue biopsies with high complexity of cellular states, including human DFU, prostate cancer, and healthy tonsil acquired using MSI, IMC, and hematoxylin and eosin (H&E). Based on dimensionality reduction benchmarks, UMAP consistently outperformed competing linear, nonlinear, global, and local information preserving algorithms in its robustness to noise and ability to efficiently preserve data complexity while capturing morphological structure (FIGS. 18A-18I, 19A-19H, and 20A-20H).

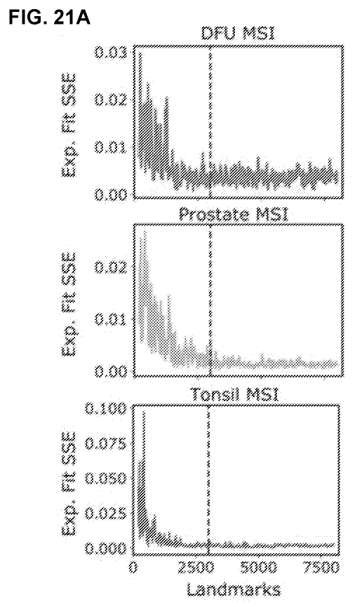

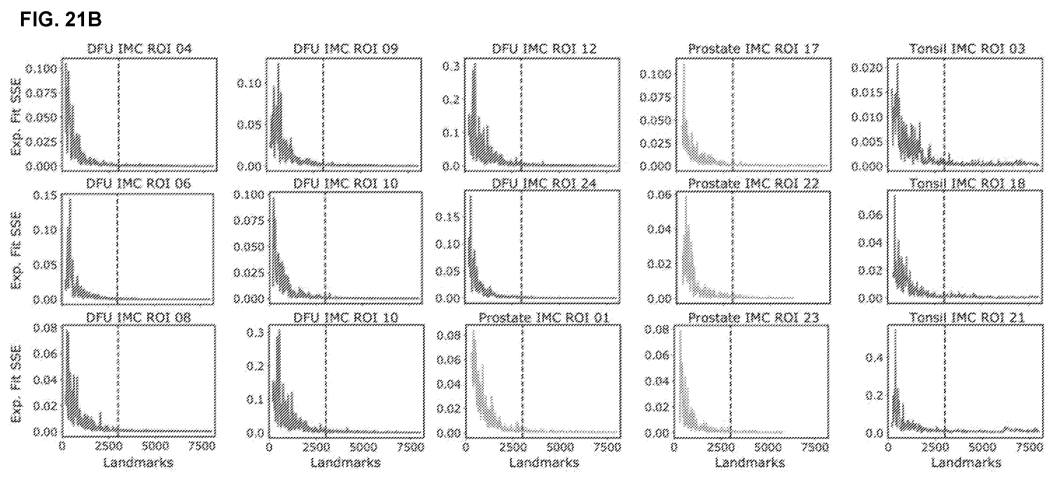

HDIprep retains global data complexity with the fewest degrees of freedom necessary by detecting steady-state manifold embeddings. To identify steady-state dimensionalities, information captured by UMAP pixel embeddings is computed (cross-entropy, Definition 1, Methods) across a range of embedding dimensionalities, and the first dimension where the observed cross-entropy approaches the asymptote of an exponential regression fit is selected. Steady state embedding calculations scale quadratically with the number of pixels, HDIprep therefore embeds spectral landmarks in the pixel manifold representative of its global structure (FIGS. 21A and 21B).

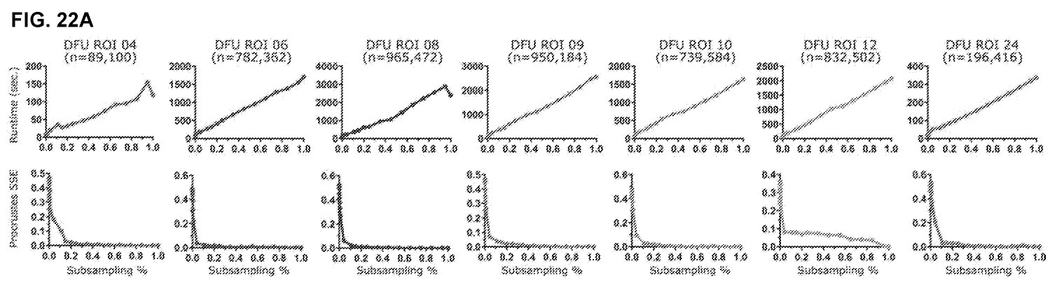

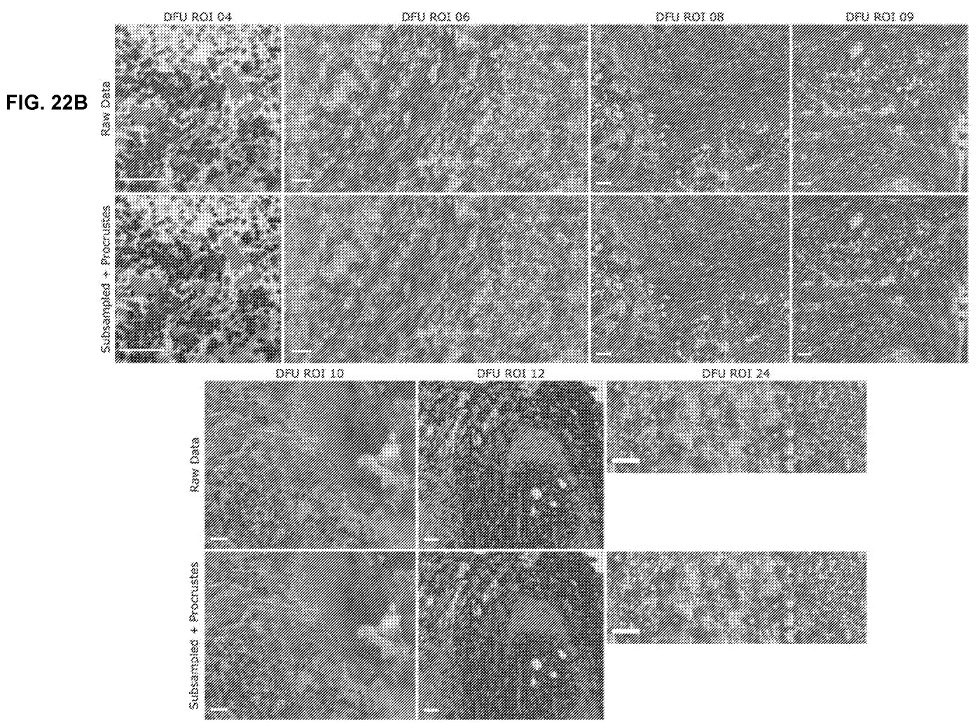

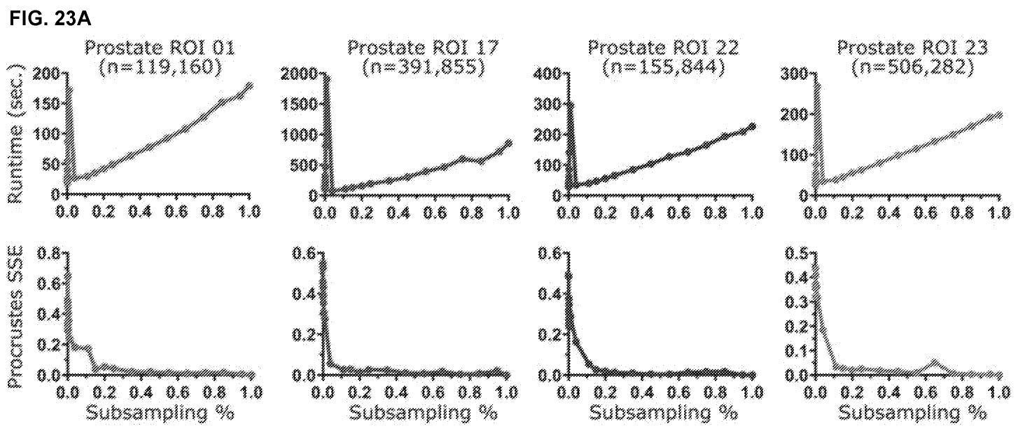

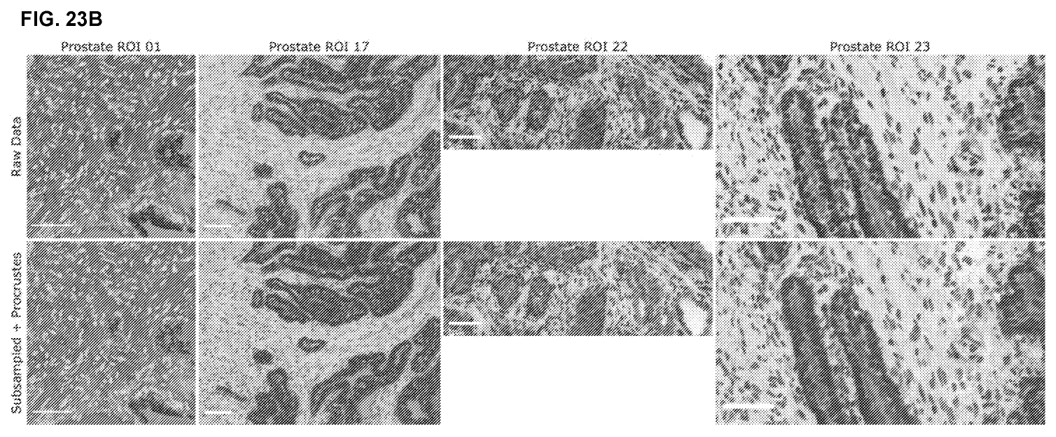

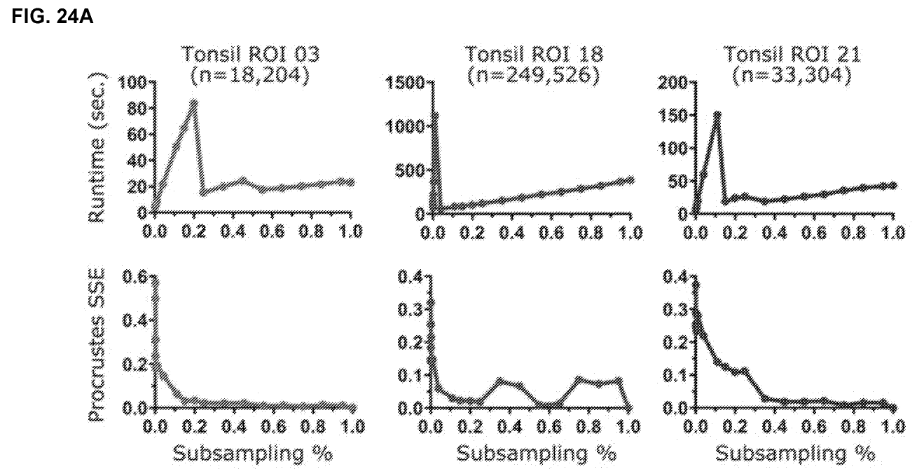

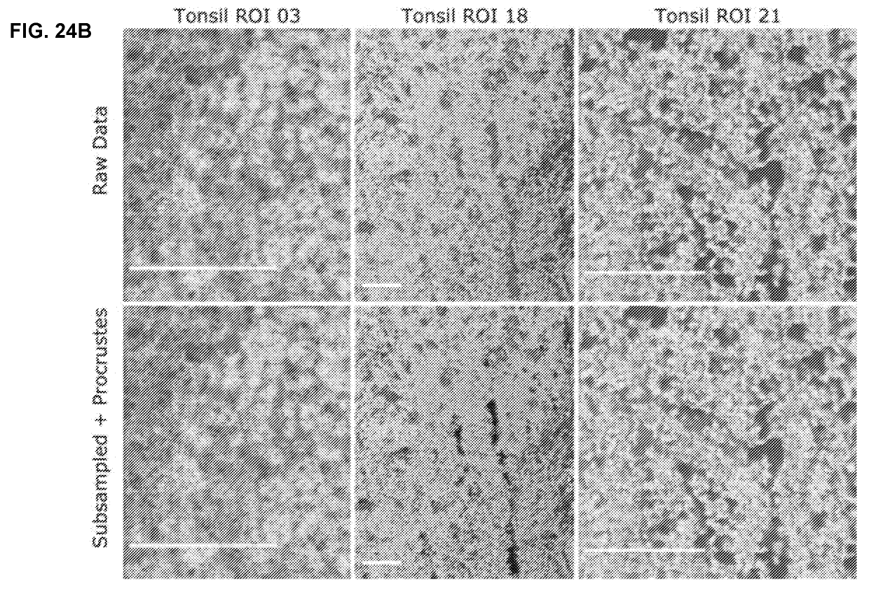

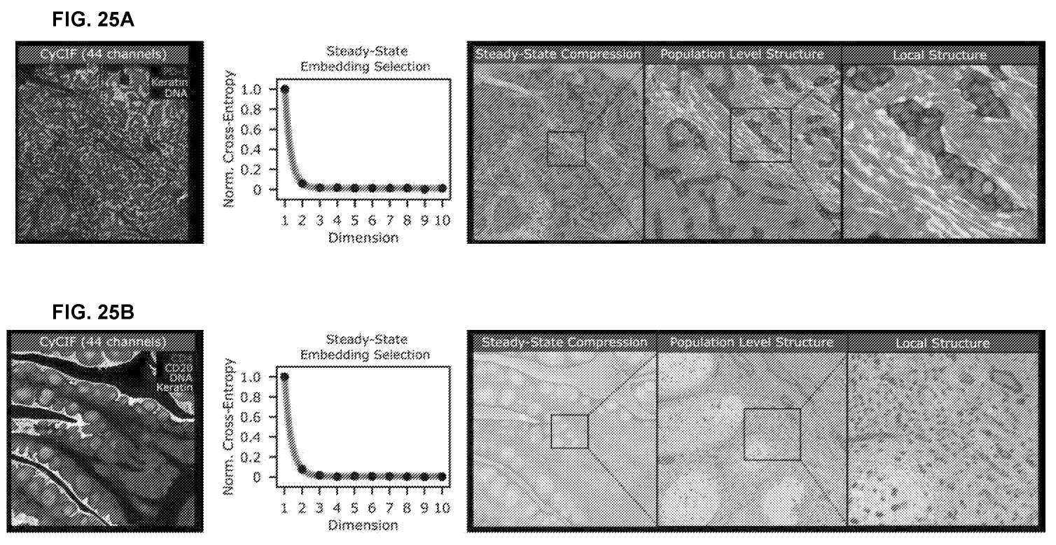

Pixel-level dimensionality reduction is computationally expensive for large images, i.e., at high resolution (e.g., 1 µm/pixel). To reduce compression time while preserving quality, we developed a subsampling scheme to embed a spatially representative subset of pixels prior to spectral landmark selection and project out-of-sample pixels into embeddings (FIGS. 22A, 22B, 23A, 23B, 24A, and 24B). HDIprep also combines all optimizations with a recent neural-network UMAP implementation to scale to whole-tissue images. We demonstrate its efficacy on publicly available 44-channel CyCIF images containing ~100 and ~256 million pixels (FIGS. 25). Thus, HDIprep presents an objective, pixel-level compression method applicable to multiple modalities (Algorithm 1, Methods).

High-Dimensional Image Registration (HDIreg). MIAAIM connects the HDlprep and HDIreg workflows with a manifold alignment scheme parametrized by spatial transformations. We developed theory for computing manifold α-entropy using entropic graphs on UMAP embeddings and applied it to image registration using the entropic graph-based Rényi α-mutual information (α-MI) (HDIreg, Methods). HDIreg produces a transformation that maximizes image-to-image (manifold-to-manifold) α-MI (FIG. 17B). This image similarity measure generalizes to Euclidean embeddings of arbitrary dimensionalities by considering distributions of k-nearest neighbor (KNN) graph lengths of compressed pixels, rather than directly comparing the pixels themselves. Combining HDIprep compression with KNN α-MI extends intensity-based registration to complex images without corresponding counterstains across technologies.

Proof-of-principle 1: MIAAIM generates information on cell phenotype, molecular ion distribution, and tissue state across scales. To highlight the utility of high-dimensional image integration, we applied the HDlprep and HDIreg workflows to MALDI-TOF MSI, H&E and IMC data from a DFU tissue biopsy containing a spectrum of tissue states, from the necrotic center of the ulcer to the healthy margin. Image acquisition covered 1.2 cm² for H&E and MSI data. Molecular imaging with MSI enabled untargeted mapping of lipids and small metabolites in the 400-1000 m/z range across the specimen at a resolution of 50 µm/pixel. Tissue morphology was captured with H&E at 0.2 µm/pixel, and 27-plex IMC data was acquired at 1 µm/pixel resolution from 7 ROls on an adjacent section.

Cross-modality alignment was performed in a global-to-local fashion (FIG. 17C). We utilized HDIprep compression for high-parameter data and HDlreg manifold alignment for registration of compressed images. Due to the destructive nature of IMC acquisition at small ROIs², we aligned full-tissue data from MSI, H&E (down-sampled to approximately 3.5 µm/pixel), and an IMC reference image first. Local deformations not captured at the full-tissue scale within each ROI were corrected using manual landmark guidance. Serial sectioning deformations were accounted for with nonlinear transformations. Registrations were initialized by affine transformations for coarse alignment before nonlinear correction. Resolution differences were accounted for with a multiresolution smoothing scheme. Final alignment proceeded by composing both modality and ROI-specific transformations.

After segmentation, quantification with the image processing software, MCMICRO, and antibody staining quality control, registered images yielded the following information for 7,114 cells: (i) average expression of 14 proteins including markers for lymphocytes, macrophages, fibroblasts, keratinocytes, and endothelial cells, as well as extracellular matrix proteins, such as collagen and smooth muscle actin; (ii) morphological features, such as cell eccentricity, solidity, extent, and area, spatial positioning of each cell centroid; and (iii) the distribution of 9,753 m/z MSI peaks across the full tissue. Distances from each MSI pixel and IMC ROI to the center of the ulcer, identified by manual inspection of H&E, were also quantified. Through the integration of these modalities, MIAAIM provided cross-modal information that could not be gathered with any single imaging system alone, such as profiling of single-cell protein expression and microenvironmental molecular abundance.

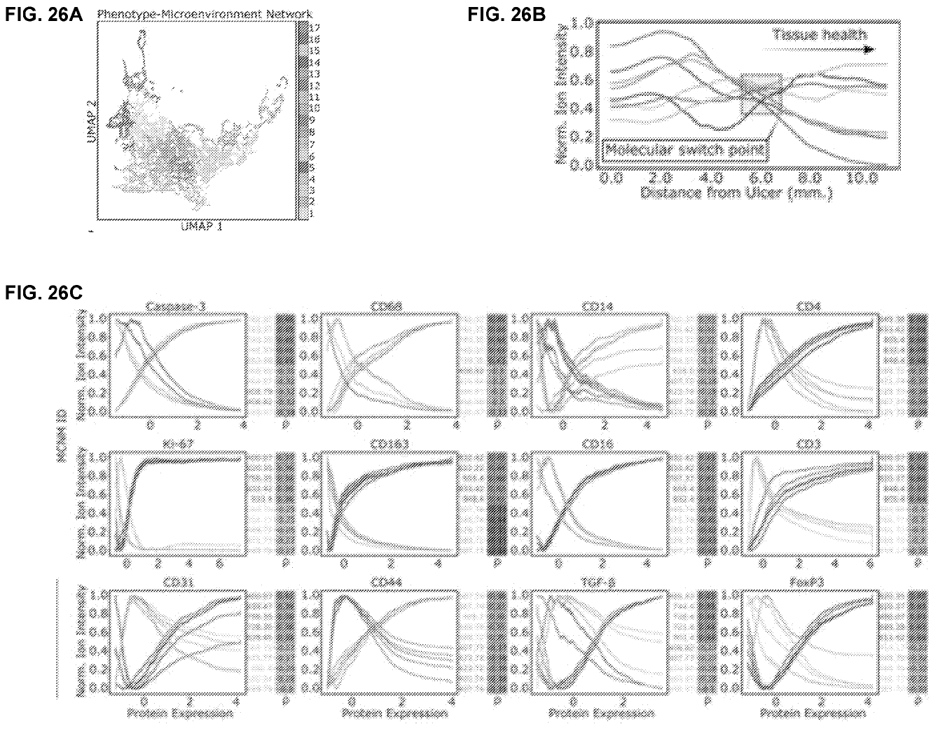

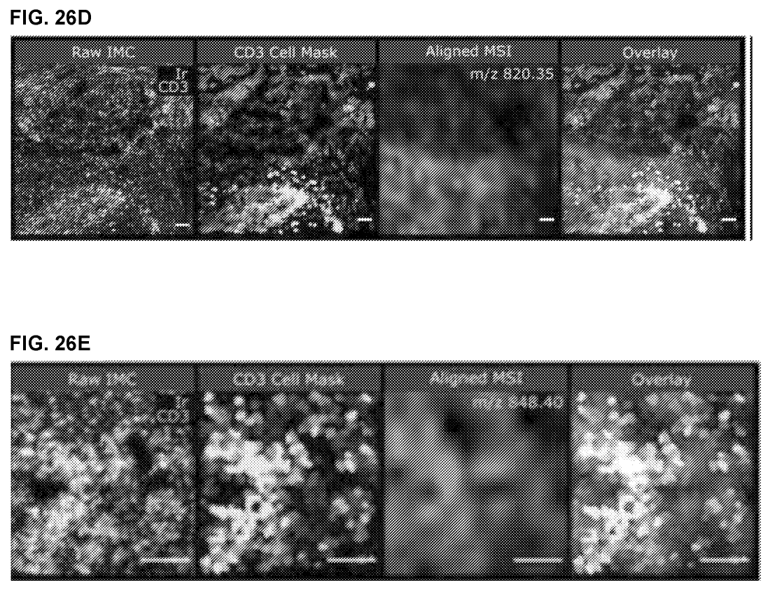

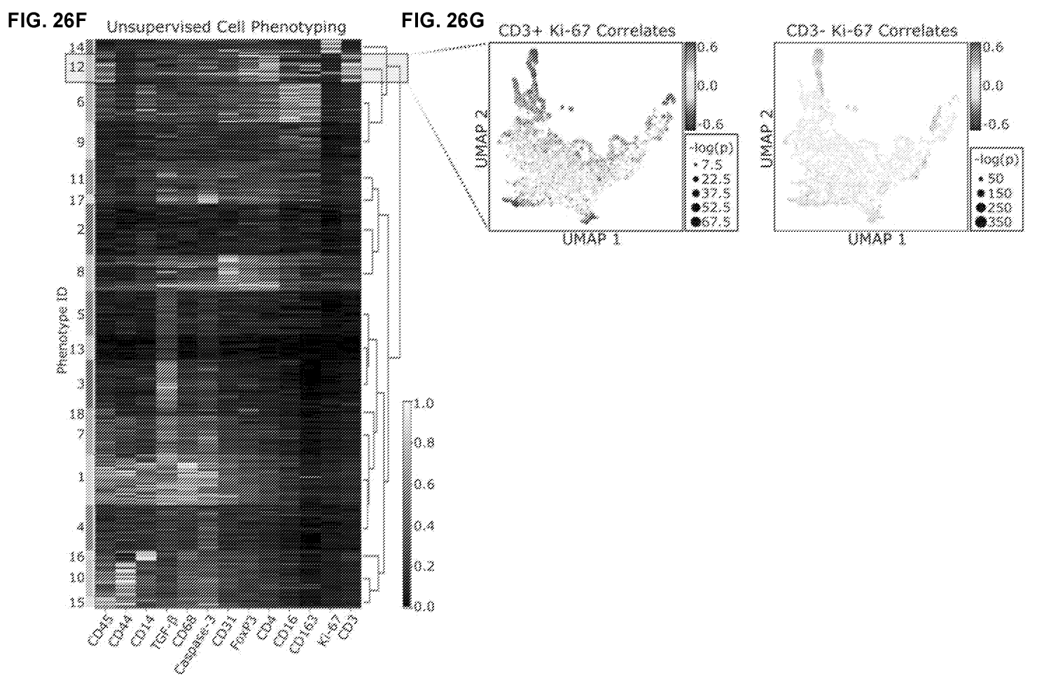

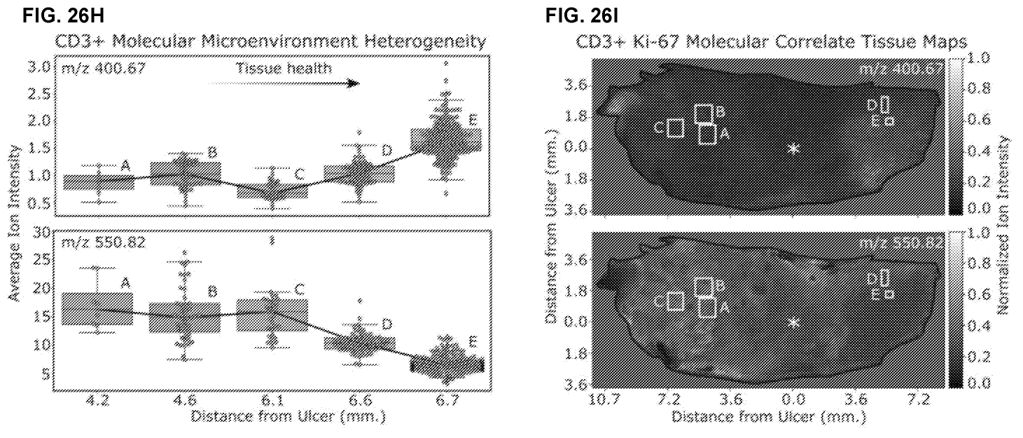

Proof-of-principle 2: Identification of molecular microenvironmental niches correlated with cell and disease states through multiple-omics networking. We verified the existence of cross-modal associations from Proof-of-principle 1 by conducting a microenvironmental correlation network analysis (MCNA) on registered IMC and MSI data (FIGS. 26A-26I). We performed community detection (i.e., clustering) on MSI analytes (m/z peaks) based on their correlations to single-cell protein measures and defined microenvironmental correlation network modules (MCNMs; different colors in FIG. 26A). Inspection of MCNMs with top correlations to protein levels identified with IMC revealed that sets of molecules, rather than individual peaks, were associated with cellular protein expression (FIG. 26B). MCNMs organized on an axis separating those with moderate positive correlations to cell markers indicative of inflammation and cell death (CD68, activated Caspase-3) and those with moderate positive correlations to markers of immune regulation (CD163, CD4, FoxP3) and vasculature (CD31). Some proteins, such as CD14 (myeloid cell marker) and the cell proliferation marker Ki-67, were not strongly correlated with any m/z peaks across all cells.

To gain insights into the association of molecular distributions with tissue health, we plotted ion intensity distributions of MCNMs with respect to their proximity to the center of the ulcer (FIG. 26C). This analysis revealed a switch in molecular profiles about 6 mm from the ulcer center point, as the tissue state progressed from healthy to injured. We validated our observations and the performance of HDIreg to align micron-scale structures by visualizing the distribution of top correlated ions within cellular microenvironments (FIGS. 26D and 26E).

A benefit of our analysis is the potential to identify molecular variations in one modality (here, MSI) that correlate with cell states identified using a different modality (here, IMC). We investigated whether m/z peaks differentially associate with cell proliferation (Ki-67 marker in IMC). We identified cell phenotypes through unsupervised clustering on IMC segmented cell-level expression patterns (FIG. 26F) and conducted a differential correlation network analysis between phenotypes within the well-separated CD3+ cluster, which likely identifies infiltrating T cells at the wound site, and the CD3- cell populations (FIG. 26G). Interestingly, we found that correlations to Ki-67 expression shifted with near significance (2σ) for multiple m/z peaks (Fisher transformed, one-sided z-statistics; Bonferroni corrected P-values) between CD3- populations and the CD3+ population (FIG. 26H).

We then utilized spatial context preserved with MIAAIM and observed that ion intensities of m/z peaks positively correlated to Ki-67 in CD3+ cells increased with distance from the wound, while molecules with Ki-67 negative correlations specific to CD3+ cells showed the opposite trend (FIG. 26I). This suggests that proliferation of CD3+ T cells occurs predominantly near the healthy margin of the DFU and confirms that molecular correlates of T-cell proliferation can be identified through this unbiased analysis. Collectively, these results provide insights to molecular microenvironments associated with different functional and metabolic states of specific cell subtypes, and how these microenvironments are distributed in the spatial context in a gradient from injured to healthy tissue.

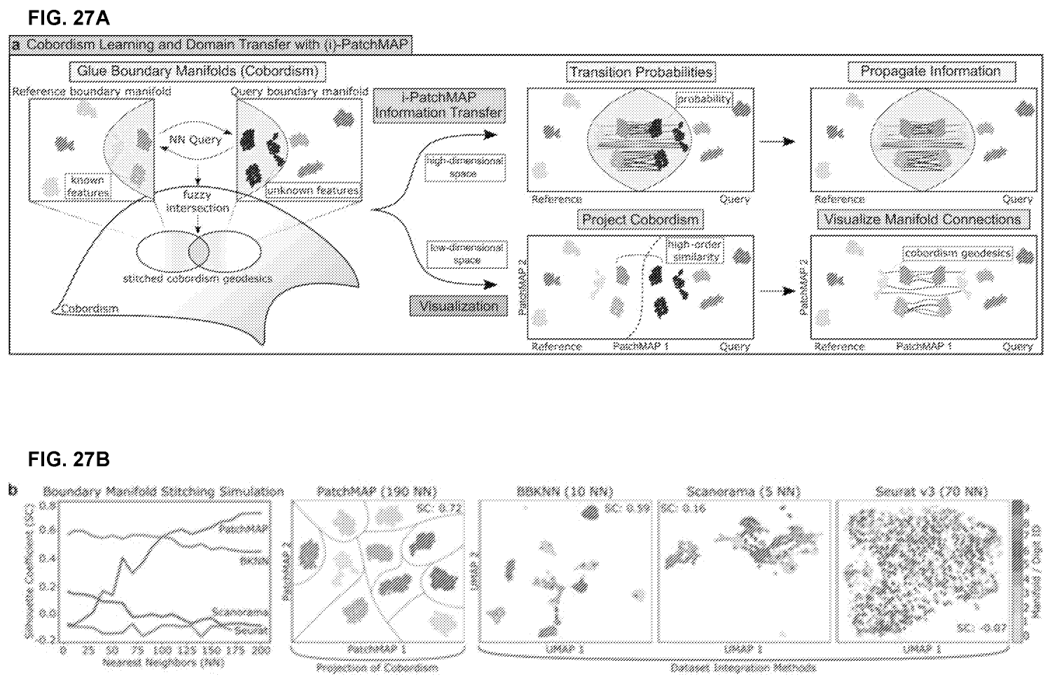

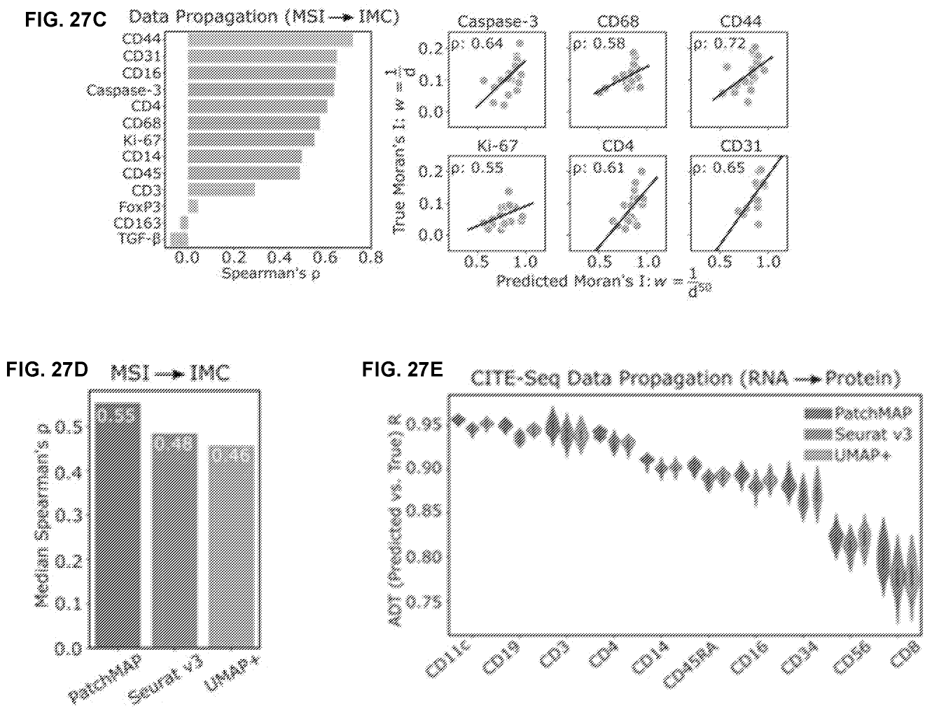

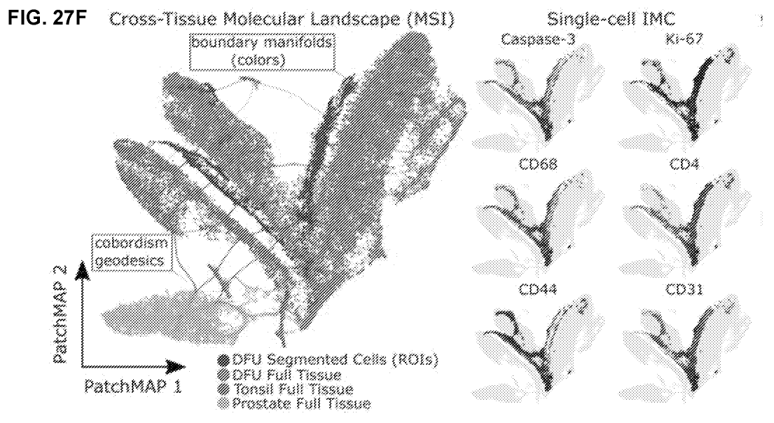

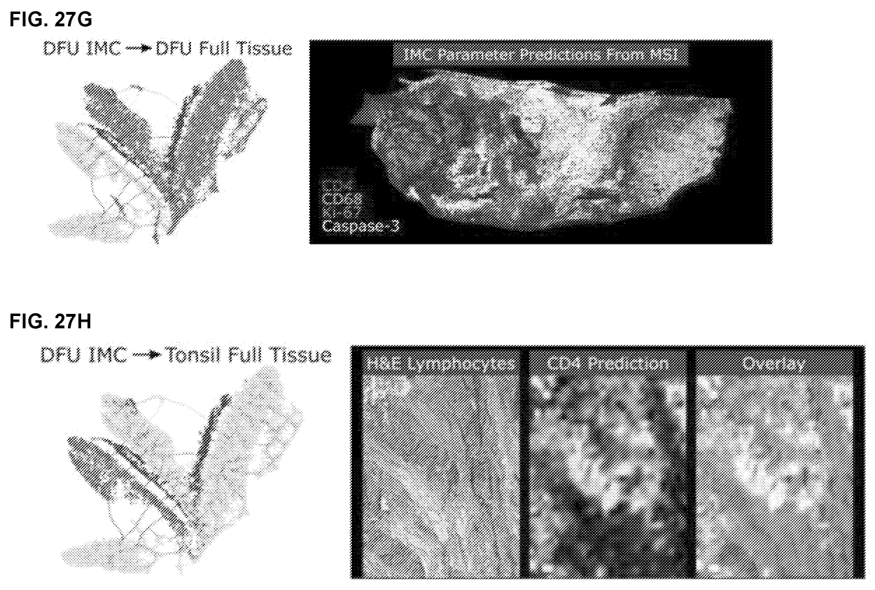

Mapping tissue state transitions via cobordism approximation and projection (PatchMAP). To model transitions between tissue states, such as healthy or injured, we generalized manifold learning and dimension reduction to higher-order instances by developing a new algorithm, called PatchMAP, that integrates mutual nearest-neighbor calculations with UMAP (FIG. 27A and Algorithm 2, Methods). We hypothesized that phase spaces of system-level transitions are nonlinear and could be parametrized consistently with manifold learning. Accordingly, PatchMAP represents disjoint unions of manifolds (i.e., system states) as the boundaries of a higher dimensional manifold (i.e., state transitions), called a cobordism. Overlapping patches are connected by pairwise directed nearest-neighbor queries that represent geodesics in the cobordism between boundary manifolds and stitched using the t-norm to make their metrics compatible. Interpreting PatchMAP embeddings is analogous to existing dimensionality reduction algorithms - similar data within or across boundary manifolds are located close to each other, while dissimilar data are farther apart. PatchMAP incorporates both boundary manifold topological structure and continuities across boundary manifolds to produce cobordisms.

Currently, no method to form cobordisms exists - methods closest to achieving this are dataset integration algorithms from the single-cell biology community. Therefore, to benchmark PatchMAP’s manifold stitching, we compared it to the data integration methods BBKNN, Seurat v3, and Scanorama in a stitching simulation using the “digits” machine learning method development data set (FIG. 27B). We split data by label into boundary manifolds, then applied each method to re-stitch the full data set. In this task, perfect stitching would result in the complete separation of projected boundary manifolds, which we quantified with the silhouette coefficient (SC). For controlled visualization, UMAP was used after data integration to provide analogous embeddings to PatchMAP’s for all benchmark methods.

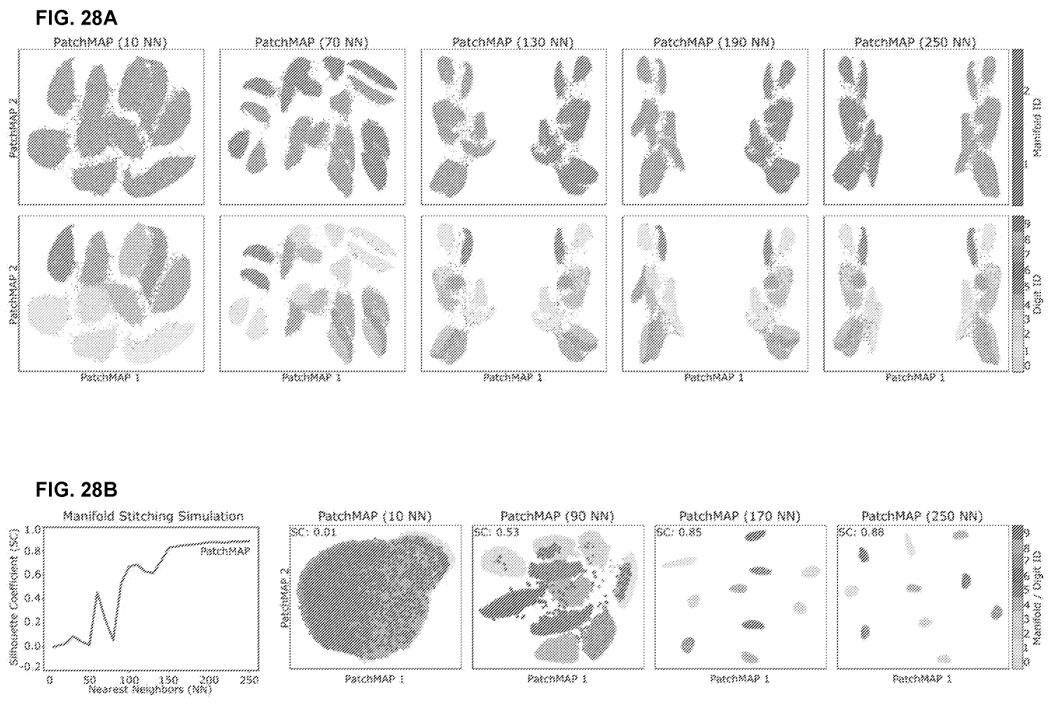

PatchMAP was robust to boundary manifold overlap and outperformed data integration methods at higher nearest-neighbor (NN) counts. All other methods incorrectly mixed boundary manifolds when there was no overlap, as expected given that lack of manifold connections violated their assumptions. By contrast, PatchMAP’s stitching uses a fuzzy set intersection, which prunes incorrectly connected data across manifolds while strongly weighting correct connections. We also validated that PatchMAP preserves boundary manifold organization while embedding higher-order structures between similar boundary manifolds (FIGS. 28A and 28B). At low NN values and when boundary manifolds are similar, PatchMAP resembles UMAP projections (FIGS. 28A and 28B). At higher NN values, manifold annotations are strongly weighted, which results in less mixing and better manifold separation.

Information transfer across imaging technologies and tissues (i-PatchMAP). We posited that the transfer of information across biological states should similarly account for continuous transitions and be robust to manifold connection strength (including the lack thereof). The i-PatchMAP workflow therefore uses PatchMAP as a paired domain transfer and quality control visualization method to propagate information between different samples (information transfer, FIG. 27A). To do that, i-PatchMAP first normalizes connections between boundary manifolds of “reference” and “query” data to define local one-step Markov chain transition probabilities (transition probabilities, FIG. 27A), and then linearly interpolates measures from reference to query data (propagate information, FIG. 27A). Quality control of i-PatchMAP can be performed by visualizing connections between boundary manifolds in PatchMAP embeddings (visualize manifold connections, FIG. 27A).

To benchmark i-PatchMAP, we compared it to other nonparametric domain transfer tools, Seurat v3 and a modification of UMAP incorporating a transition probability-based interpolation similar to i-PatchMAP (UMAP+), on data from Proof-of-principle 1 and a publicly available cord blood mononuclear cell (CBMC) CITE-seq data set¹¹. UMAP+ utilized a directed NN graph from query to reference data for data interpolation, rather than PatchMAP’s metric-compatible stitching. It therefore acted as a control for PatchMAP. We tiled ROls from Proof-of-principle 1 to construct 23 evaluation instances, and performed leave-one-out cross-validation using single-cell MSI profiles to predict IMC protein expression. We assessed accuracy using Spearman’s correlation between the predicted spatial autocorrelation (Moran’s I) and the true autocorrelation for each parameter to account for resolution differences between imaging modalities. i-PatchMAP outperformed tested methods on its ability to transfer IMC measures to query data based on MSI profiles (FIG. 27B) - though all methods performed consistently poor for parameters with no original spatial autocorrelation within tiles (TGF-β, FoxP3, CD163). For the CITE-seq data set, we created 15 evaluation instances and used single-cell RNA profiles to predict antibody derived tag (ADT) abundance. We quantified performance using Pearson’s correlation between true and predicted ADT values (FIG. 27C), finding that i-PatchMAP performed as good or slightly better than other tested methods for all parameters.

Proof-of-principle 3: i-PatchMAP transfers multiplexed protein distributions across tissues based on molecular microenvironmental profiles. To assess whether i-PatchMAP can be used to transfer molecular signature information across imaging modalities and further, across different tissue samples, we used single-cell IMC/MSI protein measures (see Proof-of-principle 1) to extrapolate IMC information to the full DFU sample, as well as to distinct prostate tumor and tonsil specimens, based on MSI profiles. A PatchMAP embedding of single cells in DFU ROls and individual pixels across tissues based on MSI parameters revealed that single-cell molecular microenvironments in the DFU ROls provided a good representation of the overall DFU molecular profile (FIG. 27F). Accordingly, we used i-PatchMAP to transfer DFU single-cell protein measures to the full DFU tissue based on molecular similarities. i-PatchMAP predicted that the wound area of the DFU tissue would show high expression levels for CD68, a marker of pro-inflammatory macrophages and activated Caspase-3, a marker of apoptotic cell death. By contrast, the healthy margin of the DFU biopsy was predicted to contain higher levels of CD4, indicating infiltrating T cells, and the cell proliferation marker Ki-67. Interestingly, the PatchMAP visualization revealed that molecular microenvironments corresponding to specific single-cell measures in the DFU (e.g., CD4) were strongly connected with MSI pixels in the tonsil tissue (FIG. 27F). In the tonsil tissue, which is a lymphocyte rich tissue, i-PatchMAP predictions for CD4 matched well with lymphocytic structure, and areas that lacked cell content were accurately predicted to not contain CD4. By contrast, there were no strong connections between the molecular profiles of the prostate cancer sample and the DFU biopsy. Thus, in the current datasets, strong inter-sample cellular and molecular connections appear supported by the common presence of specific immune cell populations. Indeed, IMC examination of the prostate biopsy used here indicated poor immune cell infiltration.

### Methods

MIAAIM implementation. MIAAIM workflows are implemented in Python and connected via the Nextflow pipeline language to enable automated results caching and dynamic processing restarts after alteration of workflow parameters, and to streamline parallelized processing of multiple images. MIAAIM is also available as a Python package. Each data integration workflow is containerized to enable reproducible environments and eliminate any language-specific dependencies. MIAAIM’s output interfaces with a number of existing image analysis software tools (see Supplementary Note 1, Combining MIAAIM with existing bioimaging software). MIAAIM therefore supplements existing tools rather than replaces them.

High-dimensional image compression and pre-processing (HDIprep). HDIprep is implemented by specifying sequential processing steps. Options include image compression for high-parameter data, and filtering and morphological operations for single-channel images. Processed images were exported as 32-bit NIfTI-1 images using the NiBabel library in Python. NIfTI-1 was chosen as the default file format for many of MIAAIM’s operations due to its compatibility with Elastix, ImageJ for visualization, and its memory mapping capability in Python.

To compress high-parameter images, HDIprep identifies a steady-state embedding dimensionality for pixel-level data. Compression is initialized with optional, spatially-guided subsampling to reduce data set size. We then implement UMAP to construct a graph representing the data manifold and its underlying topological structure (FuzzySimplicialSet, Algorithm 1). UMAP aims to optimize an embedding of a high-dimensional fuzzy simplicial set (i.e., a weighted, undirected graph) so that the fuzzy set cross-entropy between the embedded simplicial set and the high-dimensional counterpart is minimized, where the fuzzy set cross-entropy is defined as³⁵:

Definition 1. Given a reference set A and membership functions u: A → [0,1], v: A → [0,1], the fuzzy set cross-entropy C of (A, u) and (A, v) is defined as:

$$C \left(\left(A , u\right) , \left(A , v\right)\right) ≜ {\sum }_{a ∈ A} \left(u \left(a\right) log \left(\frac{u \left(a\right)}{v \left(a\right)}\right) + \left(1 - u \left(a\right)\right) log \left(\frac{1 - u \left(a\right)}{1 - v \left(a\right)}\right)\right)$$

The fuzzy set cross-entropy is a global measure of agreement between simplicial sets, aggregated across members of the reference set A (here, graph edges). Calculating its exact value scales quadratically with the number of data points, restricting its use for large data sets. UMAP’s current implementation does not, therefore. compute the exact cross entropy during its optimization of low-dimensional embeddings. Instead, it relies on probabilistic edge sampling and negative sampling to reduce runtimes for large data sets³⁵. Congruently, to identify steady-state embedding dimensionalities, we compute patches on the data manifold that are representative of its global structure, and we use these patches in the calculation of the exact cross-entropy after projecting them with UMAP over a range of dimensionalities. The result is a global estimate of the dimensionality required to accurately capture manifold complexity.

To identify globally representative patches on the data manifold, we subject the fuzzy simplicial set to a variant of spectral clustering. We iteratively project the spectral centroids into Euclidean spaces of increasing dimensionality using UMAP and calculate the fuzzy set cross-entropy in each case, then min-max normalize the obtained values. To identify the steady-state embedding dimensionality, we fit a least-squares exponential regression to normalized cross-entropy as a function of dimensionality, then simulate samples along the regression line to find the first dimensionality falling within the 95% confidence interval of the exponential asymptote. The subsampled data is embedded into the steady-state dimensionality, and out-of-sample pixels are projected into this embedding using the native nearest-neighbor based method in UMAP (transform () function). Finally, all pixels are mapped back to their original spatial coordinates to construct a compressed image with the number of channels equal to the steady-state embedding dimensionality. These steps are summarized in pseudo-code below:

Algorithm 1: Image Compression
Input: Multichannel image (X), SVD dimensionality (b), k-means clusters (k), embedding dimensions (n)
Output: Compressed image (I)
function Compress
{Spatially Subsample Pixels}
p ← ⊆ {a_{x,y} | α_{x,y} ∈ X}
{Compute Data Manifold}
g ← FuzzySimplicialSet (p) ⮞UMAP
{Compute Spectral Centroids}
s ← RandomizedSVD (g, b)
c ← MiniBatchKmeans (s,k)
{Compute Manifold Embedding Error}
g_{c} ← FuzzySimplicialSet (c)
for i = 1 ... n do
${e}_{c}^{i}$ ← EmbedSimplicialSet (g_{c},i)
{Compute Fuzzy Set Cross Entropy}
Eᵢ ← FuzzySetCrossEntropy $\left({g}_{c} , {e}_{c}^{i}\right)$
$E ← \frac{E - {E}_{m i n}}{{E}_{m a x} - {E}_{m i n}}$ ⮞Min-max Normalization
{Compute Steady-state Dimensionality}
ŷ ← (ŷ₀ - c)e^{-kE} + c ⮞Exponential Regression
for i = 1... n do
if ŷᵢ in c ± 1.96σ do ⮞Model Gaussian Residual Process
j ← i
break
{Compute Pixel Manifold Embedding}
for k_{x,y} in {a_{x,y} | α_{x,y} ∈ X Λ α_{x,y} ∉ p } do
M ← ProjectData
$\left({k}_{x , y} , {e}_{c}^{j}\right)$ ⮞Project data (UMAP transform())
{Reconstruct Image}
for k_{x,y} ∈ M do
I(x,y) ← k_{x,y}
return I

Image data subsampling. Subsampling is performed at pixel level and is optional for image compression. Implemented options include uniformly spaced grids within the (x, y) plane, random coordinate selection, and random selection initialized with uniformly spaced grids (“pseudo-random”). HDlprep also supports specification of masks for sampling regions, which may be useful for extremely large data sets.

By default, images with fewer than 50,000 pixels are not subsampled, images with 50,000-100,000 pixels are subsampled using 55% pseudo-random sampling initialized with 2×2 pixel uniformly spaced grids, images with 100,000-150,000 pixels are subsampled using 15% pseudo-random sampling initialized with 3×3 pixel grids, and images with more than 150,000 pixels are subsampled with 3×3 pixel grids. These default values are based on empirical studies (FIGS. 22A, 22B, 23A, 23B, 24A, and 24B).

No subsampling was used for presented MSI data. Subsampling rates used for presented IMC data were determined on a case-by-case basis from empirical studies and match those used in the spectral landmark sampling experiments. Subsampling with 10×10 pixel uniformly spaced grids was used for CyCIF data compression.

Fuzzy simplicial set generation. To construct a pixel-level data manifold, we represent each pixel as a d-dimensional vector, where d is the number of channels in the given high-parameter image (i.e., discarding spatial information). We then implement the UMAP algorithm and extract the resulting fuzzy simplicial set representing the manifold structure of these d-dimensional points. For all presented results, we used the default UMAP parameters to generate this manifold: 15 nearest neighbors and the Euclidean metric.

Manifold landmark selection with spectral clustering. Spectral landmarks are identified using a variant of spectral clustering. We use randomized singular value decomposition (SVD) followed by mini-batch k-means to scale spectral clustering to large data sets, following the procedure introduced in the potential of heat diffusion for affinity-based transition embedding (PHATE) algorithm. Given a symmetric adjacency matrix A representing pairwise similarities between nodes (here, pixels) originating from a d-dimensional space ℝ^{d}, we first compute the eigenvectors corresponding to the k largest eigenvalues of A. We then perform mini-batch k-means on the nodes of A using these k eigenvectors as features. Spectral landmarks are then defined as the d-dimensional centroids of the resulting clusters.

By default, the input data is reduced to 100 components using randomized SVD and then split into 3,000 clusters using mini-batch k-means. These default parameter values are based on empirical studies (FIGS. 21A and 21B). Due to steady-state embeddings of MSI and IMC data only being available after experimental tests, no landmark selection was used for processing or determining the optimal embedding dimensionality of these data sets. Instead, full or subsampled datasets were used. All other steady-state embeddings for image data was compressed using the above default parameters.

Steady-state UMAP embedding dimensionalities. By default, HDIprep embeds spectral landmarks into Euclidean spaces with 1-10 dimensions to identify steady-state embedding dimensionalities. Exponential regressions on the spectral landmark fuzzy set cross entropy are performed using built-in functions from the Scipy Python library. These default parameters were used for all presented data.

Histology image preprocessing. HDlprep processing options for hematoxylin and eosin (H&E) stained tissues and other low-channel histological stains include image filters (e.g., median), thresholding (e.g., manually set or automated), and successive morphological operations (e.g., thresholding, opening and closing). Presented H&E and toluidine-blue stained images were processed using median filters to remove salt-and-pepper noise, followed by Otsu thresholding to create a binary mask representing the foreground. Sequential morphological operations were then applied to the mask, including morphological opening to remove small connected foreground components, morphological closing to fill small holes in foreground, and filling to close large holes in foreground.

Image compression with UMAP parametrized by a neuronal network. We implemented parametric UMAP using the default parameters and neural architecture with a TensorFlow backend. The default architecture was comprised of a 3-layer 100-neuron fully connected neuronal network. Training was performed using gradient descent with a batch size of 1,000 edges and the Adam optimizer with a learning rate of 0.001.

High-dimensional image registration (HDIreg). HDIreg is a containerized workflow implementing the open-source Elastix software in conjunction with custom-written Python modules to automate the image resizing, padding, and trimming often applied before registration. HDIreg incorporates several different registration parameters, cost functions, and deformation models, and additionally allows manual definition of point correspondences for difficult problems, as well as composition of transformations for fine-tuning (see Supplemental Note 2, Notes on the HDlreg workflow’s expected performance).

High-parameter images are registered using a manifold alignment scheme parametrized by spatial transformations, which aims to maximize image similarity. Formally, we view registration as the following optimization problem⁴⁰:

Given a fixed d-dimensional image I_{F}: ℝ^{d} → ℝ² with domain Ω_{F} and a moving q-dimensional image I_{M:} ℝ^{q} → ℝ² with domain Ωₘ, we aim to optimize

$$\hat{μ} = {arg min}_{μ} S \left({T}_{μ} ; {I}_{F} , {I}_{M} , {Ω}_{F}\right) \qquad \text{(1)}$$

where Tᵤ: Ω_{F} → Ω_{M} is a smooth transformation defined by the vector of parameters µ ⊂ ℝ^{M}, and S is a similarity measure maximized when I_{M}◦T_{µ} and I_{F} are aligned.

Differential geometry and manifold learning: MIAAIM’s manifold alignment scheme uses the entropic graph-based Rényi α-mutual information (α-MI) as the similarity measure S in Equation 1, which extends to manifold representations of images (i.e., compressed images) embedded in Euclidean space with potentially differing dimensionalities. This measure is justified in the HDlreg manifold alignment scheme through the notion of intrinsic manifold information (i.e. entropy). In what follows, we introduce basic differential geometric concepts that enable us to expand existing foundations of intrinsic manifold entropy estimation to the UMAP algorithm.

Definition 2: Let X and Y be topological spaces. A function f: X → Y is continuous if for each point x ∈ X and each open neighborhood N of f(x) ⊆ Y the set f⁻¹(N) is an open neighborhood of x ε X. A function f: X → Y is a homeomorphism if it is one-to-one, onto, continuous, and has a continuous inverse. When a homeomorphism exists between spaces X and Y, they are called homeomorphic spaces.

Definition 3. A manifold

$$M$$

of dimension n (i.e., an n-manifold) is a second-countable Hausdorff space, each point of which has an open neighborhood homeomorphic to n-dimensional Euclidean space, ℝⁿ. For any open set

$$U ⊂ M$$

we can define a chart (φ, U) where φ: U → Ũ ⊂ ℝⁿ is a homeomorphism. We can say that (φ, U) acts as a local coordinate system for

$$M ,$$

and we can define a transition between two charts (φ, U) and (ω, V) as φ◦ω⁻¹: ω(U ∩ V) → φ(U ∩ V) when U ∩ V is non-empty.

Definition 4. A smooth manifold is a manifold where there exists a smooth transition map between each chart of

$$M .$$

A Riemannian metric g is a mapping that associates to each point

$$y ∈ M$$

an inner product g_{y}(·, ·) between vectors tangent to

$$M$$

at y. We denote tangent vectors of y as

$${T}_{y} M .$$

A Riemannian manifold, written

$$\left(M , g\right) ,$$

is a smooth manifold

$$M$$

together with a Riemannian metric g. Given a Riemannian manifold, the Riemannian volume element provides a means to integrate a function with respect to volume in local coordinates. Given

$$\left(M , g\right) ,$$

we can express the volume element ω in terms of the metric g and the local coordinates of a point x = x₁, ..., xₙ as ω = g(x)dx₁ Λ... Λ dxₙ where g(x) > 0 and Λ indicates the wedge product. The volume of

$$M$$

under this volume form is given by

$$V o l \left(M\right) = \int {}_{M} ω .$$

Definition 5. An immersion of a smooth n-manifold

$$M$$

into

$$N$$

is a differentiable mapping

$$ψ : M \to N$$

such that

$$d {ψ}_{p} : {T}_{p} M \to {T}_{ψ \left(p\right)} N$$

is injective for all points

$$p ∈ M .$$

ψ is therefore an immersion if its derivative is everywhere injective.

Definition 6. An embedding between smooth manifolds

$$M$$

and

$$N$$

is a smooth function

$$f : M \to N$$

such that f is an immersion and its continuous function is an embedding of topological spaces (i.e., is an injective homeomorphism). A closed embedding between

$$M$$

and

$$N$$

is an embedding where

$$f \left(M\right) ⊂ N$$

is closed.

Let

$$\left(M , g\right)$$

be a compact, n-dimensional Riemannian manifold immersed in an ambient ℝ^{d}, where n ≪ d, and let Xⱼ = {X₁,..., Xⱼ} be a set of independent and identically distributed random vectors with values drawn from a distribution supported by

$$M .$$

Define Uⱼ = {U₁, ..., Uⱼ} to be open neighborhoods of the elements of Xⱼ. An aim of manifold learning is to approximate an embedding f such that a measure of distortion D is minimized between Uⱼ and f (Uⱼ) = {f(U₁),..., f(Uⱼ)}. The manifold learning problem can therefore be written as

$$\hat{f} = {arg min}_{f ∈ F} D \left({U}_{j} , f \left({U}_{j}\right)\right) \qquad \text{(2)}$$

where

$$F$$

represents the family of possible measurable functions taking x↦ f(x). In machine learning settings, open neighborhoods Uᵢ ∈ Uⱼ about vectors Xᵢ ∈ Xⱼ are often defined to be geodesic distances (or probabilistic encodings thereof) approximated with a positive definite kernel, which allows the computation of inner products in a Riemannian framework (as compared with a pseudo-Riemannian framework which need not be positive definite). Measures of distortion vary by algorithm (see Supplementary Note 3, HDIprep dimension reduction validation for examples). Of interest in our exposition are the measures induced by the embedded geodesics via the volume elements of these coordinate patches. These provide the components needed to quantify the intrinsic Rényi α-entropy of embedded data manifolds.

Entropic graph estimators. Given Lebesgue density f and identically distributed random vectors X₁, ..., Xₙ with values in a compact subset of ℝ^{d}, the extrinsic Rényi α-entropy of f is given by:

$${H}_{α}^{{ℝ}^{d}} \left(f\right) = \frac{1}{1 - α} log {\int }_{{ℝ}^{d}} {f}^{α} \left(x\right) \text{d} x \qquad \text{(3)}$$

where α ∈ (0,1).

Definition 7 (adapted from Costa and Hero³⁸). Let Xₙ = {X₁,...,Xₙ} be identically distributed random vectors with values in a compact subset of ℝ^{d}, the nearest neighbor of Xᵢ ∈ Xₙ under the Euclidean metric is given by:

$${arg max}_{X ∈ {X}_{n} \backslash \left\{{X}_{i}\right\}} {\left‖X - {X}_{i}\right‖}_{2} \qquad \text{(4)}$$

A k-nearest neighbor (KNN) graph puts and edge between each Xᵢ ∈ Xₙ and its k-nearest neighbors. Let Γ_{k,i} = Γ_{k,i}(Xₙ) be the set of k-nearest neighbors of Xᵢ ∈ Xₙ. Then the total edge length of the KNN graph for Xₙ is given by:

$${L}_{γ , k} \left({X}_{n}\right) = {\sum }_{i = 1}^{n} {\sum }_{X ∈ {Γ}_{k , i}} {\left‖X - {X}_{i}\right‖}_{2}^{γ} \qquad \text{(5)}$$

where γ > 0 is a power-weighting constant.

In practice, the extrinsic Rényi α-entropy of f can be suitably approximated using a class of graphs known as continuous quasi-additive graphs, including k-nearest neighbor (KNN) Euclidean graphs⁵⁰, as their edge lengths asymptotically converge to the Rényi α-entropy of feature distributions as the number of feature vectors increases. This property leads to the convergence of KNN Euclidean edge lengths to the extrinsic Rényi α-entropy of a set of random vectors with values in a compact subset of ℝ^{d} with d ≥ 2. This is a direct corollary of the Beardwood-Halton-Hammersley Theorem outlined below.

Beardwood-Halton-Hammersley (BHH) Theorem. Let

$$\left(M , g\right)$$

be a compact Riemannian m-manifold immersed in an ambient ℝ^{d}. Suppose Xₙ = {X₁, ...Xₙ} are identically distributed random vectors with values in a compact subset of ℝ^{d} and Lebesgue density f. Assume d ≥ 2, 1 ≤ γ < d and define

$$α = \frac{\left(d - γ\right)}{d} .$$

Then with probability 1,

$${lim}_{n \to ∞} \frac{{L}_{γ , k} \left({X}_{n}\right)}{{n}^{\frac{{d}^{′} - γ}{{d}^{′}}}} = {β}_{d , γ , k} {\int }_{M} {f}^{α} \left(x\right) d x \qquad \text{(6)}$$

The value that determines the right side of the limit in Equation 6 is the extrinsic Rényi α-entropy given by Equation 4. When identically distributed random vectors are restricted to a compact smooth m-manifold,

$$M ,$$

in an ambient ℝ^{d}, the BHH Theorem generalizes to enable an estimation of intrinsic Rényi α-entropy

$${H}_{α}^{M} \left(f\right)$$

of the multivariate density f on

$$M$$

defined by

$${H}_{α}^{M} \left(f\right) = \frac{1}{1 - α} log {\int }_{M} {f}^{α} \left(y\right) {μ}_{g} \left(\text{d} y\right) \qquad \text{(7)}$$

by incorporating the measure µ_{g} naturally induced by the Riemannian metric via the Riemannian volume element. This is formalized by the following given by Costa and Hero:

Theorem 1 (Costa and Hero): Let

$$\left(M , g\right)$$

be a compact Riemannian m-manifold immersed in an ambient ℝ^{d}. Suppose Yₙ = {Y₁,... Yₙ} are identically distributed random vectors of

$$M$$

with bounded density f relative to the differential volume element µ_{g} induced by the metric g. Assume m ≥ 2, 1 ≤ γ < m and define

$$α = \frac{\left(m - y\right)}{m} .$$

Then with probability 1,

$${lim}_{n \to ∞} \frac{{L}_{γ , k} \left({Y}_{n}\right)}{{n}^{\frac{{d}^{′} - γ}{{d}^{′}}}} = \left\{\begin{matrix}∞ , & {d}^{′} < m \\ {β}_{m , γ , k} {\int }_{M} {f}^{α} \left(y\right) {μ}_{g} \left(d y\right) , & {d}^{′} = m \\ 0 , & {d}^{′} > m\end{matrix}\right) \qquad \text{(8)}$$

where β_{m,γ,k} is a constant that is independent of f and (M, g). Similarly, the expectation E[L_{γ,k} (Yₙ)]/n^{α} converges to the same limit.

The quantity that determines the limit when d′ = m is the intrinsic Renyi alpha entropy of f given by Equation 7. Theorem 1 has been used in conjunction with manifold learning algorithms Isomap and a variant C-lsomap to estimate the intrinsic dimensionality of embedded manifolds³⁹. In contrast to these results that use all pairwise geodesic approximations for each point in the data set to estimate the α-entropy, we aim to provide a similar formulation utilizing local information contained in data manifolds, following the results of our dimension reduction benchmark which shows that local information preserving algorithms are well-suited for the task of high-dimensional image data compression (FIGS. 18A-18I, 19A-19H, and 20A-20H). Indeed, the information density of volumes of continuous regions of model families (i.e., collections of output embedding spaces or input points) have been recognized in defining an information geometry of statistical manifold learning.

Entropic graph estimators on local information of embedded manifolds: In what follows, we utilize two concepts to show that the intrinsic information of multivariate probability distributions supported by embedded manifolds in Euclidean space with the UMAP algorithm can be approximated using the BHH Theorem: (i.) the compactness of constructed manifolds and (ii.) the conservation of Riemannian volume elements. We address (i.) with a simple proof, and we provide a motivational example of conservation of volume elements using UMAP to address (ii.).

Definition 8. A topological space X is compact if every open cover [symbol] of X contains a finite sub collection that also covers X. By open cover, we mean that the elements of [symbol] are open, and that the union of the elements of [symbol] equals

[image]

Proposition 1. Let n > d and suppose that

$$M$$

is a compact manifold of dimension r with r ≤ d that is immersed in ambient ℝⁿ. Then the image

$$f \left(M\right)$$

of

$$M$$

M under a projection

$$f : M \to {ℝ}^{d}$$

is compact. Proof. Let

$$\left(M , g\right)$$

be a compact Riemannian manifold (e.g., a manifold constructed with UMAP) with metric g in an ambient ℝⁿ and f a projection from

$$M$$

to ℝ^{d}. Since f is a projection, it is continuous, which takes compact sets to compact sets.

Proposition 1 shows that a d-dimensional Euclidean projection of a compact Riemannian manifold take values in a compact subset of ℝ^{d}, a sufficient condition in the BHH Theorem. The UMAP algorithm considers fuzzy simplicial sets, i.e., manifolds, constructed from finite extended pseudo-metric spaces (see finite fuzzy realization functor, Definition 7). By finite, we mean that these extended pseudo-metric spaces are constructed from a finite collection of points. If one considers this finiteness condition, then the compactness of UMAP manifolds follows naturally from Definition 8 – given an open cover on a manifold, one can find a finite subcover.

Thus, UMAP projections are compact, following Proposition 1. To extend the BHH Theorem to the calculation of intrinsic α-entropy of UMAP embeddings as in Equation 7, we must show that volume elements induced via embedding are well approximated. Note that these results apply to any dimension reduction algorithm that can provably preserve distances within open neighborhoods upon embedding a compact manifold in Euclidean space. In what follows, we do not provide a proof that UMAP preserves distances within open neighborhoods about points, although, this would be an ideal scenario. Rather, we assume that this ideal scenario exists, and we describe how to find the optimal dimensionality for projecting data to satisfy this assumption.

In contrast to global data preserving algorithms, such as Isomap that calculate all pairwise geodesic distances or approximations thereof with landmark based approaches, UMAP approximates geodesic distances in open neighborhoods local to each point (see Lemma 2 below). Given Lebesgue density µ and identically distributed random vectors Y₁, ...,Yₙ with values constrained to lie on a compact, uniformly distributed Riemannian manifold

$$M ,$$

geodesics between samples Yᵢ and Yⱼ drawn from µ are encoded probabilistically with UMAP and represent a scaled exponential distribution:

$${P}_{j \vert i} = exp \left(\frac{- \left‖{Y}_{i} - {Y}_{j}\right‖ - {ρ}_{i}}{{σ}_{i}}\right) \qquad \text{(9)}$$

$${P}_{i j} = {P}_{j \vert i} + {P}_{i \vert j} - {P}_{j \vert i} {P}_{i \vert j} \qquad \text{(10)}$$

where ρᵢ is the distance from vector Yᵢ to its nearest neighbor and σᵢ is an adaptively chosen normalization factor. Using the terminology in Equation 2, the objective of embedding in UMAP is given by minimizing the fuzzy simplicial set cross-entropy (Definition 1), which represents distortion D. Formally, given probability distribution Pᵢⱼ encoding geodesics between samples Yᵢ and Yⱼ and probability distribution Qᵢⱼ encoding distances between samples f(Yᵢ) and f(Yⱼ), we can represent the cross-entropy loss employed by UMAP as:

$$C E \left(P \vert \vert Q\right) = - {\sum }_{i j} {P}_{i j} log {Q}_{i j} + \left(1 - {P}_{i j}\right) log \left(1 - {Q}_{i j}\right) \qquad \text{(11)}$$

where Qᵢⱼ is the probability distribution formed from low dimensional positions of embedded vectors f(Yᵢ) and

$$f \left({Y}_{j}\right) \text{by} {Q}_{i j} \left(a , b\right) = \frac{1}{\left(1 + a {\left‖f \left({Y}_{i}\right) - f \left({Y}_{j}\right)\right‖}_{2}^{2 b}\right)}$$

with a,b user-defined parameters to control embedding spread.

Minimizing Equation 11 is not, in general, a convex optimization problem. Optimization over the family

$$F$$

F from Equation 2 is restricted to a subset rather than the full family and thus represents, in the best case, a local optimum. We include a larger family of measurable functions in order to more accurately approach optimal embedding of geodesic distances within open neighborhoods of vectors through the identification steady-state embedding dimensionalities, as outlined in the HDlprep workflow in a “pseudo-global” optimization procedure.

Using the notation in Equation 2, the volume elements induced by the embedding f̂ are similarly those that minimize distortion between the volume elements of

$$M$$

M given for local coordinates x₁,...,xₙ by σ = g(x)dx where dx = dx₁Λ ...Λ dxₙ and those of

$$\hat{f} \left(M\right)$$

given for local coordinates f̂x₁, ... f̂xₙ by τ = f̂g(x)d( f̂x), assuming that the dimensionality n of local coordinates is preserved. Under a globally optimal solution to Equation 7 (i.e., when Pᵢⱼ = Qᵢⱼ), volume elements are preserved:

$$\int {}_{M} σ = \int {}_{M} τ .$$

The existence of volume preserving diffeomorphisms for compact manifolds in consideration are proven by Moser^{53.}

In order to identify manifold embeddings that minimize distortion of volume elements, we viewed increases in the dimensionality of real-valued data in a natural way by modelling increases in dimensionality as exponential increases in potential positions of points (i.e., increasing copies of the real line, ℝⁿ). The relationship between radii of open neighborhoods, volume, and density of manifolds in a learning setting is formalized by Narayan et. al⁵² in an application where density is preserved with a given dimensionality for embeddings by altering open neighborhood radii; however, we can readily extend this in an adapted scenario of volume preservation under fixed radii to infer a dimensionality that satisfies the assumption of geodesic distance preservation. Consider the following example:

Let

$${Y}_{i} ∈ M$$

be a vector of manifold

$$M$$

M immersed in an ambient ℝ^{d}, and assume that the k-nearest neighbors of Yᵢ are uniformly distributed in a ball B_{r_{d}} of radius r_{d} with proportional volume

$${V}_{d} ∝ {r}_{d}^{d} .$$

Assume that a map f takes the open neighborhood B_{r_{d}} of Yᵢ to an m-dimensional ball

$${B}_{{r}_{m}} ⊆ N$$

of manifold

$$N$$

with radius rₘ while preserving its structure, including the uniform distribution and the induced Riemannian volume element Vₘ. Following Narayan et al.⁵², we can use the proportion

$${V}_{d} ∝ {r}_{m}^{m}$$

to infer a power law relationship

$${r}_{m} ∝ {r}_{d}^{d - m}$$

between the local radii rₘ in embedding spaces and the original radius of B_{r_{d}}.

To extend this example, suppose that rₘ and r_{d} are fixed (we can assume that radii are fixed in the original space, and that those in the embedding space are controlled by the a, b parameters influencing Qᵢⱼ in Equation 11). Assume that the ambient metrics of the embedding space and the original space are the same, and that they give rise to geodesic distances within B_{rₘ} and B_{r_{d}} using the native UMAP method (Lemma 2 below). Since ambient metrics and radii are preserved and that

$${r}_{m} ∝ {r}_{d}^{d - m} ,$$

this implies that the geodesic distances δₘ and δ_{d} between points in B_{rₘ} and B_{r_{d}} also exhibit a power law relationship,

$${δ}_{m} ∝ {δ}_{d}^{d - m} .$$

If we further assume that

$${δ}_{m} = {δ}_{d}^{d}$$

(i.e., that geodesic distances between points in open neighborhoods are preserved, the ideal scenario) we can solve for the relationship between geodesics and dimensionality m. Specifically, suppose that

$${δ}_{m} = {δ}_{d}^{d} .$$

Substituting

$${δ}_{d}^{d}$$

for δₘ, we can see that

$${δ}_{d}^{d} = {δ}_{d}^{d - m}$$

$$\to {δ}_{d}^{d} = \frac{{δ}_{d}^{d}}{{δ}_{d}^{m}}$$

$$\to {δ}_{d}^{m} = \frac{{δ}_{d}^{d}}{{δ}_{d}^{d}} = 1$$

which implies that the geodesics within open neighborhoods of points of the original space have an exponential relationship with dimensionality m.

Using the power-law relationship between volumes of open neighborhoods in UMAP manifolds and their embedded counterparts, we can attempt to identify the dimensionality m that such that geodesics within open neighborhoods is preserved with exponential regression. Note that geodesic distance preservation is stronger than volume preservation; however, volume preservation is implied. As a result, steady-state manifold embeddings provide a Euclidean dimensionality to approximate manifold geodesics of vectors sampled from

$$M ,$$

and thus the volume elements of

$$M .$$

KNN graph functionals calculated in the steady-state embedding space provide the necessary machinery to calculate the intrinsic α-entropy of embedded data manifolds in MIAAIM by applying the BHH Theorem using the induced measure across all coordinate patches as in Theorem 1.

Note, though, that the distances outside of open neighborhoods of points are not guaranteed to be accurately modelled in the embedding space with UMAP if one makes the assumptions introduced in our example. Therefore, applying Theorem 1 in conjunction with UMAP by replacing KNN graph lengths with those obtained with length functionals of geodesic minimal spanning trees (GMST), another type of entropic graph, should not be expected to reproduce the intrinsic entropy originally reported by Costa and Hero³⁹. Our primary contribution here is combining the KNN intrinsic entropy estimator with a local information preserving dimension reduction algorithm. We wish to extend these results to the setting where two such manifolds are compared, as this serves the basis for our image registration application. An entropic graph-based estimator of α-MI in an image registration setting is described by the following⁴⁰:

Let z(xᵢ) = [zᵢ(xᵢ), ..., z_{d}(xᵢ)] be a d-dimensional vector encoding the features of point xᵢ. Let Z_{f}(x) = {z^{f}(x₁), ...,z^{f} (x_{N})} be the feature set of a fixed image, Zₘ(T_{µ}(x)) = {z^{m}(T_{µ}(x₁)), ..., z^{m}(T_{µ}(x_{N}))} be the feature set of a transformed moving image at points in T_{µ}(x), and

$${z}_{i}^{f m} = \left[{z}^{f} \left({x}_{i}\right) , {z}^{m} \left({T}_{μ} \left({x}_{i}\right)\right)\right]$$

be the concatenation of the feature vectors of the fixed and transformed moving image at xᵢ. Then,

$$\hat{α - M I} \left(μ ; {Z}_{f} , {Z}_{m} , {Z}_{f m}\right) = \frac{1}{α - 1} log \frac{1}{{N}^{α}} {{\sum }_{i = 1}^{N} \left(\frac{{Γ}_{i}^{f m}}{\sqrt{{Γ}_{i}^{f} {Γ}_{i}^{m}} \left(μ\right)}\right)}^{2 γ} \qquad \text{(12)}$$

is a graph-based estimator for α-MI, where y = d(1 – α), 0 < α < 1, and three graphs

$${Γ}_{i}^{f} = {\sum }_{i = 1}^{k} \left‖{z}^{f} \left({x}_{i}\right) - {z}^{f} \left({x}_{i p}\right)\right‖ \qquad \text{(13)}$$

$${Γ}_{i}^{m} \left(μ\right) = {\sum }_{i = 1}^{k} \left‖{z}^{m} \left({T}_{μ} \left({x}_{i}\right)\right) - {z}^{m} \left({T}_{μ} \left({x}_{i p}\right)\right)\right‖ \qquad \text{(14)}$$

$${Γ}_{i}^{f m} \left(μ\right) = {\sum }_{i = 1}^{k} \left‖{z}^{f m} \left({x}_{i} , {T}_{μ} \left({x}_{i}\right)\right) - {z}^{f m} \left({x}_{i p} , {T}_{μ} \left({x}_{i p}\right)\right)\right‖ \qquad \text{(15)}$$

represent the Euclidean graph functionals (lengths) of a feature vector z to its p^{th} nearest neighbor over k considered nearest neighbors.

The Rényi α-MI provides a quantitative measure of association between the intrinsic structure of multiple manifold embeddings constructed with the UMAP algorithm. The Rényi α-MI measure extends to feature spaces of arbitrary dimensionality, which MIAAIM utilizes in combination with its image compression method to quantify similarity between steady-state embeddings of image pixels in potentially differing dimensionalities.

Proof-of-concept studies. Since data acquisition removed tissue context at regions of interest on the IMC full-tissue reference image, we first aligned full tissue sections then used the coordinates of IMC regions to extract data from all modalities for fine-tuning. Custom Python scripts were used to propagate alignment across imaging modalities. Manual landmark correspondences were used where unsupervised alignment proved suboptimal. We accounted for alignment errors around IMC regions following full-tissue registration by padding regions with extra pixels prior to cropping. All registrations involving MSI or IMC data were conducted using KNN α-MI, as in Equation 12, with α = 0.99 and 15 nearest neighbors. All registrations aligning low-channel slides (IMC reference toluidine blue image and H&E) were conducted using histogram-based MI after grayscale conversion for rapid processing.

For full-tissue images, a two-step registration process was implemented by first aligning images using an affine model for the vector of parameters µ (Equation 1) and subsequently aligning images with a nonlinear model parametrized by B-splines. Hierarchical Gaussian smoothing pyramids were used to account for resolution differences between image modalities, and stochastic gradient descent with random coordinate sampling was used for optimization. We additionally optimized final control point grid spacings for B-spline models and the number of hierarchical levels to include in pyramidal smoothing for each MSI data set to H&E alignment individually (FIGS. 18A-18I, 19A-19H, and 20A-20H). A final control point spacing of 300 pixels for nonlinear B-spline registrations of MSI data to corresponding H&E data balanced correct alignment with unrealistic warping, which we identified visually and by inspecting the spatial Jacobian matrices for values that deviated substantially from 1. H&E and IMC reference tissue registrations utilized a final grid spacing of 5 pixels. Similar optimizations for numbers of pyramidal levels were carried out for these data. All data that underwent image registration were exported and stored as 32-bit NlfTl-1 images. IMC data was not transformed and was kept in 16-bit OME-TIF(F) format.

Cobordism Approximation and Projection (PatchMAP). PatchMAP is an algorithm that constructs a smooth manifold by gluing Riemannian manifolds to its boundary, and it projects the higher-order manifold in a lower dimensional space for visualization. Higher-order manifolds produced by PatchMAP can be understood as cobordisms, which are described by the following set of definitions:

Definition 9. Given a family of sets {Sᵢ: i ∈ I} and an index set I, their disjoint union, denoted

$$S = ∐ {}_{i ε I} {S}_{i}$$

is a set together with injective functions ϕᵢ: Sᵢ → S for each Sᵢ. The disjoint union corresponds to the coproduct of sets.

Definition 10. Two closed n-manifolds

$$M$$

and

$$N$$

N are cobordant if their disjoint union, denoted

$$M ∐ N ,$$

is the boundary of some manifold

$$W$$

We call the manifold

$$W$$

a cobordism. By boundary of a n-manifold, we mean the set of points on

$$M$$

which are homeomorphic to the upper half plane,

$${ℝ}_{+}^{n} .$$

We denote the boundary of

$$W$$

as

$$\partial W .$$

PatchMAP addresses cobordism learning in a semi-supervised manner, where data is assumed to follow the structure of a nonlinear cobordism, and our task is to glue lower dimensional manifolds to the boundary of a higher dimensional manifold to produce a cobordism. Here, we would like for coordinate transformations across the cobordism to have their own geometries independent of the metrics of boundary manifolds. In practice, this property allows us to explore data within boundary manifolds without being reliant on the specific geometry of the cobordism. Ultimately, cobordism geodesics are the base component of downstream applications such as the i-PatchMAP workflow. Furthermore, we would like for the cobordism to highlight boundary manifolds whose points overlap with high confidence - such overlaps may give rise to interesting nonlinearities in higher-order spaces. A natural way to satisfy both of these conditions is to use the fuzzy set-theoretic foundation of the UMAP algorithm.

The primary goal of PatchMAP then is to identify a smooth manifold whose boundary is the disjoint union of smooth manifolds of lower dimensionality, and which has a metric independent of each boundary manifolds’ metric that we choose to represent. We address this with a two-step algorithm that uncouples the computation of boundary manifolds from the cobordism. First, boundary manifolds are computed by applying the UMAP algorithm to each set of data with a user-provided metric. Practically, the result of this step are symmetric, weighted graphs that represent geodesics within each boundary manifold. Our task is to construct from a finite set of n boundary manifolds

$$F = \left\{\left({M}_{1} , {g}_{1}\right) ... \left({M}_{n} , {g}_{n}\right)\right\}$$

a manifold

$$\left({M}_{F} , g\right) ,$$

with metric g such that the disjoint union

$$∐ {}_{i ε I} {S}_{i} = \partial {M}_{F} .$$

We wish to approximate the geodesics of

$${M}_{F} ,$$

and for each element of

$$p ∈ {M}_{F} ,$$

the tangent space

$${T}_{p} {M}_{F}$$

with inner product gₚ.

Lemma 2 (McInnes and Healy³⁵). Let

$$\left(M , g\right)$$

be a Riemannian manifold in an ambient ℝⁿ, and let

$$p ∈ M$$

be a point. If g is locally constant about p in an open neighborhood

$$U ⊂ M$$

such that g is a constant n diagonal matrix in ambient coordinates, then in a ball B ⊆ U centered at p with volume

$$\frac{{π}^{\frac{n}{2}}}{Γ \left(\frac{n}{2} + 1\right)}$$

with respect to g, the geodesic distance from p to any point in q ∈ B is

$$\frac{1}{r} {d}_{{ℝ}^{n}} \left(p , q\right) ,$$

(p, q), where r is the radius of the ball in the ambient space ℝⁿ and

$${d}_{{ℝ}^{n}}$$

is the metric on the ambient space.

If we assume that data points across boundary manifolds can be compared with a suitable metric, we can compute the geodesics between points on the projections of each boundary manifold under a user-provided ambient metric using Lemma 2 to their disjoint union. Given two boundary manifolds

$${M}_{i}$$

and,

$${M}_{j} ,$$

we compute the pairwise geodesic distances between points

$${p}_{i} , {p}_{j} ∈ {M}_{i} ∐ {M}_{j}$$

where

$${p}_{i} ∈ M {i}_{} \to {M}_{i} ∐ {M}_{j}$$

and

$${p}_{j} ∈ {p}_{i} ∈ {M}_{i} \to {M}_{i} ∐ {M}_{j}$$

to obtain the components needed to construct the metric on

$${M}_{i} ∐ {M}_{j}$$

By extension, concatenation of all pairwise distance calculations between boundary manifolds

$${M}_{i}$$

and

$${M}_{j}$$

where i,j ∈ {1,2,...,n}; i ≠ j to the disjoint union

$$∐ {}_{i ∈ l} {M}_{i}$$

provides the components to construct the geodesics on the full cobordism across all pairwise combinations of boundary manifolds.The result of using Lemma 2 to approximate the projections of manifold geodesics, however, is that we have directed, incompatible views of the geodesics across the cobordism, to and from, boundary manifolds. We can interpret these directed geodesics as being defined on oriented cobordisms. We aim to encode the directed geodesics in the oriented cobordisms and the boundary manifold geodesics with a single data representation.

Our goal then is to construct an unoriented cobordism, where the directed geodesics of oriented cobordisms are resolved into a single, symmetric matrix representation. To do this, we can translate each of the extended pseudo-metric spaces described above into a fuzzy simplicial set using the fuzzy singular set functor (see Definition 9), which captures both a topological representation of the oriented cobordisms and the underlying metric information. The incompatibilities in oriented cobordism geodesics can be resolved with a norm of our choosing. A natural choice for the fuzzy set representation that we have chosen is the t-norm (also known as a fuzzy intersection). If we interpret the fuzzy simplicial set representations of oriented cobordisms in a probabilistic manner, then their intersection corresponds to the joint distribution of the oriented cobordism metric spaces, which highlights the directed cobordism geodesics that occur in both directions, to and from, with a high probability.

The final step is to integrate the boundary manifold geodesics with the symmetric cobordism geodesics obtained with the fuzzy set intersection. We can do this by taking a fuzzy set union (probabilistic t-conorm) over the family of extended pseudo-metric spaces, as in the original UMAP implementation. The result is a cobordism that contains its own geometric structure that is captured in cobordism geodesics, in addition to individual boundary manifolds that contain their own geometries.

Optimizing a low dimensional representation of the cobordism can be achieved with a number of methods - we choose to optimize the embedding using the fuzzy set cross entropy (Definition 1), as in the original UMAP implementation for consistency. Note that since our algorithm produces a symmetric matrix, PatchMAP could be repeatedly applied to construct “nested” cobordisms of hierarchical dimensionality.

PatchMAP implementation. To construct cobordisms, PatchMAP first computes boundary manifolds by constructing fuzzy simplicial sets from each provided set of data, i.e., system state, by applying the UMAP algorithm (FuzzySimplicialSet, Algorithm 2). Then, pairwise, directed nearest neighbor (NN) queries between boundary manifolds are computed in the ambient space of the cobordism (DirectedGeodesics, Algorithm 2). Directed NN queries between boundary manifolds are weighted according to the native implementation in UMAP, the method of which we refer the reader to Equations 5 and 6. Resulting directed NN graphs between UMAP submanifolds are weighted, and they reflect Riemannian metrics that are not compatible. That is, they cannot be simply added or multiplied to integrate their weights. We therefore stitch the cobordism metric and make directed NN queries compatible by applying a fuzzy simplicial intersection, which results in a weighted, symmetric graph (FuzzyIntersection, Algorithm 2). The final cobordism produced by PatchMAP is obtained by taking a fuzzy union over the family of all fuzzy simplicial sets (FuzzyUnion, Algorithm 2). To represent connections between boundary manifolds in PatchMAP cobordism projections, we implemented the hammer edge bundling algorithm in the Datashader Python library. Pseudo-code outlining the PatchMAP algorithm is shown in the following:

Algorithm 2: PatchMAP
Input: Data sets (D₁,D₂ ...Dₙ), boundary manifold ambient metric (g_{f}), cobordism ambient metric(g)
Output: Cobordism $\left(W\right)$
function Stitch
{Compute boundary manifolds}
for i ... n do
${M}_{i}$ ← FuzzySimplicialSet (Dᵢ, g_{f} = ⮞UMAP
{Compute geodesic projections in cobordism}
for i ... n do
${M}_{i \to j}$ ← DirectedGeodesics (Dⱼ,g) : i ≠ j ⮞Project data (UMAP transform ())
${M}_{j \to i}$ ← DirectedGeodesics (Dᵢ, g) : i ≠ j
${M}_{i j}$ ← Fuzzylntersection $\left({M}_{i \to j} , {M}_{j \to i}\right)$ ⮞t-norm
{Integrate Cobordism}
$W$ ← FuzzyUnion $\left\{{M}_{i} , {M}_{i j}\right\}$ ⮞t-conorm
return $W$

Domain/Information Transfer (i-PatchMAP). Let

$${M}_{r q}$$

be the geodesics in a cobordism between points in boundary manifolds

$${M}_{r}$$

and

$${M}_{q}$$

obtained with PatchMAP that come a reference and query data set, respectively. Specifically,

$${M}_{r q}$$

is a matrix where rows represent points in the reference boundary manifold, columns represent the nearest neighbors of reference manifold points in the query factor manifold under a user defined metric, and the i,j^{th} entry represents the geodesics between points

$${p}_{i} , {p}_{j} ∈ {M}_{r} ∐ {M}_{q}$$

such that

$${p}_{i} ∈ {M}_{r} \to {M}_{r} ∐ {M}_{q}$$

and

$${p}_{j} ∈ {M}_{q} \to {M}_{r} ∐ {M}_{q} .$$

We compute a new feature matrix of predictions P_{q} for the query data set by multiplying the feature matrix to be transferred, F, with the transpose of the weight matrix W_{rq} obtained through ℓ₁ normalization of

$${M}_{r q} :$$

$${P}_{q} = F {W}_{r g} {}^{T} \qquad \text{(16)}$$

In this context, the matrix W_{rq} can be interpreted as a single-step transition matrix of a Markov chain between states pᵢ and pⱼ derived from geodesic distances on the cobordism.

Biological Methods. All patient tissue samples were obtained with approval from the Institutional Review Boards (IRB) of Massachusetts General Hospital (protocol #2005P000774) and Beth Israel Deaconess Medical Center (protocol #2018P000581).

Generation of imaging mass cytometry data. Frozen tissues were sectioned serially at a thickness of 10 µm using a Microm HM550 cryostat (Thermo Scientific) and thaw-mounted onto SuperFrost™ Plus Gold charged microscopy slides (Fisher Scientific). After temperature equilibration to room temperature, tissue sections were fixed in 4% paraformaldehyde (Ted Pella) for 10 min, then rinsed 3 times with cytometry-grade phosphate-buffered saline (PBS) (Fluidigm). Unspecific binding sites were blocked using 5% bovine serum albumin (BSA) (Sigma Aldrich) in PBS including 0.3% Triton X-100 (Thermo Scientific) for 1 hour at room temperature. Metal conjugated primary antibodies (Fluidigm) at appropriately titrated concentrations were mixed in 0.5% BSA in DPBS and applied overnight at 4° C. in a humid chamber. Sections were then washed twice with PBS containing 0.1 % Triton X-100 and counterstained with iridium (Ir) intercalator (Fluidigm) at 1:400 in PBS for 30 min at room temperature. Slides were rinsed in cytometry-grade water (Fluidigm) for 5 min and allowed to air dry. Data acquisition was performed using a Hyperion Imaging System (Fluidigm) and CyTOF Software (Fluidigm), in 33 channels, at a frequency of 200 pixels/second and with a spatial resolution of 1 µm. Images were visualized with MCD Viewer software (Fluidigm) before exporting the data as text files for further analysis. After imaging, slides were rapidly stained with 0.1% toluidine blue solution (Electron Microscopy Sciences) to reveal gross morphology. Slides were digitized at a resolution of approximately 2.75 µm/pixel using a digital camera.

Generation of mass spectrometry imaging data. Paired 10 µm thick sections from the same tissue blocks as used for imaging mass cytometry were thaw mounted onto Indium-Tin-Oxide (ITO) coated glass slides (Bruker Daltonics). Tissue sections were coated with 2.5-dihydroxybenzoic acid (40 mg/mL in 50:50 acetonitrile:water including 0.1% TFA) with an automated matrix applicator (TM-sprayer, HTX imaging). Mass spectrometry imaging of sections was performed using a rapifleX MALDI Tissuetyper (Bruker Daltonics, Billerica, MA). Data acquisition was performed using FlexControl software (Bruker Daltonics, Version 4.0) with the following parameters: positive ion polarity, mass scan range (m/z) of 300-1000, 1.25 GHz digitizer, 50 µm spatial resolution, 100 shots per pixel, and 10 kHz laser frequency. Regions of interest for data acquisition were defined using Flexlmaging software (Bruker Daltonics, version 5.0), and individual images were visualized using both Flexlmaging and SCiLS Lab (Bruker Daltonics). After data acquisition, sections were washed with PBS and subjected to standard hematoxylin and eosin histological staining followed by dehydration in graded alcohols and xylene. The stained tissue was digitized at a resolution of 0.5 µm/pixel using an Aperio ScanScope XT brightfield scanner (Leica Biosystems).

Mass spectrometry imaging data preprocessing. Data were processed in SCiLS LAB 2018 using total ion count normalization on the mean spectra and peak centroiding with an interval width of ±25 mDa. For all analyses, a peak range of m/z 400-1,000 was used after peak centroiding, which resulted in 9,753 m/z peaks. No peak-picking was performed for presented data unless explicitly stated. Data were exported from SCiLS Lab as imzML files for further analysis and processing.

Single-cell segmentation. To quantify parameters of single-cells in IMC and registered MSI data within the DFU dataset, we performed cell segmentation on IMC ROls using the pixel classification module in Ilastik (version 1.3.2) [38], which utilizes a random forest classifier for semantic segmentation. For each ROI, two 250 µm by 250 µm areas were cropped from IMC data and exported in the HDF5 format to use for supervised training. To ensure each cropped area was a representative training sample, a global threshold for each was created using Otsu thresholding on the Iridium (nuclear) stain with Scikit-image Python library. Cropped regions were required to contain greater than 30% of pixels over their respective threshold.

Training regions were annotated for “background”, “membrane”, “nuclei”, and “noise”. Random forest classification incorporated Gaussian smoothing features, edges features, including Laplacian of Gaussian features, Gaussian gradient magnitude features, and difference of Gaussian features, and texture features, including structure tensor eigenvalues and Hessian of Gaussian eigenvalues. The trained classifier was used to predict each pixels’ probability of assignment to the four classes in the full images, and predictions were exported as 16-bit TIFF stacks. To remove artifacts in cell staining, noise prediction channels were Gaussian blurred with a sigma of 2 and Otsu thresholding with a correction factor of 1.3 was applied, which created a binary mask separating foreground (high pixel probability to be noise) from background (low pixel probability to be noise). The noise mask was used to assign zero values in the other three probability channels from Ilastik (nuclei, membrane, background) to all pixels that were considered foreground in the noise channel. Noise-removed, three-channel probability images of nuclei, membrane, and background were used for single-cell segmentation in CellProfiler (version 3.1.8) [59].

Single-cell parameter quantification. Single-cell parameter quantification for IMC and MSI data were performed using an in-house modification of the quantification (MCQuant) module in the multiple-choice microscopy software (MCMICRO)[60] to accept NIfFTI-1 files after cell segmentation. IMC single-cell measures were transformed using 99^{th} percentile quantile normalization prior to downstream analysis.

Imaging mass cytometry cluster analysis. Cluster analysis was performed in Python using the Leiden community detection algorithm with the leidenalg Python package. UMAP’s simplicial set (weighted, undirected graph) created with 15 nearest neighbors and Euclidean metric was used as input to community detection.

Microenvironmental correlation network analysis. To calculate associations across MSI and IMC modalities, we used Spearman’s correlation coefficient in the Python Scipy library. M/z peaks from MSI data with no correlations to IMC data with Bonferroni corrected P-values above 0.001 were removed from the analysis. Correlation modules were formed with hierarchical Louvain community detection using the Scikit-network package. The resolution parameter used for community detection was chosen based on the elbow point of a graph plotting resolution vs. modularity of community detection results. UMAP’s simplicial set, created with 5 nearest neighbors and the Euclidean metric, was used as input for community detection after inverse cosine transformation of Spearman’s correlation coefficients to form metric distances. Visualization of MSI correlation module trends to IMC parameters were computed using exponential-weighted moving averages in the Pandas library in Python after standard scaling IMC and MSI single-cell data. MSI moving averages were additionally min-max scaled to a range of 0-1 for plotting purposes. Differential correlations of variables u from MSI data and v from IMC data between conditions α and b were quantified and ranked using the formula:

$${D}_{a \to b}^{u , v} = \left({ρ}_{b}^{u , v} - {ρ}_{a}^{u , v}\right) \times max \left(\left|{ρ}_{a}^{u , v}\right| , \left|{ρ}_{b}^{u , v}\right|\right) \qquad \text{(17)}$$

where change in correlation coefficients for each pair u, v between conditions are weighted according to the maximal absolute correlation coefficient among both conditions. Significance of differential correlations

$${ρ}_{b}^{u , v} - {ρ}_{a}^{u , v}$$

were calculated using one-sided, Bonferroni corrected z-statistics after Fisher transformation.

Dimensionality reduction algorithm benchmarking. Methods used for benchmarking dimensionality reduction algorithms are outlined in Supplementary Note 3, HDIprep dimension reduction validation.

Spatial subsampling benchmarking. Default subsampling parameters in MIAAIM are based on experiments across IMC data from DFU, tonsil, and prostate cancer tissues recording Procrustes transformation sum of squares errors between subsampled UMAP embeddings with subsequent projection of out-of-sample pixels and full UMAP embeddings using all pixels. Spatial subsampling benchmarking was performed across a range of subsampling percentages.

Spectral landmark benchmarking. Subsampling percentages and dimensionalities to validate landmark-based steady-state UMAP dimensionalities were determined on a case-by-case basis from empirical studies and match those used for presented, registered data. Parameters were chosen due to the computational burden of computing values for cross-entropy on large data. To compare landmark steady-state dimensionality selections to subsampled data, we compared the shape of exponential regression fits from both sets of data using sum of squared errors. Sum of squared errors were calculated across a range of resulting landmarks.

Submanifold stitching simulation. Simulations were performed using the MNIST digits dataset in the Python Scikit-learn library using the default parameters for BKNN, Seurat v3, Scanorama, and PatchMAP across a range of nearest neighbor values. Data points were split into according to their digit label and stitched together using each method. Integrated data from each tested method excluding PatchMAP was then visualized with UMAP. Quality of submanifold stitching for each algorithm was quantified using the silhouette coefficient in the UMAP embedding space, implemented in Python with the Scikit-learn library. The silhouette coefficient is a measure of dispersion for a partition of a dataset. A high value indicates that data from the same label/type are tightly grouped together, whereas a lower value indicates that data from different types are grouped together. The silhouette coefficient (SC) is the average silhouette score s computed across each data point in the dataset, given by the following:

$$s \left(i\right) = \left\{\begin{matrix}1 - \frac{a \left(i\right)}{b \left(i\right)} , & i f \text{(18)} a \left(i\right) < b \left(i\right) \\ 0 , & i f a \left(i\right) = b \left(i\right) \\ \frac{b \left(i\right)}{a \left(i\right)} - 1 , & i f a \left(i\right) > b \left(i\right)\end{matrix}\right)$$

where a(i) is the average distance of data point i to all points with its label and b(i) is the average distance of point i to all other data that do not have the same label.

CBMC CITE-seq data transfer. CBMC CITE-seq data were preprocessed according to the vignette provided by the Satija lab at https://satijalab.org/seurat/articles/multimodal_vignette.html. RNA profiles were log transformed and ADT abundances were normalized using centered log ratio transformation. RNA variable features were then identified, and the dimensionality of the RNA profiles of cells were reduced using principal components analysis. The first 30 principal components of single-cell RNA profiles were used to predict single-cell ADT abundances. The CBMC dataset was split randomly into 15 evaluation instances with 75% training and 25% testing data. Training data was used to predict test data measures. Prediction quality was quantified using Pearson’s correlation coefficient between true and predicted ADT abundances. Correlations were calculated using the Python library, Scipy. Seurat was implemented using the TransferData function after finding transfer anchors (FindTransferAnchors function) using the default parameters. PatchMAP and UMAP+ were applied with 80 nearest neighbors and the Euclidean metric in the PCA space.

Spatially resolved image data transfer. To benchmark MSI to IMC information transfer, we performed leave-one-out cross validation with segmented single-cells from 23 image tiles (number of cells ranging from ~100 to ~500 each) from the DFU dataset. IMC ROls were split into four evenly sized quadrants to create 24 tiles. One tile was removed due to lack of cell content. Data was transformed prior to information transfer using principal components analysis with 15 components using the Scikit-learn library. Seurat was implemented using the TransferData function after finding transfer anchors (FindTransferAnchors function) using the default parameters and 15 principal components. PatchMAP and UMAP+ were implemented using 80 nearest neighbors and the Euclidean metric in the PCA space. Information transfer quality was computed for each predicted IMC parameter by calculating Pearson’s correlation in Python with the Scipy library between the Moran’s autocorrelation index of ground truth data and predicted data. Moran’s autocorrelation index (I) is given by the following¹³:

$$I = \frac{N}{W} \frac{{\sum }_{i} {\sum }_{j} {w}_{i j} \left({x}_{i} - \overline{x}\right) \left({x}_{j} - \overline{x}\right)}{{\sum }_{i} {\left({x}_{i} - \overline{x}\right)}^{2}} \qquad \text{(19)}$$

where N is the number of spatial dimensions in the data (2 for our purposes), x is the abundance of a protein of interest, x̅ is the mean abundance of protein x, wᵢⱼ is a spatial weight matrix, and W is the sum of all wᵢⱼ.

### Supplementary Notes

### Supplementary Note 1. Combining MIAAIM With Existing Bioimaging Analysis Software

MIAAIM’s core functionality enables cross-technology and cross-tissue comparisons. As shown in our Proof-of-principle examples, it has broad applications that may be configured and executed using other software applications. We anticipate that a challenge for many users will be the execution of sequential registration and analysis across varied software. MIAAIM’s multiple output data formats directly interface with a number of tools for visualization, cell segmentation, and single-cell analysis (Table 2), creating an avenue for continued investigation of multimodal tissue portraits in various settings.

TABLE 2

| | | | | | | | |
|---|---|---|---|---|---|---|---|
| Software | Input File Formats | Multi-modal Alignment | Modular | Multi-modal Analysis | Scalable | Segmentation | GUI |
| MCMICRO | BioFormats | × | ✔ | × | ✔ | ✔ | ✔ |
| histoCAT | TIFF | × | ✔ | × | × | × | ✔ |
| Ilastik | HDF5 | × | ✔ | × | ✔ | ✔ | ✔ |
| Image J/FIJI | BioFormats NlfTl | × | ✔ | × | × | ✔ | ✔ |
| Qupath | BioFormats | × | × | × | × | ✔ | ✔ |
| napari | Image Visualization Software | | | | | | |

### Supplementary Note 2. Notes on the HDIreg Workflow’s Expected Performance

A fundamental assumption in intensity-based image registration is that quantifiable relationships exist between modalities - this is often met in practice, as shown in our Proof-of-principle applications. However, this assumption can be compromised by artefacts, such as folds, tears, and, in the case of serial sectioning, nonlinear deformations. In our experience, glandular tissues, such as those derived from prostate, likely show high structural variability over short distances, making the alignment of images from distinct sections challenging. Manual landmark guidance can be used in difficult use-cases such as those posed by serial tissue sectioning. By using the Elastix library, HDlreg also offers a multitude of similarity measures for single-channel registration, in addition to the manifold alignment scheme used for multichannel registration. We note that histogram-based mutual information has outperformed KNN α-MI in these single-channel registration settings¹⁶, which we used in our benchmark studies.

### Supplementary Note 3. HDIprep Dimension Reduction Validation Dimensionality Reduction Algorithm Benchmarking (FIGS. 18A-18I, 19A-19H, and 20A-20H).

Our investigation involved a range of dimension reduction methods, spanning from local nonlinear methods, to global, linear methods. Considered methods included t-distributed stochastic neighbor embedding (t-SNE), uniform manifold approximation and projection (UMAP), potential of heat diffusion for affinity-based transition embedding (PHATE), isometric mapping (Isomap), non-negative matrix factorization (NMF), and principle components analysis (PCA).

To assess each methods’ ability to provide an appropriate data representation while enabling multi-modal correspondences, we measured their ability to (i.) generalize to arbitrary numbers of features or necessary degrees of freedom to accurately represent data modalities (ii.) succinctly capture data complexity (iii.) maximize the information content shared between imaging modalities (iv.) be robust to noise and (iv.) be computationally efficient.

(i.-ii.) Estimating intrinsic data dimensionality. To identify an appropriate method for reducing the complexity of the mass-spectrometry based image data sets, we hypothesized that introducing more degrees of freedom in the coordinates of embedded data (i.e., increases in the dimension of embeddings) would result in increases of the similarity between each methods’ embedding and its high-dimensional counterpart with respect to the objective function of each algorithm. Therefore, we viewed each algorithm separately with a distinct objective function, and identified the appropriate target dimensionality for the data to be embedded in for each method by analyzing the objective function errors produced by each method after embedding the data in increasing dimensions. To do this, we created a suitable score for estimating the error associated with embedding the MSI data in Euclidean n-space, ℝⁿ, for each dimension reduction method across tissue types and ascending embedding dimensions. For this analysis, we focused on the MSI data rather than the IMC data, which we found was not feasible to apply most dimension reduction methods to because of data size (number of pixels/high resolution).

To determine each method’s estimated intrinsic dimensionality of the data set, we identified the point in each methods’ error graph where increases in dimensionality no longer reduced embedding error. To do this, we viewed increases in the dimensionality of real-valued data in a natural way by modelling increases in dimensionality as exponential increases in potential positions of points (i.e., increasing copies of the real line, ℝⁿ). We therefore fit a least-squares exponential regression to the error curves of data embedding, and 95% confidence intervals (CI) were constructed by modelling gaussian residual processes. The optimal embedding dimensions for each method were selected by simulating samples along the expected value of the fit curve and identifying the first integer-valued instance that fell within the 95% CI for the exponential asymptote. In this way, the minimum degrees of freedom necessary to capture data complexity was identified. The average error curves for each method across 5 random initializations of each algorithm across each MSI data set are shown in FIGS. 18A-18I, 19A-19H, and 20A-20H. The methods and rationale used for calculating each method’s embedding error are outlined below:

UMAP. The UMAP algorithm falls in the category of manifold learning techniques, and it aims to optimize the embedding of a fuzzy simplicial set representation of high-dimensional data into lower dimensional Euclidean spaces. Practically, a low dimensional fuzzy simplicial set is optimized so that the fuzzy set cross-entropy between its high-dimensional counterpart is minimized. The fuzzy-set cross entropy is defined explicitly in Definition 1, Methods, given by Mclnnes and Healy [15].

While the theoretical underpinnings of UMAP are grounded in category theory, the practical implementation of UMAP boils down to weighted graphs. To provide an estimate of the intrinsic dimensionality of the data determined by UMAP, we used the open-source implementation in Python with 15 nearest neighbors, a value of 0.1 for minimum distance in the resulting embedding, and we allow the algorithm to optimize the embedding for the default value of 200 iterations for each dimension. The cross-entropy for each dimension between the high dimensional fuzzy simplicial set and the low dimensional counterpart was computed using a Python-converted module of the MATLAB UMAP implementation.

T-SNE. T-SNE is a manifold-based dimension reduction method that aims to preserve local structure in data sets for visualization purposes. To achieve this, t-SNE minimizes the difference between distributions representing the local similarity between points in the original, high-dimensional ambient space and the respective low dimensional embedding. The difference between these two distributions is determined by the Kullback-Leibler (KL) divergence between them. As a result, we report the final value of the KL-divergence upon embedding as a means of estimating the error associated with t-SNE embeddings in each dimension. For all t-SNE calculations, we use an open-source multi-core implementation with the default parameters (perplexity of 30).

Isomap. Isomap is a manifold-based dimension reduction method that uses classic multidimensional scaling (MDS) to preserve interpoint geodesic distances. To do this, the geodesic distance between points are determined by shortest-path graph distances using the Euclidean metric. The pairwise distance matrix represented by this graph is then embedded into n-dimensional Euclidean space via classical MDS, a metric-preserving technique that finds the optimal transformation for inter-point Euclidean metric preservation. As a result of the implicit linearity in classic MDS, we estimate the intrinsic dimensionality of the data by calculating the reconstruction error in each dimension using 1 – R², where R is the standard linear correlation coefficient between the geodesic distance matrix and the pairwise Euclidean distance matrix in ℝⁿ. For all calculations, 15 nearest neighbors were chosen for determining shortest-path graph distances, and the Minkowski metric with an order of two for the norm of the difference ||u – v||ₚ was chosen. All Isomap calculations were performed using Scikit-learn.

PHATE. PHATE is a manifold-based dimension reduction technique developed for data visualization that captures both global and local features of data sets. PHATE achieves this by modelling relationships between data points as t-step random walk diffusion probabilities and by subsequently calculating potential distances between data points through comparison of each pair of points’ respective diffusion distributions to all others in the data set. These potential distances are then embedded in n-dimensional space using classic MDS followed by metric MDS. Metric MDS is suitable for embedding points with dissimilarities given by any metric, relaxing Euclidean constraints imposed by classical MDS, through minimizing the following stress function S:

$$S \left({\hat{x}}_{1} … {\hat{x}}_{N}\right) = \sqrt{\frac{{\sum }_{i , j} {\left({D}_{{x}_{i} , {x}_{j}} - \left‖{\hat{x}}_{i} - {\hat{x}}_{j}\right‖\right)}^{2}}{{\sum }_{i , j} {\left({D}_{{x}_{i} , {x}_{j}}\right)}^{2}}}$$

where D is the metric defined over points x₁ ... x_{N} in the original data set, and x̂₁, ... x̂_{N}∈ℝⁿ are the corresponding embedded data points in dimension n. This stress function amounts to a least-squares optimization problem. In the scalable form of PHATE used for large data sets, landmarks instead of points are embedded in n-dimensional Euclidean space based on their pairwise potential distances using the above stress function. Out-of-sample embedding for all data points is performed by calculating linear combinations of the t-step transition matrix from points to landmarks using the embedded landmark coordinates as weights. If the stress function for metric MDS is zero, then the dimension reduction process is fully able to embed and capture the interpoint distances of the data. This would provide an error estimate to be used for analyses on intrinsic data dimension for the full data set and full PHATE algorithm; however, for the landmark-based calculations, not all points are embedded using metric MDS. Given the linear interpolation scheme and the initialization of scalable PHATE using classical MDS on landmark potential distances, we posited that the reconstruction error given by 1 – R², where R is the linear correlation coefficient between the point-to-landmark transition matrix and the pairwise Euclidean distance matrix in ℝⁿ, provides an estimate for the error associated with embedding the full data set. All PHATE calculations were performed in Python using 15 nearest neighbors and the default number of 2,000 landmark points.

NMF. Non-negative matrix factorization (NMF) is a linear dimension reduction technique that aims to minimize the divergence between an input matrix X and its reconstruction obtained through the matrix factorization WH. Through this factorization, linear combinations of the columns of W are produced using weights from H. The Frobenius norm between X and WH was used in our calculations, with the divergence between the two being calculated as

$$\frac{1}{2} {\left‖X - W H\right‖}_{2} .$$

Thus, in order to estimate the error associated with each embedding dimension, this divergence or reconstruction error was plotted. For allcalculations, each channel in the data set was min-max rescaled to a 0 to 1 range to ensure that only positive elements were included in X. All calculations were performed using Scikit-learn.

PCA. Principal components analysis (PCA) is a linear dimension reduction method that aims to capture the primary axes of variation in the data on a global level. In order to determine the intrinsic dimensionality of the data set estimated by PCA, the cumulative percentage of residual variance remaining after dimension reduction for each component is plotted. Given a component 1 ≤ d ≤ n –1 where n is the number of dimensions of the original data set, the percentage of variance explained by embedding in dimension d is determined by summing the d-largest eigenvalues of the covariance matrix of the full data set. For all calculations, each channel in the data set was standardized by removing the mean and scaling to unit variance. Standardization was used to ensure that no feature dominated the objective function of PCA. All calculations were performed using Scikit-learn.

(iii.) Assessing information content relative to H&E tissue morphology. In order to have an unbiased assessment of image to image information content between embedded data produced from each dimension reduction method and corresponding H&E stained tissue biopsy sections, three channels from MSI data were carefully chosen as representative peaks that highlighted morphological characteristics of the tissue (m/z peaks 782.399, 725.373, 566.770 for diabetic foot ulcer, prostate, and tonsil), a hyperspectral image was created, converted to gray scale, and was registered to the corresponding gray scale converted H&E image (FIGS. 18A, 19A, and 20A).

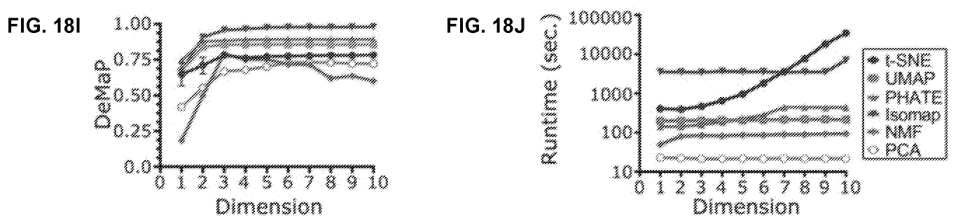

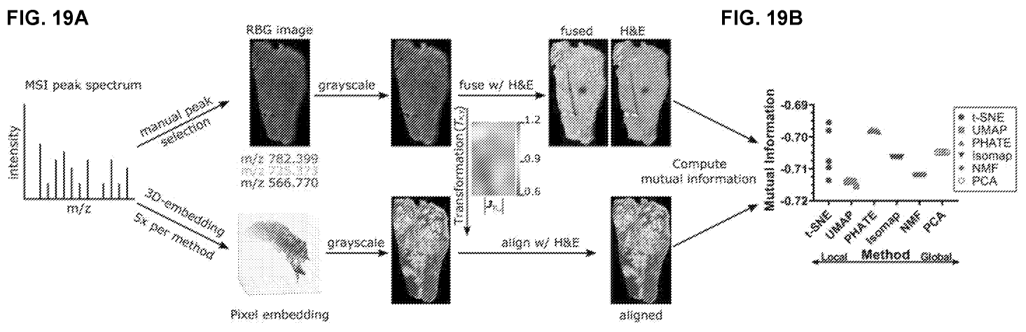

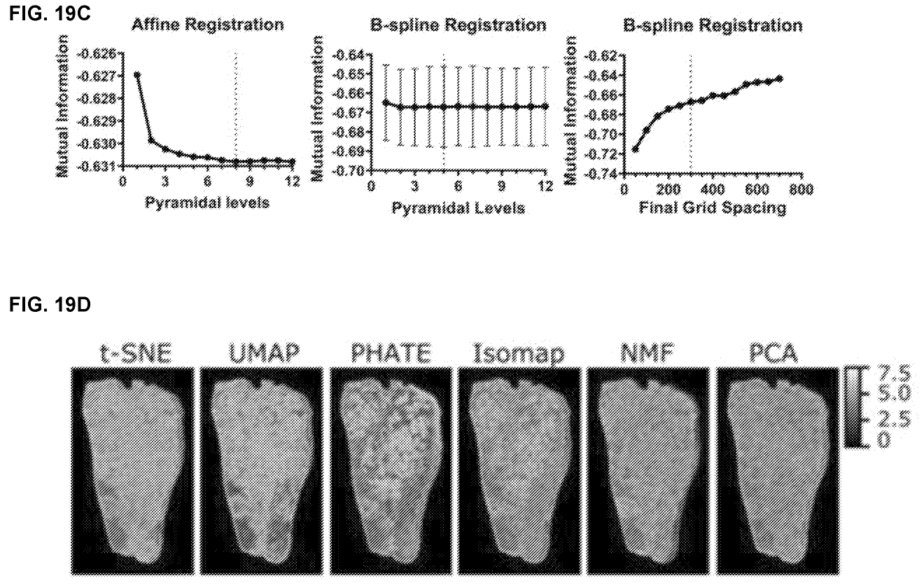

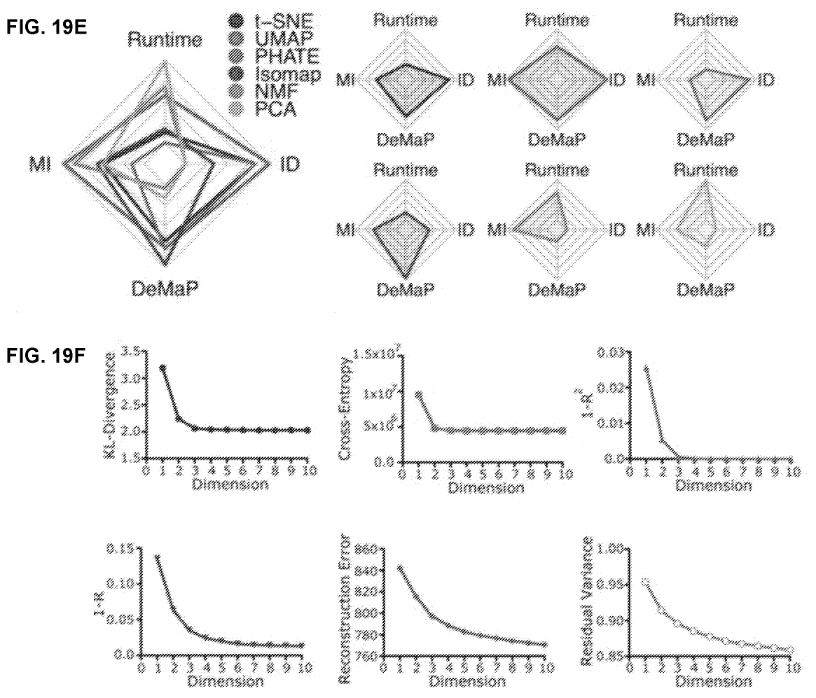

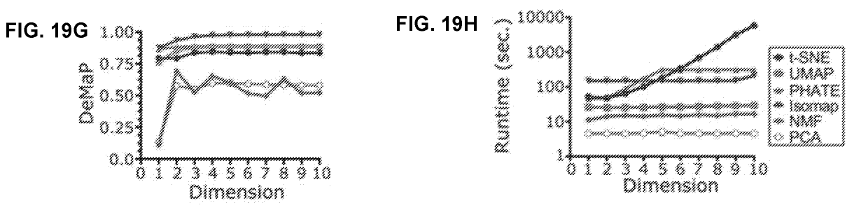

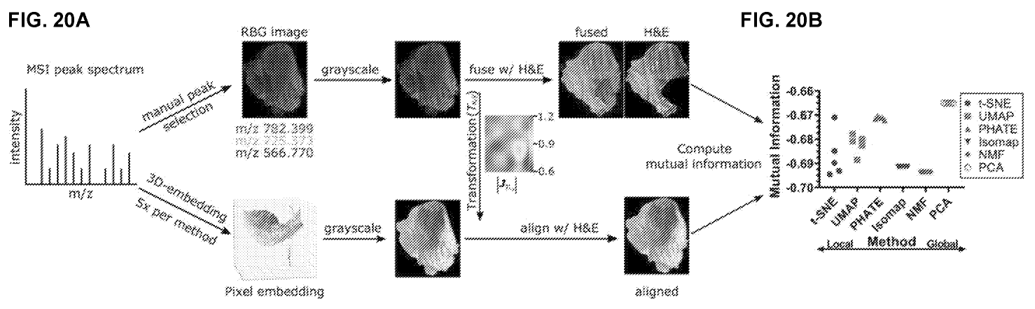

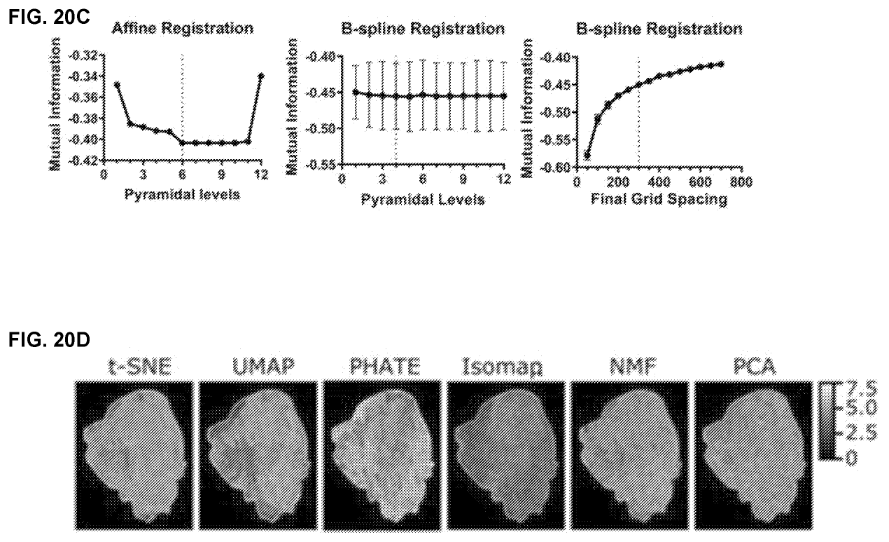

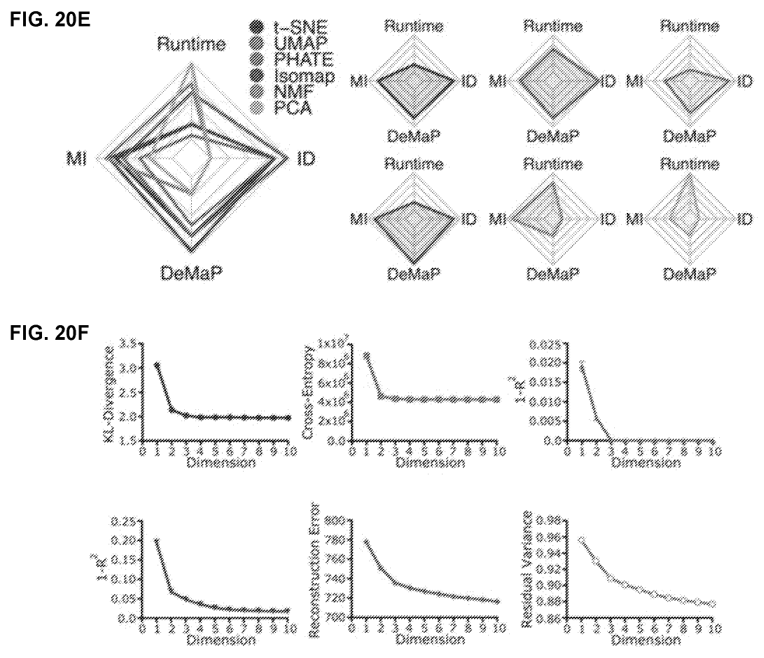

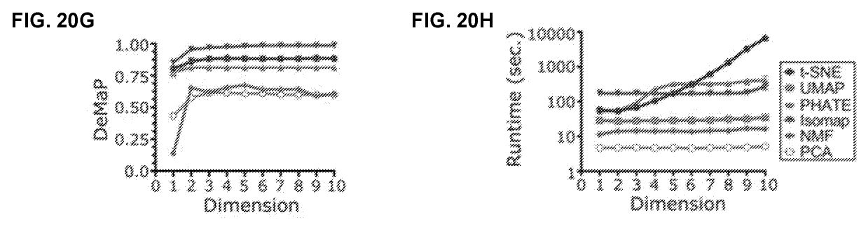

To ensure an appropriate alignment between the manually chosen gray scale MSI image of the diabetic foot ulcer and the gray scale H&E image, the mutual information of the registration and the dice score of seven paired ROls between the two images were assessed across hyper-parameter grids for an initial affine registration and subsequent nonlinear registration (FIG. 18C). For the prostate and tonsil tissues, we optimized the mutual information alone (FIGS. 19C and 20C). The results across hyper-parameter grids were then analyzed in order to choose the optimal parameters for each step in the registration scheme.

For the affine registrations, the hyper-parameter search resulted in a chosen number of resolutions in the multi-resolution pyramidal hierarchy. For the nonlinear registrations, both the number of resolutions and final uniform grid-spacing for the B-spline controls points were determined by the hyper-parameter grid search. In both registrations, the number of resolutions either improved registration results or left the registration unchanged. However, during the nonlinear registration, finer control point grid-spacing schedules resulted in improved registrations indicated by the mutual information, yet they resulted in regions with unrealistic warping even with the addition of regularization using deformation bending energy penalties. A value of 300 for the final grid-spacing was chosen as a balance between improved registration indicated by the cost function and increased warping.

The resulting deformation field was then applied to the gray scale hyperspectral images created from each dimension reduction algorithm to spatially align them equally with the H&E images of each tissue. Prior to calculating the mutual information between the H&E and embedded MSI images, a nonzero intersection was applied to the pair of images. The nonzero intersection was used to account for any edge effects introduced in the registration by using three manually chosen MSI peaks, which could have adversely affected the registration and mutual information calculations in our analysis if they were not well-represented at all locations in the images. The mutual information between each registered dimension reduction image (n = 5 per method) was then calculated using a Parzen window-based method in SimplelTK (FIGS. 18B, 19B, and 20B).

(iv.) Assessing algorithm robustness to noise. Through the assessment of data intrinsic dimensionality, we learned that both high-dimensional imaging modalities (MSI and IMC) follow a manifold structure, where the dimensionality of the data can be approximated with fewer degrees of freedom than the number of parameters initially given in the ambient space. Using this information, in addition to the visual quality of subsequent spatial mappings of each method back onto tissues, as evidence to justify the assumption of such manifold structure, we then proceeded to interrogate the ability of each algorithm to preserve geodesic distances in low dimensional embeddings with and without the addition of “noisy” peaks and/or technical variation.

To do this, we utilized the denoised manifold preservation (DEMaP) metric. By computing the DEMaP metric (Spearman’s rank correlation coefficient) between geodesic distances in the ambient space of a peak-picked MSI data set and the pairwise embedded Euclidean distances between data points from the corresponding non-peak-picked data set, we assessed the ability of each algorithm to preserve the manifold structure of the data set in the presence of noise. Since all the algorithms used were either calculated using the Euclidean metric with 15 nearest neighbors or they inherently assume a Euclidean structure, we calculated geodesic distances in the peak picked MSI data set using 15 nearest neighbors using the Euclidean metric. Peak-picking was performed in SCiLS Lab 2018b using orthogonal matching pursuit with a maximum number of peaks of 1,000. The DEMaP scores for each method across 5 random initializations of each algorithm for each MSI data set are shown in FIGS. 18I, 19G, and 20G.

(v.) Assessing computational runtime. Computational runtime for all methods was captured across 5 randomly initialized runs for each algorithm for embedding dimensions 1-10 across diabetic foot ulcer, prostate cancer, and tonsil tissue biopsy MSI data (FIGS. 18I, 19H, and 20H).

### References

Fay Wang, John Flanagan, Nan Su, Li-Chong Wang, Son Bui, Allissa Nielson, Xingyong Wu, Hong-Thuy Vo, Xiao-Jun Ma, and Yuling Luo. Rnascope: a novel in situ rna analysis platform for formalin-fixed, paraffin-embedded tissues. The Journal of Molecular Diagnostics, 14(1):22-29, 2012.

Michael Angelo, Sean C Bendall, Rachel Finck, Matthew B Hale, Chuck Hitzman, Alexander D Borowsky, Richard M Levenson, John B Lowe, Scot D Liu, Shuchun Zhao, et al. Multiplexed ion beam imaging of human breast tumors. Nature medicine, 20(4):436, 2014

Jia-Ren Lin, Mohammad Fallahi-Sichani, and Peter K Sorger. Highly multiplexed imaging of single cells using a high-throughput cyclic immunofluorescence method. Nature communications, 6:8390, 2015.

Jia-Ren Lin, Benjamin Izar, Shu Wang, Clarence Yapp, Shaolin Mei, Parin M Shah, Sandro Santagata, and Peter K Sorger. Highly multiplexed immunofluorescence imaging of human tissues and tumors using t-cycif and conventional optical microscopes. Elife, 7, 2018.

Sanja Vickovic, Gökcen Eraslan, Fredrik Salmén, Johanna Klughammer, Linnea Stenbeck, Denis Schapiro, Tarmo Äijö, Richard Bonneau, Ludvig Bergenstråhle, José Fernandéz Navarro, et al. High-definition spatial transcriptomics for in situ tissue profiling. Nature methods, 16(10):987-990, 2019.

Amanda Rae Buchberger, Kellen DeLaney, Jillian Johnson, and Lingjun Li. Mass spectrometry imaging: a review of emerging advancements and future insights. Analytical chemistry, 90(1):240-265, 2018

Yury Goltsev, Nikolay Samusik, Julia Kennedy-Darling, Salil Bhate, Matthew Hale, Gustavo Vazquez, Sarah Black, and Garry P Nolan. Deep profiling of mouse splenic architecture with codex multiplexed imaging. Cell, 174(4):968-981, 2018

Charlotte Giesen, Hao AO Wang, Denis Schapiro, Nevena Zivanovic, Andrea Jacobs, Bodo Hattendorf, Peter J Schüffler, Daniel Grolimund, Joachim M Buhmann, Simone Brandt, et al. Highly multiplexed imaging of tumor tissues with subcellular resolution by mass cytometry. Nature methods, 11 (4):417-422, 2014.

Jean-Marie Guyader, Wyke Huizinga, Valerio Fortunati, Dirk H. J. Poot, Jifke F. Veenland, Margarethus M. Paulides, Wiro J. Niessen, and Stefan Klein. Groupwise multichannel image registration. IEEE J. Biomedical and Health Informatics, 23(3):1171-1180, 2019.

Wyke Huizinga, Dirk HJ Poot, J-M Guyader, Remy Klaassen, Bram FCoolen, Matthijs van Kranenburg, RJM Van Geuns, Andrè Uitterdijk, Mathias Polfliet, Jef Vandemeulebroucke, et al. Pca-based groupwise image registration for quantitative mri. Medical image analysis, 29:65-78, 2016

Guha Balakrishnan, Amy Zhao, Mert R Sabuncu, John Guttag, and Adrian V Dalca. Voxelmorph: a learning framework for deformable medical image registration. IEEE transactions on medical imaging, 2019.

Tongtong Che, Yuanjie Zheng, Jinyu Cong, Yanyun Jiang, Yi Niu, Wanzhen Jiao, Bojun Zhao, and Yanhui Ding. Deep group-wise registration or multi-spectral images from fundus images. IEEE Access, 7:27650-27661, 2019.

Adrian V Dalca, Guha Balakrishnan, John Guttag, and Mert R Sabuncu. Unsupervised learning for fast probabilistic diffeomorphic registration. In International Conference on Medical Image Computing and Computer-Assisted Intervention, pages 729-738. Springer, 2018.

Max Jaderberg, Karen Simonyan, Andrew Zisserman, et al. Spatial transformer networks. In Advances in neural information processing systems, pages 2017-2025, 2015.

Leland Mclnnes, John Healy, and James Melville. Umap: Uniform manifold approximation and projection for dimension reduction. arXiv preprintarXiv:1802.03426, 2018

Joshua B Tenenbaum, Vin De Silva, and John C Langford. A global geometric framework for nonlinear dimensionality reduction. Science, 290(5500):2319-2323, 2000.

Laurens van der Maaten and Geoffrey Hinton. Visualizing data using t-sne. Journal of machine learning research, 9(Nov):2579-2605, 2008.

Kevin R Moon, David van Dijk, Zheng Wang, Scott Gigante, Daniel B Burkhardt, William S Chen, Kristina Yim, Antonia van den Elzen, Matthew J Hirn, Ronald R Coifman, et al. Visualizing structure and transitions in high-dimensional biological data. Nature Biotechnology, 37(12):1482-1492, 2019.

lan T Jolliffe and Jorge Cadima. Principal component analysis: a review and recent developments. Philosophical Transactions of the Royal Society A: Mathematical, Physical and Engineering Sciences, 374(2065):20150202, 2016.

Ronald R Coifman and Stephane Lafon. Diffusion maps. Applied and computational harmonic analysis, 21 2006

Hyunsoo Kim and Haesun Park. Sparse non-negative matrix factorizations via alternating nonnegativity-constrained least squares for microarray data analysis. Bioinformatics, 23(12):1495-1502, 05 2007.

Stefan Klein, Marius Staring, Keelin Murphy, Max A Viergever, and Josien PW Pluim. Elastix: a toolbox for intensity-based medical image registration. IEEE transactions on medical imaging, 29(1):196-205, 2009.

Judith M Fonville, Claire L Carter, Luis Pizarro, Rory T Steven, Andrew D Palmer, Rian L Griffiths, Patricia F Lalor, John C Lindon, Jeremy K Nicholson, Elaine Holmes, et al. Hyperspectral visualization of mass spectrometry imaging data. Analytical chemistry, 85(3):1415-1423, 2013.

Walid M Abdelmoula, Karolina Škrášková, Benjamin Balluff, Ricardo J Carreira, Else A Tolner, Boudewijn PF Lelieveldt, Laurens van der Maaten, Hans Morreau, Arn MJM van den Maagdenberg, Ron MA Heeren, et al. Automatic generic registration of mass spectrometry imaging data to histology using nonlinear stochastic embedding. Analytical chemistry, 86(18):9204-9211, 2014

Daniel Rueckert, Luke I Sonoda, Carmel Hayes, Derek LG Hill, Martin O Leach, and David J Hawkes. Nonrigid registration using free-form deformations: application to breast mr images. IEEE transactions on medical imaging, 18(8):712-721, 1999.

Denis Schapiro, Hartland W Jackson, Swetha Raghuraman, Jana R Fischer, Vito RT Zanotelli, Daniel Schulz, Charlotte Giesen, Raúl Catena, Zsuzsanna Varga, and Bernd Bodenmiller. histocat: analysis of cell phenotypes and interactions in multiplex image cytometry data. Nature methods,14(9):873, 2017.

Nico Battich, Thomas Stoeger, and Lucas Pelkmans. Control of transcript variability in single mammalian cells. Cell,163(7):1596-1610, 2015.

Vincent A Traag, Ludo Waltman, and Nees Jan van Eck. From louvain to leiden: guaranteeing well-connected communities. Scientific reports, 9(1):1-12, 2019.

Vincent D Blondel, Jean-Loup Guillaume, Renaud Lambiotte, and Etienne Lefebvre. Fast unfolding of communities in large networks. Journal of statistical mechanics: theory and experiment, 2008(10): P10008, 2008.

Xin Li, Ondrej E Dyck, Mark P Oxley, Andrew R Lupini, Leland Mclnnes, John Healy, Stephen Jesse, and Sergei V Kalinin. Manifold learning of four-dimensional scanning transmission electron microscopy. npj Computational Materials, 5(1):1-8, 2019.

Junyue Cao, Malte Spielmann, Xiaojie Qiu, Xingfan Huang, Daniel M Ibrahim, Andrew J Hill, Fan Zhang, Stefan Mundlos, Lena Christiansen, Frank J Steemers, et al. The single-cell transcriptional landscape of mammalian organogenesis. Nature, 566(7745):496-502, 2019.

Jacob H Levine, Erin F Simonds, Sean C Bendall, Kara L Davis, D Amir El-ad, Michelle D Tadmor, Oren Litvin, Harris G Fienberg, Astraea Jager, Eli R Zunder, et al. Data-driven phenotypic dissection of aml reveals progenitor-like cells that correlate with prognosis. Cell, 162(1):184-197, 2015.

Damien Arnol, Denis Schapiro, Bernd Bodenmiller, Julio Saez-Rodriguez, and Oliver Stegle. Modeling cell-cell interactions from spatial molecular data with spatial variance component analysis. Cell Reports, 29(1):202-211, 2019.

Honglei Zhang, Jenni Raitoharju, Serkan Kiranyaz, and Moncef Gabbouj. Limited random walk algorithm for big graph data clustering. Journal of Big Data, 3(1):1-22, 2016

Ulrike Von Luxburg. A tutorial on spectral clustering. Statistics and computing, 17(4):395-416, 2007.

Fanhua Shang, LC Jiao, Jiarong Shi, Fei Wang, and Maoguo Gong. Fast affinity propagation clustering: A multilevel approach. Pattern recognition, 45(1):474-486, 2012.

Manuel Fernández-Delgado, Eva Cernadas, Senén Barro, and Dinani Amorim. Do we need hundreds of classifiers to solve real world classification problems? The journal of machine learning research, 15(1): 3133-3181, 2014.

Stuart Berg, Dominik Kutra,Thorben Kroeger, Christoph N Straehle, Bernhard X Kausler, Carsten Haubold, Martin Schiegg, Janez Ales, Thorsten Beier, Markus Rudy, et al. ilastik: Interactive machine learning for (bio) image analysis. Nature Methods, pages 1-7, 2019.

Peter J Schüffler, Denis Schapiro, Charlotte Giesen, Hao AO Wang, Bernd Bodenmiller, and Joachim M Buhmann. Automatic single cell segmentation on highly multiplexed tissue images. Cytometry Part A, 87(10):936-942, 2015

Olaf Ronneberger, Philipp Fischer, and Thomas Brox. U-net: Convolutional networks for biomedical image segmentation. In International Conference on Medical image computing and computer-assisted intervention, pages 234-241. Springer, 2015

Leeat Keren, Marc Bosse, Diana Marquez, Roshan Angoshtari, SamirJain, Sushama Varma, Soo-Ryum Yang, Allison Kurian, David Van Valen, Robert West, et al. A structured tumor-immune microenvironment in triple negative breast cancer revealed by multiplexed ion beam imaging. Cell, 174(6):1373-1387, 2018

Chris Brunsdon, Stewart Fotheringham, and Martin Charlton. Geographically weighted regression. Journal of the Royal Statistical Society: SeriesD (The Statistician), 47(3):431-443, 1998.

A Stewart Fotheringham, Chris Brunsdon, and Martin Charlton. Geographically weighted regression: the analysis of spatially varying relationships. John Wiley & Sons, 2003

lan Goodfellow, Jean Pouget-Abadie, Mehdi Mirza, Bing Xu, David Warde-Farley, Sherjil Ozair, Aaron Courville, and Yoshua Bengio. Generative adversarial nets. In Advances in neural information processing systems, Pages 2672-2680, 2014.

Alireza Makhzani, Jonathon Shlens, Navdeep Jaitly, lan Goodfellow, and Brendan Frey. Adversarial autoencoders. arXiv preprint arXiv:1511.05644, 2015

Jun-Yan Zhu, Taesung Park, Phillip Isola, and Alexei A Efros. Unpaired image-to-image translation using cycle-consistent adversarial networks. In Proceedings of the IEEE international conference on computer vision, pages 2223-2232, 2017.

Yair Rivenson, Tairan Liu, Zhensong Wei, Yibo Zhang, Kevin de Haan, and Aydogan Ozcan. Phasestain: the digital staining of label-free quantitative phase microscopy images using deep learning. Light: Science & Applications, 8(1):1-11, 2019.

Eric M Christiansen, Samuel J Yang, D Michael Ando, Ashkan Javaherian, Gaia Skibinski, Scott Lipnick, Elliot Mount, Alison O′Neil, Kevan Shah, Alicia K Lee, et al. In silico labelling: predicting fluorescent labels in unlabeled images. Cell, 173(3):792-803, 2018.

Michele Guindani and Alan E Gelfand. Smoothness properties and gradient analysis under spatial Dirichlet process models. Methodology and Computing in Applied Probability, 8(2):159-189, 2006.

McDonnell, L.A. & Heeren, R.M. Imaging mass spectrometry. Mass spectrometry reviews 26, 606-643 (2007).

Giesen, C. et al. Highly multiplexed imaging of tumor tissues with subcellular resolution by mass cytometry. Nature methods 11, 417-422 (2014).

Angelo, M. et al. Multiplexed ion beam imaging of human breast tumors. Nature medicine 20, 436

.

Goltsev, Y. et al. Deep profiling of mouse splenic architecture with CODEX multiplexed imaging. Cell 174, 968-981. e915 (2018).

Lin, J.-R. et al. Highly multiplexed immunofluorescence imaging of human tissues and tumors using t-CyCIF and conventional optical microscopes. Elife 7 (2018).

Gut, G., Herrmann, M.D. & Pelkmans, L. Multiplexed protein maps link subcellular organization to cellular states. Science 361 (2018).

Rodriques, S.G. et al. Slide-seq: A scalable technology for measuring genome-wide expression at high spatial resolution. Science 363, 1463-1467 (2019).

github.com/ionpath/mibilib

Rashid, R. et al. Highly multiplexed immunofluorescence images and single-cell data of immune markers in tonsil and lung cancer. Scientific data 6, 1-10 (2019).

McQuin, C. et al. CellProfiler 3.0: Next-generation image processing for biology. PLoS biology 16, e2005970 (2018).

Schapiro, D. et al. MCMICRO: A scalable, modular image-processing pipeline for multiplexed tissue imaging. bioRxiv (2021).

### OTHER EMBODIMENTS

Various modifications and variations of the described invention will be apparent to those skilled in the art without departing from the scope and spirit of the invention. Although the invention has been described in connection with specific embodiments, it should be understood that the invention as claimed should not be unduly limited to such specific embodiments. Indeed, various modifications of the described modes for carrying out the invention that are obvious to those skilled in the art are intended to be within the scope of the invention.

Other embodiments are in the claims.

What is claimed is:

1. A method of identifying a cross-modal feature from two or more spatially resolved data sets, the method comprising:
(a) registering the two or more spatially resolved data sets to produce an aligned feature image comprising the spatially aligned two or more spatially resolved data sets; and
(b) extracting the cross-modal feature from the aligned feature image.

2. The method of claim 1, wherein step (a) comprises dimensionality reduction for each of the two or more data sets.

3. The method of claim 2, wherein the dimensionality reduction is performed by uniform manifold approximation and projection (UMAP), isometric mapping (Isomap), t-distributed stochastic neighbor embedding (t-SNE), potential of heat diffusion for affinity-based transition embedding (PHATE), principal component analysis (PCA), diffusion maps, or non-negative matrix factorization (NMF).

4. The method of claim 3, wherein the dimensionality reduction is performed by uniform manifold approximation and projection (UMAP).

5. The method of any one of claims 1 to 4, wherein step (a) comprises optimizing global spatial alignment in the aligned feature image.

6. The method of any one of claims 1 to 5, wherein step (a) comprises optimizing local alignment in the aligned feature image.

7. The method of any one of claims 1 to 6, wherein the method further comprises clustering the two or more spatially resolved data sets to supplement the data sets with an affinity matrix representing inter-data point similarity.

8. The method of claim 7, wherein the clustering step comprises extracting a high dimensional graph from the aligned feature image.

9. The method of claim 8, wherein clustering is performed according to Leiden algorithm, Louvain algorithm, random walk graph partitioning, spectral clustering, or affinity propagation.

10. The method of any one of claims 7 to 9, wherein the method comprises prediction of cluster-assignment to unseen data.

11. The method of any one of claims 7 to 10, wherein the method comprises modelling cluster-cluster spatial interactions.

12. The method of any one of claims 7 to 10, wherein the method comprises an intensity-based analysis.

13. The method of any one of claims 7 to 10, wherein the method comprises an analysis of an abundance of cell types or a heterogeneity of predetermined regions in the data.

14. The method of any one of claims 7 to 10, wherein the method comprises an analysis of spatial interactions between objects.

15. The method of any one of claims 7 to 10, wherein the method comprises an analysis of type-specific neighborhood interactions.

16. The method of any one of claims 7 to 10, wherein the method comprises an analysis of high-order spatial interactions.

17. The method of any one of claims 7 to 10, wherein the method comprises an analysis of prediction of spatial niches.

18. The method of any one of claims 1 to 17, wherein the method further comprises classifying the data.

20. The method of claim 18, wherein the classifying process is performed by a hard classifier, soft classifier, or fuzzy classifier.

21. The method of any one of claims 1 to 20, wherein the method further comprises defining one or more spatially resolved objects in the aligned feature image.

22. The method of claim 32, wherein the method further comprises analyzing spatially resolved objects.

23. The method of claim 33, wherein the analyzing spatially resolved objects comprises segmentation.

24. The method of any one of claims 1 to 23, wherein the method further comprises inputting one or more landmarks into the aligned feature image.

25. The method of any one of claims 1 to 24, wherein step (b) comprises permutation testing for enrichment or depletion of cross-modal features.

26. The method of claim 25, wherein the permutation testing produces a list of p-values and/or identities of enriched or depleted factors.

27. The method of claim 25 or 26, wherein the permutation testing is performed by mean value permutation test.

28. The method of any one of claims 1 to 27, wherein step (b) comprises multi-domain translation.

29. The method of claim 28, wherein the multi-domain translation produces a trained model or a predictive output based on the cross-modal feature.

30. The method of claim 28 or 29, wherein the multi-domain translation is performed by generative adversarial network or adversarial autoencoder.

31. The method of any one of claims 1 to 30, wherein at least one of the two or more spatially resolved data sets is an image from immunohistochemistry, imaging mass cytometry, multiplexed ion beam imaging, mass spectrometry imaging, cell staining, RNA-ISH, spatial transcriptomics, or codetection by indexing imaging.

32. The method of claim 31, wherein at least one of the spatially resolved measurement modalities is immunofluorescence imaging.

33. The method of claim 31 or 32, wherein at least one of the spatially resolved measurement modalities is imaging mass cytometry.

34. The method of any one of claims 31 to 33, wherein at least one of the spatially resolved measurement modalities is multiplexed ion beam imaging.

35. The method of any one of claims 31 to 34, wherein at least one of the spatially resolved measurement modalities is mass spectrometry imaging that is MALDI imaging, DESI imaging, or SIMS imaging.

36. The method of any one of claims 31 to 35, wherein at least one of the spatially resolved measurement modalities is cell staining that is H&E, toluidine blue, or fluorescence staining.

37. The method of any one of claims 31 to 36, wherein at least one of the spatially resolved measurement modalities is RNA-ISH that is RNAScope.

38. The method of any one of claims 31 to 37, wherein at least one of the spatially resolved measurement modalities is spatial transcriptomics.

39. The method of any one of claims 31 to 38, wherein at least one of the spatially resolved measurement modalities is codetection by indexing imaging.

40. A method of identifying a diagnostic, prognostic, or theranostic for a disease state from two or more imaging modalities, the method comprising comparing a plurality of cross-modal features to identify a correlation between at least one cross-modal feature parameter and the disease state to identify the diagnostic, prognostic, or theranostic, wherein the plurality of cross-modal features is identified according to any one of methods 1 to 39, wherein each cross-modal feature comprises a cross-modal feature parameter, and wherein the two or more spatially resolved data sets are outputs by the corresponding imaging modality selected from the group consisting of the two or more imaging modalities.

41. The method of claim 40, wherein the cross-modal feature parameter is a molecular signature, single molecular marker, or abundance of markers.

42. The method of claim 40 or 41, wherein the diagnostic, prognostic, or theranostic is individualized to an individual that is the source of the two or more spatially resolved data sets.

43. The method of claim 40 or 41, wherein the diagnostic, prognostic, or theranostic is a population-level diagnostic, prognostic, or theranostic.

44. A method of identifying a trend in a parameter of interest within the plurality of aligned feature images identified according to the method of any one of claims 1 to 39, the method comprising identifying a parameter of interest in the plurality of aligned feature images and comparing the parameter of interest among the plurality of the aligned feature images to identify the trend.

45. A computer-readable storage medium having stored thereon a computer program for identifying a cross-modal feature from two or more spatially resolved data sets, the computer program comprising a routine set of instructions for causing the computer to perform the steps from the method of any one of claims 1 to 39.

46. A computer-readable storage medium having stored thereon a computer program for identifying a diagnostic, prognostic, or theranostic for a disease state from two or more imaging modalities, the computer program comprising a routine set of instructions for causing the computer to perform the steps from the method of any one of claims 40 to 43.

47. A computer-readable storage medium having stored thereon a computer program for identifying a trend in a parameter of interest within the plurality of aligned feature images identified according to the method of any one of claims 1 to 39, the computer program comprising a routine set of instructions for causing the computer to perform the steps from the method of claim 44.

48. A method of identifying a vaccine, the method comprising:
(a) providing a first data set of cytometry markers for a disease-naïve population;
(b) providing a second data set of cytometry markers for a population suffering from a disease;
(c) identifying one or more markers from the first and second data sets that correlate to clinical or phenotypic measures of the disease; and
(d)
(1) identifying as a vaccine a composition capable of inducing the one or more markers that directly correlate to positive clinical or phenotypic measures of the disease; or
(2) identifying as a vaccine a composition capable of suppressing the one or more markers that directly correlate to negative clinical or phenotypic measures of the disease.
